(19) United States
(12) Patent Application Publication
(10) Pub. No.: US 2023/0046080 A1
(43) Pub. Date: Feb. 16, 2023

(54) Combo 12

(71) Applicant: JonMichael Harmon, Arcata, CA (US)

(72) Inventor: JonMichael Harmon, Arcata, CA (US)

(21) Appl. No.: 17/886,836

(22) Filed: Aug. 12, 2022

Related U.S. Application Data
(60) Provisional application No. 63/233,180, filed on Aug. 13, 2021.
(60) Provisional application No. 63/303,990, filed on Jan. 28, 2022.
(60) Provisional application No. 63/317,941, filed on Mar. 8, 2022.
(60) Provisional application No. 63/328,743, filed on Apr. 8, 2022.
(60) Provisional application No. 63/352,626, filed on Jun. 15, 2022.

(51) Int. Cl. B62D 33/027; A23G 3/36; G06Q 50/00

(52) U.S. Cl. CPC B62D 33/0273; A23G 3/36; G06Q 50/01; E05Y 2900/546

(57) ABSTRACT

The following provisional application contains many innovations to many products and markets. Including wetsuits, shoes, social media apps, sports equipment and more.

### SPECIFICATION

Door handle that only works if a coin is inserted.

Shower head with speaker built into it.

Indented groove on mattress so it cups the body for comfort.

Fridge with drinking fountain, so you don't need a glass to get a quick drink.

To store CO2 inside concrete, tubes can inject CO2 gas inside the wet mix and fill large pockets.

To prevent houses from catching on fire from a forest fire event, or from another nearby fire a very large fireproof house tarp could cover the house. The ends of the tarp should be sealed to the ground as best as possible by use of stakes or by weighted material. Waterproof and or fireproof tarp bigger than 1000 square feet.

A pillow with a downward sloping surface for the user to put the side of their face on. This helps put the sleeper in a more natural head position when sleeping on their stomach and decreases the rotation of their neck.

To make it easier for people to get through rows of narrow seats that are bolted to the floor like in a movie theater or lecture hall, the back-rest part of the seat could fold forward.

To make it easier to sleep when it's too hot a mattress could be made with an electronically powered cooling system.

A bed frame can transform a mattress into a more curved shape for the head, neck and upper body. The top half of the bed can have two, three, four, five, or more moveable platforms. These joints can be mechanically changed and locked into place by metal teeth like a pool lounge chair, or with a hole and holes that line up at different angles and a metal bar can pass through to lock in place. These moveable joints can also be changed electronically where they are powered by an electronic module and can be locked into place when a metal piece is slid into groove electronically or metal teeth in a circular pattern can lock into a receiving female part for teeth arranged around a circle pattern when electronically moved together. Said interlocking teeth can be arranged on, near or in between a rotational point/s. The benefit of having two or more rotational segments in the upper portion of the bed frame is so that your head can be supported with a steeper angle of bed surface than the back this prevents neck pain. Hydraulic cylinders can be used to raise and lower the sections of the bed frame that rotate to different angles. With this method the rotational points are not needed to be motorized or locked. With my multistage angled platform design for the upper body support, a hydraulic cylinder be secured to the frame that angles a platform and then from that platform that can be angled another hydraulic cylinder can be attached to that frame to then angle another platform. On a remote control each section of angle changing platforms can be controlled individually.

To prevent elderly people and young children from falling and getting hurt in their bath tub a special pad that adheres to the surface of the bathtub by means of an adhesive. This pad can be squishy and made grippy with a tread surface.

Dishwasher with curved spokes to better hold bowl.

A dishwasher can have clips or clamps similar to a clothespin that can be used to easily grab a plate, bowl or cups to hold the item in place as it is washed.

In order to keep towels tightly rolled a Velcro strap can be attached to the end of the towel to secure it stays rolled or folded.

To dim the incoming light from window without giving up the view of the window a clear tinted cover can be pulled over the window, or tinted sliding glass doors. Said cover can be rolled up for storage and unrolled for use. This device can be electronically powered.

For people that like to smoke in their house it would be convenient to have a smoke alarm that can be temporary turned off due to a cover that blocks air from the smoke detectors sensors, or by turning off the its sensor. Most smoke detectors are placed in the highest part of the house, which makes them difficult to get to. A remote control would be helpful in making these commands, or the smoke detector could be linked to an app so that its controls could be changed by someone's phone.

To make a pillow more comfortable for sleeping on your back or in a chair a pillow can be made that holds the shape of a half pipe to support your head in a straightforward position. Said shape for head support could also be made in a car seat head rest. Where the sides that support the head on either side could come out of the head rest or be move back to be flush with the rest of the head rest when not in use. {pillow with general head mold}

Car seat that has three or more movable seat parts. A car could have two or more moveable seat parts above the seat part that is sat on by the butt, not including the headrest. A car could have two or more movable seat parts below the seat part that lays against the lower back.

A car can have a headrest where the angle can change with the use of electric controls.

A car can have a side door that swings open where a button can be used to automatically open and close.

A car/truck can have seat coolers in the back seats, including the middle. A car can have a seat warmer in the back middle seat. The back middle seat of a vehicle can be made concave for comfort.

To save labor for the person cleaning their clothes a washing machine can automatically transfer the clothes into a dyer. The washer can be placed above the drier. When the clothes are done washing a door opens that drops the washed clothes into the dryer, then the door shuts, and dryer automatically starts.

To make a lawn chair more comfortable it needs to support the head and neck. To do this the lawn chair's area where the head and neck lay should have their angle separately adjustable.

To have a shower handle work well for a person it must be at the right height. An adjustable shower handle can be made so that it is the right height for a short person, tall person and for a person in the middle. This shower handle can be adjustable by having the neck of it be made of a flexible but stable material so when it is shaped to the right height it stays that way.

A mattress where the area of where the person layers their head is elevated. This acts as a built-in pillow. Said elevated area to support a person's head and neck can be changed in height by a mechanical system.

To help propel a hydrofoil forward through the water when being pumped a coil hinge can be placed on the mast near the attachment plate. Coil can be very strong and even shaped in half circle.

An electric hydrofoil can have a propeller that is built into the fuselage, where the propellers spin around in the core of the fuselage or on either side.

A hydrofoil can have a fuselage that has a greater height than width and have rounded edges that are sharper on the top and bottom. This limits resistance when pumping.

Hydrofoils can be made with interchangeable wings. One way of doing this is by having a rod that is parallel with the fuselage screw the front wing to the fuselage. To prevent chipping where the two attach a squishy washer can be placed between the two.

To make a foil easily attach and detach from a board one or more clamps can be used. A clamp can have two stages one where it loses the board from the foil so it can be adjusted along an attachment track and the second stage separates the foil from the board.

Clamp to attach foil to foil board.

A “v” shaped brush can be made to clean the places between one's teeth.

People wear teeth straining covers for many hours of the day. However, they could be multi-tasking while wearing these retainers. Teeth whitening ingredients could be put inside the retainer so while they wear it their teeth get whitened and straightened at the same time.

A toothbrush where the head curves around the tooth straight bristles are placed at various angles to ergonomically surround the tooth. This allows someone to brush all sides of their teeth at once. A toothbrush with a built-in place to hold floss. A toothbrush with a built-in place to hold brush for in-between cracks in teeth.

Acne prevention cream with active ingredient Chlorhexidine gluconate. 4% is ideal.

Parking meter or parking garage entry where the customer slides their credit or debit card at the beginning and once again at the end of their visit. The time in between the card swipes the parking meter is green and for the parking garage the customer has to swipe to open the gate.

To make a cashier system work for efficient with high quantities of customers one cashier can be scanning the items only. Once the person has all their items scanned the customer goes to another employee to pay for the item. This lets the first employee go back to scanning the next customers items before the first customer is done paying. Computer software can be made to handle this multi-customer approach.

To avoid getting sued, an online store could have a form where the customer must sign to but the product.

A car insurance agreement where the customers pay a flat rate regardless of their car, their age, and/or driving record. If the customer gets into an accident the insurance company will pay the fee all upfront. After the insurance company pays for the fee, it gives the customer options of how they would like to pay it back. The customer can choose to how quickly it wants to pay it back by how much they choose to raise their monthly rates. The same can be done for health insurance. To help with financial capital a lender can let their customer have access to their money whenever they need to make an important purchase. The lender can have technology that calculates the interest on this purchase and can be tabs on this and additional purchases as well.

An app or website that assigns stock to a person. This will mostly be used on people who are artists or sports players. A person might buy stock in an artist who they think will become popular in the future. Stock can be exchanged between people. Every time stock is moved towards a person, they earn some money from the transfer. Every time stock is exchanged the company running it earns a percentage of the money transferred.

Wireless headphones where the user can control the volume of their music from the headphone by use of a dial, switch, surface tap or swipe pattern. A tap on one ear bud could mean volume up and a tap on the other ear bud could mean volume down. One downward swipe could mean volume down and an upward swipe be volume up. A single tap could mean pause song and a tap on the other headphone be skip song. A swipe up or down on one headphone could mean volume change and on other headphone could be skip or rewind song.

Air pod or other wireless devices where the carrier programs them to a certain phone, and they can change it when a customer gets a new phone. This will help prevent theft.

Wireless headphones can be made where if you tap the top portion of the headphone, it increases it volume and if you tap the lower portion of the headphone, it decreases the volume.

A social media app or website can have two like buttons for the same post. This can be used as a form of voting.

A social media app can have a setting that lets the user view content in full screen, with no caption, comments, and other icons like the “like” icon and others.

A social media app that can let the user rotate their phone into landscape position and the user can stroll through feed in the landscape position.

A social media app can allow the user to view adult content, (nudity, porn or graphic images/videos) if they are above a specific age or if they pay for a specific subscription that allows them to view that type of content. Said subscription can be general for the app or specific for an account they want to view the content of.

A social media app can give the ability for three or more people make the same post. In this case it shows up on the feed of all three or more combined followers and each of the homepages of those who were apart of the combined post.

A social media app can have a video be paused with a single touch, and once paused the caption and or other icons on the screen can disappear.

A remix in a social media app is where the user can add their own video next to an existing video or picture posted by another user. A social media app where you can remix a video that is already remixed once. The newly added video or photo can appear side by side with the others, where the boarder lines are parallel, and all three video or photos are even sized. When at post that has been remixed a total of four times can have the four videos or photos in a symmetrical four quadrant pattern.

A social media app could give the user the ability to select a user's profile picture and see the profile picture in a larger display, where the profile picture is not centered in the middle of the accounts page.

A social media site where a picture or video selection is made, the interface allows the user to scroll down and up from that selection, to view more content.

A social media app can have a livestream where the comments can be removed; this can be done by an “x” icon or a downward or horizontal swipe on the screen or at the top of comments.

A social media app where it has this format within the app; where the video or photo is nearly or is full screen and to get more content you can scroll down, and there is a category of posts that are in rows of three, and more content can be found once one of these posts has been selected and the user scrolls down.
a. The video can pause with one tap and the caption, comments, and vertical line of icons and other information can be removed from the foreground while paused
b. The video can be zoomed in on with a two-finger spread.
c. Has a mute icon that can be selected with a single tap.
d. Has a small “x” that can be selected to remove comments, or a downward swipe at the top of the comments to remove the comments from the foreground so you can have a better view of the content.

A social media app can give the user the ability to add a location, and a song on a post.

A social media app can have a format where the next video is below the current one; once the current video is done playing the next one below it can play next automatically; or the current video can play either twice, three, four or five times then move to the video below it. The user can set this feature in settings of the app.

A social media app can have an advertisement within a post where the viewer of the advertisement is able to play the game, perhaps for a limited time, or limited number of tries. A window at the bottom of the screen can be selected to play the game, or the game can play auto/semiautomatically when user scrolls to the post.

A social media app can give the user the ability to tag their music that is on another app onto their post, where their music handle/song can pop up on the post in the comments or above the post. Once selected the app that has the music can be opened.

A phone installation or app can monitor real cell phone battery amount. What phone companies like to do is make their older phone models battery die earlier than necessary so the customer is inclined to get the next phone model. Said installation or app can prevent this from happening. It can prevent the phone from turning off when it still has power.

A navigation app can be made with a feature that pauses/silences directions. This is useful for when you want to make a detour. The navigation can then be un-paused/unsilenced with another selection.

Setting on social media app or website where you can have any language automatically translated to your language.

Music app where you can save versions of original songs that the user can personally trim and cut sections to their liking.

On a music playing or making app/software the position of where the song is or will be played from can be more accurately changed when the touchscreen is pressed harder.

A music playing app that shows the time of the song to a fraction of a second.

A flap or flaps on phone charging port that flips down and out of the way when the charger is inserted and flips back up to protect the port from debris when not charging. Said flap/s can also slide sideways, perpendicular to the inserted charger cable.

Phone chargers insert with surface area greater than 0.3 cm squared. This extra surface area will let the phone charge quicker.

Social media app where users can individually like a posts caption, song or location.

Phone screen thicker than 0.05 inches thick and can be made from real glass so that it is less likely to break.

Social media app that lets you post multiple images or videos and allows you to delete one or more after posting. On said social media when you are tagged in an image it does not go to your accounts main homepage, or where you can't post only a text, and/or where other users can't post writings that appear on the users main homepage.

A laptop can have right, left, up and down facing arrow buttons above the keyboard. This makes it more useable.

A laptop can have arrow control buttons on the left side of the keyboard.

Music playing app where you can choose between multiple pics/videos that relates to the song, album or artist.

A music playing app could have an interface where you can send music like a song or album or even a podcast to your friend who also has the app. People and groups could easily exchange texts, images and videos, as well as voice or sound recordings. This could all take place on the music playing app.

To get more people to vote it must become more convenient. An app or website that lets people vote from the convenience of where they are will increase voting numbers.

A system inside an electrical or power cord that can disconnects and reconnect to save power when not being used.

A phone can have an active screen/touchscreen the encompasses the front face as well as the back face, and maybe even most of the sides as well. The device could detect when face of the phone the use is looking at based on sensing how the user is holding it, or by sensing the face of the user as well. This can be an entirely touchscreen phone, except for the cameras and charging port.

If you lose your phone but you have wireless headphones connected to the device, a general command can be given where the phone will respond be vibrating or ringing your phone so that you can find it. The same concept could work if the headphones are lost, where the headphones can vibrate and make noise.

Social media app with fast forward/slowdown/reverse selection/button option on a posted video. This can be done by taping/holding on the left or right side of a video post.

When zooming in on an image, the image can stay zoomed in for as long as a finger is touching a screen, this lets the user readjust a finger while zoomed in so that they can zoom-in more.

To help channel surfers know if what they are watching is on commercials or not a symbol can be put near where it says the title of what is playing on that channel. A button could also be added to the remote that takes you back to the channel once it is off commercial.

A credit card number can be linked to a license plate so that when you need to pay a for a parking pass you just need to fill out your license plate and how long you are staying for. They can then get ahold of your credit card information from just knowing your license plate. This will save the parker time in filling out a parking slip.

When listening to a to a song on a music app on a phone it is annoying if the song is paused you have to reopen your phone go to the app and press play. For music playing apps controls for the music such as play, skip song, restart song, and go back to last song should be available on the lock screen if the music app is not cleared.

A music playing app can be made where once you select an artists profile you can search their songs, where in this specific search it only brings up songs that the artist is in.

If you miss a call a notification will pop up, without unlocking you phone the user can touch or swipe the notification, and the phone will call back the caller.

Social media apps like to limit the amount of information people can post to keep it simple. However, companies may want to post extra information by having longer videos to explain a product or service. Extra information posted on a social media site can come at a financial expense.

To make a sailboat sailable by one person and the electric winches that control the sails can be controlled by buttons in the helm or cockpit.

To create electricity without burning fossil fuels a driverless wind-powered vessel could have a turbine that collects and stores energy as it moves through the water.

When typing a paper when you type your way down to the bottom of the page the writing program keeps what you are writing at the bottom of the page. However, it is uncomfortable to have to look at the very bottom of your screen to see what you are writing. A writing program could be made where it keeps what you are writing at an adjustable place on the screen, preferably the middle area. Wherever the curser is moved the program will adjust the screen/document to have it at the preferred place.

For a more secure password for login on a site, the site can have a password option of a fingerprint. The site brings up a spot for you to put your fingerprint. It saves the details of your fingerprint as a password. If you want to login on the site, then you press your finger to the screen of a phone or computer where the site receives fingerprint scan. If the fingerprint matches, then you are now logged onto the site. Fingerprint recognition on middle of phone or computer screen so it can be used as a password for apps and sites.

To easily edit the speed of a video on a touch screen device a program can be made so that when you hold one side of the screen it fast forwards and when you hold the other side of the screen it reverses. Once the users finger is taken off the screen the fast-forward or reverse is stop and the video continues to play normally.

To make headphones less inclined to fall off when wearing them they could have one or more gentle suction cups that attach to the ear.

Electronic chargers are prone to break because they go from a thicker coating layer straight to a thinner coating layer. At this junction is where the wire tends to fray. To avoid this the wires coating should smoothly decrease from thick to thin.

When playing a game with friends it is common to have different views on the rules. To solve these conflicts an app or website should be made where you can search a game it will tell the official rules. This app can also keep score during a game by keeping track of set words you say each time someone scores.

When an unknown number calls your phone, you have no idea who it is or what they want, but you do know the location of the call. To help unknown callers not confuse the people they call information can be added to go along with their number, such as their name, business, or subject for call. This information would show up under the number on a person's phone who was called by them and doesn't have their contact information. Instead of one line of informative text, several can be used to inform the receiver of the unsolicited call.

For rolling papers with a very sticky edge, a paper can go over it that acts like a peel able sticker. This keeps it from getting stuck to anything before use.

A bong can be made from interchangeable pieces so that shapes and sizes of different parts of the bong can be interchangeable as well as percolations can be added and removed based on consumer preferences. Said interchangeable pieces can attach and detach by means of clamps, snaps, or a screw in system.

A bowl piece for a bong can have wires crossing through the opening at the end of the area where the herb is placed. This allows a smaller amount of herb to be placed in the bowl without it falling into the down stem.

Bong made with rubber coated exterior to prevent breaking. Said coating can be strips or patches.

Water filtered smoke is healthier. A convent and cheap way to make a smoke filtering devise from water can be made using a water bottle. A product can be made that has a mouthpiece stern and bowl that screw on and seal to a beverage container.

Normal bench presses that are rectangularly shaped limit range of motion for the shoulder blades. A bench press that gives the shoulder blades proper range of motion is shaped where the bench is thinner where the persons shoulder blades would be.

A muscle building and fat burning work out product is weighted juggling balls. These balls are meant to be heavy so that when someone juggles with them they get an exercise. These balls are also made soft and easily deformed so it you drop it on your foot it doesn't hurt. The center can be a sand or gravel, wrapped in fabric, an then covered in a rubber coating with tread for grip. This type of weighted object can made heavy enough to be used for workouts that don't involve juggling. It can be a sandbag like work out, can this product can come with hand straps and other straps. These weights can range from 10-100 lbs or more.

Useable electricity can be generated from weightlifting machines. Many weightlifting machines have a series of pulley. One or more of these pulleys could have generator that collects electricity. Instead of using weight as work out resistance, the generator can be used as work out resistance. These generators can be adjustable to have more or less resistance thus creating more or less electricity respectively.

To avoid breaking the weight plates on an exercise machine or to prevent them from making a loud sound the tops or bottoms can be coated in rubber to absorb impact and sound.

To make a beverage easier to get all the liquid out it can be made with no space between the opening and the vertical side wall.

To simplify canned drink containers and cheeping their manufacturing the can, can be opened without a lever. Instead, a perforated part of the can that is meant to open is made weaker than normal so the pressure of a finger is enough to open a beverage can.

To make a beverage able to be drunk faster two openings on the can, can be made. One at the top and the other on the side. One of the openings is to drink from and the other is for air flow so the liquid can empty from the container quicker.

A car's very back door can have an extra high resting position so that tall people don't have to duck under it or hit their head. This means the vehicles hatch back can have two or more opened resting positions. These resting positions are determined by the placement of grooves in the rotational hinge part of the hatch back.

A car can have button on or near the back bumper where the user can press it with their foot to open the very back door.

Truck with storage compartment built into truck bumper. Said compartment can side outward to expose the stored items.

To hide valuables a lock box can be built into a car bumper.

Self-driving cars with spontaneous direction settings. Options can appear where the driver can select a right, straight or left turn, or have interactive voice control.

In a car's interior cords such as the aux and phone chargers can be retractable to become flush or almost flush with the interior of the car.

An aux cord that can charge a device.

Middle car seat with concave seat surface.

License plate fee scanner for parking garages. When you drive into a parking garage a license plate scanner can record your license plate information and automatically send you a fee based upon the time your vehicle spent in the parking garage. The same can be done for a parking spot on the side of the road. This gives the customer a more accurate fee price because it knows more accurately how long you were parked.

Buttons can be placed on a car mirror that can unlock the car when the correct code is pressed.

A car's interior lights only stay on for so long while the car is off and a door is open. If someone is unpacking their car in the dark this can be problematic. To solve this problem the car lights can turn back on when the position of the door is changed.

Electric sliding tint layer for windshield can be made to dim the incoming light on a bright day and to prevent people from seeing what's in your car while it is unattended, so people are less likely to break in. This can work like there are two windows. One is normal and the other is tinted.

A back up camera on a car can calculate the actual distance till the nearest object. This gives the driver a more accurate understanding of how far away the nearest object is. The screen can say 10 inches and the user will know that is the distance till they hit something. The car can also take control and back itself up to a certain distance from the object. To make a cars seat more comfortable they can have a concave curve in the upper portion of the seat. Said curve can be adjustable. A gas cap can have a lock on it so that you can place your keys in it. A license place holder that is built into the car can have hidden capsule that has lock to keep important things like keys from being stolen. A car can have a hidden capsule built into the grill, bumper, undercarriage, or wheels of a car. Said capsule can have a lock.

To simplify the controls on the inside of a vehicle, a single nob can have multiple controls. Said nob can be made with one or more dials that each have a different function. Said dials can be rotating dials with different diameters.

A car insurance company, where the company gets paid a flat fee and the rest of the money the customer pays goes to covering for the consumers car or cars. An underpass can be made below ground level and equipped with a drain. An overpass/underpass system can be made in a size that is smaller than standard.

To prevent traffic jams, under passes and over passes can be used a lot more. An underpass can be made below ground level and equipped with a drain. An overpass/underpass system can be made in a size that is smaller than standard. This reduces cost in materials.

A windbreaker like jacket can be made with built in gloves have cover each finger individually and thumb or can have the pinky and neighboring finger grouped next to one another.

Head support head rest in a car seat could also be made with side support pieces for either side of the head. This lets the user rest their head to the side with support so that their neck isn't hurt. On either side said piece could rotate out of the head rest or be rotated back to be flush with the rest of the head rest when not in use. Said pieces are padded and provides comfortable support for keep the head in the headrest.

Four to six wheeled vehicles can have rotating tracks attached to either end of the vehicle and/or the undercarriage. One or more wheels or rotating cylinders can be attached to the lower front or back end of a car or truck.

A vehicle can have a censor that detects the distance/speed/acceleration of the vehicle in front of them. Based from the information collected from said censor the vehicle can stay at a precise distance from the vehicle in front of them. At higher speeds this distance can increase and at lower speeds it can be super close. If most vehicles had this innovation traffic jams could be eliminated. Another innovation that could help decrease traffic jams is if vehicles could automatically change lanes while traveling forward on the road at the same speed despite the extra distance traveled due to the lane change. The vehicle can automatically accelerate the right amount when changing lanes to maintain the same total speed.

A self-driving car that uses sensors to navigate itself on the road and around other cars can slow down or speed up based upon the trajectory of merging traffic so that the merge can be made as smooth as possible to keep the speed of traffic efficient as a whole.

A vehicle can have a computer connection with the other vehicles on the road with it. Based from the information collected from said connection the vehicle can stay at a precise distance from the vehicle in front of them. Traffic jams are commonly created when the number of lanes decrease or when ‘on ramps’ merge. To solve this, said vehicle computer connection can organize a smooth merge between the vehicles. This is done by the corporation of many vehicles interacting together.

A center console in a car can wirelessly charge a phone without incremental ridges that protrude more than 3 mm.

A magnetic clip can be used to close charger cover and prevent debris from entering on a smart phone or laptop.

An aluminum/metal can, can have a layer of peelable plastic over the opening of a soda can for sanitation reasons.

A resealable package could be made where the resealable lock has two specific plastic pieces that protrude from the seal, one on each side to make it easy to open. These two pieces can be slightly offset, so they can be distinguished. A perforated layer above the seal can also be offset for the same purpose. Said package can reseal by groves that snap together.

A smart phone can have rotating lenses, camera/s, and sensors. They can rotate individually or a system of them together can rotate.

A smart touchscreen watch could be made without any buttons on the watch that protrudes of the surface of the watch more than a millimeter or two. A smart watch can have a touchscreen dial that doesn't protrude at all or very slightly.

When adding photos to text/email the user can be able to select multiple at a time, when adding them to the text draft. This can be done by pressing a setting that lets you select as many as you want and to unselect just touch the photo again.

A gaming console remote can be made with a touchscreen.

A decoy animal can be solar powered to make moments.

Adjustment dial in interior of vehicle that could be for radio channel/volume/air-conditioning adjustments/or more, where said dial is circular and when it is spun it causes a physical hand, like that of a clock, to rotate at the same or different speed relative the turning of the dial. This physical hand tells the level of what the control nob has set.

To have more space in a truck with a truck bet cover to fit gear. The back part of the truck cab can fit together with the cover of the truck bed so there is no barrier between the two on the surface that faces that back window/s of the truck. Said truck bed cover can have a roof and three edge panels as apposed the normal four edge panels.

To help a car or truck roll out from rough terrain, one or more wheels, or rotating tracks can be attached to or near the front frame or bumper. This also helps trucks and cars more smoothly roll away from landings where the car or truck nose dives. The same placed on the back of the car.

A trailer hitch or bike rack can have a rotating wheel on the back bottom surface. When going through rough terrain instead of strapping the trailer hitch or bottom of bike rack the wheel can allow it to roll out of it. An axil and bearings can also be used in this assembly.

To enable the driver to keep one of their hands on the steering wheel on a turn, a rotating handle that is not circular can be attached to or apart of the steering wheel. One can be on each side of steering wheel with a rotational pivot point that attaches to steering wheel that allows this handle can spin indefinitely. The steering wheel can be a bar that has these two handles on either side. Said handles can be in a variety of shapes some designs can include a bar or a loop.

To be able to adjust a steering wheel to the driver's desired position the angle of the steering wheel needs to be adjustable without adjusting the height of the steering wheel. This is done with a rotation pivot at the base of the steering wheel that allows the angle to change. This pivot can be adjusted with an electronic powered system. Once adjusted the system can lock the wheel into position by siding a metal part into the pivot so that it can't rotate.

Instead of having four back tires and wheels attached to a truck's back axle to improve grip for pulling power, it could have a standard two back tires and wheels, but the tires and wheels could be made wider than the front tires and wheels. This will give the back tires more friction when pulling heavy loads. The back axle can also be made longer or shorter than the front.

On hot days the metal on the seat belt gets so hot that if you touch it, it will burn your hand. To solve this problem a less-heat-absorbing material can coat the metal of the seat belt, as well as the steering wheel. This can be a white/light colored rubber or plastic.

To make airplanes more comfortable for people who like to sleep, bed pods can be available instead of seats. These can be single tube like structures or have enough room for two or more people.

An airplane can have a track that can dispense food and beverages to different isle's. Said track can have conveyer belt to deliver food or drinks. A track in the shape of a half-pipe can deliver canned and bottled drinks, the bottom of track can be a conveyer belt. Said tracks and conveyer belts can be located on the isle and/or window side of the passage seats.

To keep a car cool, and prevent people from being able to see into your car people put shades on their dash board. Said shade can be built into car, where it is rolled up on one side of the cars windshield and can hook to the other side of the cars windshield. Or the said shade could be rolled up on either the top or bottom of the windshield and can hook to either the bottom or top of the windshield respectively.

A car can have a sensor that automatically turns off high beams if it detects a car driving towards them, so it doesn't blind the driver. Once the car has passed the high beams can automatically turn back on. For a self-driving car with a location emitting chip a program can be made so that the high beams automatically turn off when the car is a certain distance away, and automatically turn back on once the car has passed.

To be able to adjust a steering wheel to the driver's desired position the angle of the steering wheel needs to be adjustable without adjusting the height of the steering wheel.

A vehicle with a hatchback can have a platform that can extend from the back of the car. This platform is for sitting and setting stuff on. Said platform can come out of the back bumper and can be slid back into storage position.

A car can have a touch screen on roof or windshield of car.

To prevent drivers from driving with their parking brake, the car can automatically release the parking brake when the car is put into a gear other than park. And could get automatically put on when put into park.

Buttons to unlock a car can be placed on the surface of the door handle that faces towards the car. A car can also be unlocked by a fingerprint scanner on the inside of the car door handle, or on the outside of the car door handle or on the surface of the door.

To make long car rides less boring in a self-driving car the car's windshield and or roof can be a screen.

Car seats could be made with built in massage mechanisms. Car seats could be made to lean extra far back and the seat to sink extra low into the floor of the car to make a better sleeping environment for the passengers, especially for self-driving cars. A car interior can be made with no seats, but grooves in the interior for laying complete with safety belts.

For self-driving/manual-driving cars their computer can be programed so that before they make a turn they put on a blinker. This is done be censors detecting a lane change.

A large database on self-driving cars where car routes are shared between each other to prevent accidents and find fastest way through traffic.

To avoid robbery of valuable possession in a car the center console can have a lock on it so it acts as a case. To avoid the annoyance of having to unlock the center console every time you want to get something out of it, there can be a mechanical or electrical setting to keep leave the console unlocked or locked. If the car is on or unlocked the center console can be unlocked, otherwise it can automatically lock when shut.

It is very frustrating when objects fall in the slim area between the cars center console and the seat. To avoid this problem a material layer from the center console can overlap the edge of the seat to block objects from falling in the crack. The crack can be eliminated by a stretchy layer of material that attaches the center console to the seat. It is important that this is stretchy so that the seat can be adjusted.

A car can have a middle seat next to the driver that can fold down, and become a center console.

When car seats are leaned back, they are much less safe because the passenger can slide forward underneath the seat belt during rapid deceleration. A seat belt can be made that is secured between the legs so that it stops the passenger from sliding forward. Foot grooves can also be in-place so that the leg muscles can also be used to stop the passenger from sliding forward. These are needed to have a safe car where you can lay down.

To increase the fuel efficiency by aerodynamics trucks tail gates can folds inward. This can be done by having a hinge or series of hinges that can fold 180 degrees with a stopping position at 90 degrees. When the hinge/s has the tail gate in the upright position at 90 degrees compare to when it is laid down, the tail gate can be brought up on a track several inches and then it will be able to fold down inward and flat with the truck bed. This motion can be electronically powered or down mechanically with the strength of the user.

Tire spikes are put in place to prevent cars from entering an area but allow them to leave. If a car goes over are tire spike the wrong way then the cars tires are popped. However it does not stop the car dead in its tracks. Tire spikes that a “r” shaped, where the spike protrudes up and towards the wrong way traveling car. This spike does not simply poke a hole in the tire but also forces two holes to be pokes in the area between the holes to be ripped. This takes much more force and will stop most moving vehicles dead in their tracks.

Gun holster built into sports car/car/truck. Protective frame keeps it concealed. Can be made with a lock. Said holster can have a latched and be located in the vehicles inside of door, below the steering wheel, or center console.

Birdshot in smaller diameter shell so that it can be fired out of a rifle.

To make car windshield wipers more efficient a single blade can sweep the entire windshield by going from side to side or from top to bottom. The windshield wiper can be powered electricity and move along a track. To make it more convent for the driver a sensor can detect the amount on oncoming rainfall on the car to automatically turn on the windshield wipers and put them at the right speed for rainfall.

When driving down a winding road at night it is hard to see what is ahead of you around the corner. Head lights can be made with reflectors that turn when the steering wheel turns to angle the headlights in the direction the car is driving to see better on winding roads at night.

When vehicle breaks are applied super heavy the back break lights can blink and/or shine brighter than normal. A vehicles break lights can be LED lights to get the attention of drivers behind them.

Surf leash with helium core for buoyancy. This limits drag on kelp. Foil board with two mast attachment. Surf leash that is made with a wire cord. Surf leash, where end of strap loops back through a part.

Surf wax with ridges so the wax rubs off easier. Surf wax can have a words or drawings imprinted on them for branding, beauty, or to be informatory.

In order to make a hydrofoil easily to attach and detach from a board, the tracks on the board can have a slightly bendable but very elastic bar that runs the length of the track. Said bard can have a wheel around it. A foil box can be made that has grooves that fit into said bar and wheel, however the part before said groove is bigger than groove, this makes the foil snap into place with the track. This is a bar and wheel attachment like the FCS 2 fins and fin boxes have.

In order to make a hydrofoil that is meant to be attached to a board the hydrofoil can have multiple masts for stability.

To make a hydrofoil more portable, the wings can be rotated to parallel with the fuselage. This can be most easily done by a rotation in the fuselage.

To make portable basketball hoops less likely to tip over when someone dunks support bars that run parallel to the ground can be attached to the base of the basketball hoop. These bars can protrude outward in the direction of the court.

To make a jet pack have better steering the jet back can have thrusters on the side that are parallel and adjacent to the users legs. Theses thrusters can rotate forward and backward for control. One or more thrusters can be adjacent to the users back and rotate side to side.

To prevent the melting of a chocolate coated bar a non-melting coating can be made to coat the chocolate. This can be a candy coating like what covers the chocolate of an M&M.

Velcro attachment between harness and wetsuit, to prevent the harness from riding up on the user. Velcro can be built into the harness inner surface and Velcro built into the wetsuits outer surface.

To give the diver an estimate on where the spear will shoot a laser can be built into a speargun. It can be attached at then end of the frame, and can be removable for recharging. The outer casing of the laser can be have a thread so that it can screw into its mount.

A wetsuit can be made with large pockets of air bubbles inside of the neoprene of the wetsuit material. This is for warmth and buoyancy. This can be done by an air injecting neoprene with a system that involves needle injection.

A wetsuit can have a hood that also has fabric covering part of the face like the cheeks and nose. This keeps the user warm in extremely cold conditions.

To prevent a persons foot from slipping off a slack line the slack line can cup the foot of the user. This can be done by having a slightly shorter length of material on the sides then the middle. This can also be done by having the material in the middle be more stretchy than the material on the sides.

To make a harness more comfortable and ergonomic it needs areas where folding is induced. A seat harness can have two parts separated by a line with an induced fold. This line with an induced fold can be a part of the harness that has an area of less and/or more flexible material. A waist harness can also have one or more of said areas of induced fold to make them more ergonomic when the rider moves. Adjustment straps that tighten the harness can be placed on both parts of a harness.

To make a harness strap more comfortable it needs to have more surface area so it doesn't dig into the rider. The extra of the adjustment that isn't being used is better off being small so it isn't in the way as much. An adjustment strap can be made so that the part that is being used is thicker than the extra. For this strap to thin down towards the extra end material can be missing in an area of the middle of the strap.

To make windsurf harness lines longer lasting they can be made from metal wire. For safety they can be coated in a rubber or plastic.

Shorty wetsuit where at the endings of the legs and arms is a plastic synch that helps prevent water from entering and from the ending of the arm or leg to fold over from impacts. Plastic synch ending on ancle high booties. Plastic synch ending on long sleeved, short legged wetsuit on arm and leg endings. Plastic synch ending around hood of wetsuit. Plastic synch ending on bottom waist ending on wet suit top. Plastic synch ending around waist of wetsuit bottoms.

To make a wetsuit bootie optimal for the user it needs to be grippy on the surface that touches the ground as well as the surface that touches the foot. On the inside soul of the bootie could be a textured pattern for grip. This can be for ancle or calf high booties.

A surfboard can be made with only the top half covered in carbon fiber and the bottom glassed with fiberglass cloth.

Wetsuit with layers of ridges and grooves to help a harness grip to it. A wet suit and harness can have grooves that fit into each other to better help them grip.

A rock-climbing gym where the climbing route is an uphill traverse in either direction in spiral or zig zag pattern where the matted floor can parallel these routes, so that the climber can boulder all the way up. Essentially it keeps the falling distance at a minimum. A foam pit can be placed in the center of the structure as a quick way to get down. For a route that doesn't traverse a padded surface can follow the pitch of the route and when the routes pitch changes slope the padded surface can change its slope so that they correspond with one another.

A rock-climbing gym can be made with multiple stories, where bouldering routes go up through the stories. These routes would lead the climber through a pocket. As the climber goes through the pocket, their back becomes close to the padding of the second level, and then they enter bouldering the same route on the second floor.

Wet suit made with low friction interior to make it easier to put on. This can be made with a high polyester or latex content surface fabric or a PEEK fabric.

To make cross country skiing faster and more fun each ski can contain a motorized rotating belt that when turns propels the skier forward. These motors can be electronically powered.

A jacket, pants, and wetsuit can have the exterior camouflage pattern of satellite image of the surface of the earth. This will create superior camouflage patterns because it draws a macroscale amount of terrain color patterns.

To prevent water from entering a wetsuit a plastic or rubber synch can be put around the very outer most edge of the ending on the wrists, ankles. For the ending edge of the hood and neck a rubber synch can be made that protrudes more than 0.5 mms.

To help prevent water from entering a wetsuit the endings at the ankle and wrists can have a stretchier and or elastic material attached there. This same principle can be applied to the hood, booties and gloves.

To make a wetsuits outer seam less likely to unravel, a rubber sealant can cover the outside seam's end, and conjunction point with section of said sealant while the rest of the seam is not covered.

In order to make a wetsuit easier to paddle while surfing, the fabric panel/s that cover the users shoulder, armpit and/or part of the latissimus dorsi, and shoulder blade, can be made thinner then the neoprene that covers the legs and/or arms, and/or stretchier by having a different jersey that covers the neoprene.

To prevent a wetsuit from ripping on the leg ending, a thinner and/or more stretchy material can be used in that area. A panel of thinner material or stretchier from having a different jersey covering the neoprene can cover the back half of the leg ending so that the heel can pass through without ripping it. This panel can end several inches from the leg ending up to mid-calf. The same can be done for the full circumference of the leg ending.

An alternative method to preventing the leg ending on a wetsuit from ripping is to have a rubber surface covering or replacing the neoprene fabric at the endo of the wetsuit leg most likely over the back side near the heel, or can wrap all the way around. Said rubber surface can have perforated or missing sections for more flexibility.

The outside of a wetsuit can be coated in silicon to repel water.

A layer of silicon, latex, polyurethane, polyethene, polycarbonate, or polyester can cover the seams of a wetsuit or hold the pieces of fabric together. These materials are very stretchy and that would prevent the seams from breaking.

To bring ornamental value to a shoe designs, logo, or writing can be made of a silk, leather, suede, or velvet material when the majority of the outside face fabric is not said material.

A shoe can be made with a helium bubble. This will lighten the shoe.

To make tags on clothing more comfortable they can be made of velvet.

Solid neoprene foam with strip of woven fabric in between it. This with prevent rips and will make a great wetsuit material. Said woven fabric can be a layer of thin stretchy material similar or identical to the wetsuits jersey.

Wetsuit with fluid seams but non-fluid seams on and around shoulder area. Said fluid seams can be seams covered by a rubber glue.

Small holes close to end of wetsuit wrist and ankle to drain water. These holes can have a valve so that water can exit but not enter. Neoprene gloves can be made with small holes to drain water, can have valve also.

4 mm/3 mm or 3 mm/2 mm wetsuit with extra fuss like surface on inside of core for warmth.

A wetsuit can be made with neoprene thinner in the arms than the legs.

Wetsuit where the arm of the suit ends into fingerless gloves, or full gloves or mittens. Wetsuit where leg portion of the suit end into a bootie. A wetsuit's hood can have a neoprene fabric panel that covers the area of the users chin to bottom of mouth, and can be shaped like a half oval.

Heat molded climbing shoes. For a better and more comfortable fit to the individual.

Toy gun that loads and/or cocks by being spun. The users fingers are inside the trigger area. Two or more fingers fit into holes for them. When the user spins the gun, the fingers hold a part so that said part is not spun but the gun is. As this motion takes place it winds up a spring or elastic material so that when the trigger or firing mechanism is initiated it can propel the projectile.

CO2 canister for paintball gun that is rectangular shaped with sharp right angles with the edge slightly rounded. This makes it better for storage and transportation.

A pair of pants, or shorts with an elastic waist can have a pocket that secures a firearm and/or a holster to the waistband. This can be built in or can have loops for attachment.

A lane line like device could be made with a powered device that has a handle and can tow a swimmer across the pool. This device could also be attached under water to zip people around and even to the surface for a breach. This device could also be built into the pool bottom or wall and could even be nonlinear.

A circular shaped pool could be made for the purpose of creating a whirlpool. A group of people can start the wave motion by moving in circle, or a prop can be placed at the bottom to generate the whirlpool. The shape of pool could taper into a tighter circle as the depth increases. Making a 3d shape like a funnel. Mesh layers for safety from propeller can cover the bottom.

A water park ride that consists of a thick layer of foam shaped into a ride path, strong top layer, with a waterproof seal, and network of hoes that supply the water lubricant. This can be great for rafting paths and sliding; jumps with take of ramps and landing can be made as well for both the rafters and the sliders. The landing zone would be made with thicker foam depth, and they can land on the wet foamy surface, or could land in pool that has more ride downstream also with jumps. With the right trajectory jump heights could reach 20 ft plus. The loop-dee-loop and side-ways-loop would need a foam thickness of about eight feet at the base. Fans can be used to cool people and push them along flat water. Two fans on either side hitting the raft at the focal point and push it forward. The fans stay a calculated distance behind the raft as it travels.

In order to have a serving size for dabs, hash, wax, or any condensed THC product could be rolled up into little balls of a precise size/weight for consumption. Or could be pressed into cubes or other shapes.

A gun with an adjustable explosion volume can be made so that it adjusts the strengths of gun. To lower the strength of the gun holes for air to escape through can be opened so that the air pressure is released. These holes can be adjusted in size and also be closed completely. This can be helpful if you are shooting to wound and not to kill.

To protect the fins of a surfboard in a surfboard bag, the surfboard bag can be made with fin covers that protrude from the bag. When the board slides in the fins slide into the protected pocket that covers them. A board bag can have 3, 4, or 5 fin covers.

Basketball rim where the top surface piece that attaches the rim to the backboard is slightly sloped. This prevents the basketball from being stuck on top of this part, by making it so it rolls off.

A basketball rim could be made easier or harder by the having the size of the rim adjustable. This can be done by having overlapping pieces of rim that can be slide out or in and locked into a new position. This can increase or decrease the diameter of the rim. The method of snaping the rim shape into set size can be done with a spring-loaded part that can be pressed in when changing size. Once it gets to an incremental size, a hole lets the part pop out and thus locking the rim into this size position. The rim close to the backboard can flex and/or have rotating parts to adjust to different sized hoops.

A basketball hoop system can come with an easily detachable hoop. Secured to the backboard is an attachment for the hoop. This can have the spring-loaded platform secured to backboard and this will be referred to as the base. The rim of varying size can a part that protrudes and slides into the base. The rim is additionally secured by clamps or snaps. Said clamps or snaps can be located on the bases protruding support beams which are on either side of center. The protruding part could also be screwed into its place, or snap/buckle in. Rims of just the rim with protruding part can be sold in sizes of 9-28 inches in diameter.

Stand up paddling and rafting are outdoor sports. Part of the appeal to these outdoor sports is to see the beauty of nature. An inflatable raft or stand-up paddle board can have a full or part area where the bottom of the vessel is clear so the user can see the beauty of the water.

To make a body surfer have more control, a soft top hand board can have a strap for the rider's hand. To increase the performance of a soft top surfboard the hard-plastic bottom of the board can wrap around and cover the rails of the board. To make a high-performance surfboard cheaper to manufacture, the foam of the surfboard can be covered in a hard plastic or rubber on the top, bottom and rails. To make a surfboard extra light helium can be put inside the board. Plastic coated surfboard with hollow center. To get a wetsuit to have better range of motion but still keep the user warm the difference in thickness between the limbs and torso can be 1.6 mm or greater. To prevent water from entering a wetsuit at the ends of its limbs coverage a stretchy elastic material can cover the very ends of the limbs. To prevent a surfer's feet from separating from the board when doing an air one part of the Velcro can be on the surface of the board and the other part can be on the underside of the surfer's booties.

A wave pool can be made more efficient by a rotating hydrofoil wave generating system surrounded by water on all sides. When the device spins its wave creating apparatus it can expel one or more waves in a spiraling shape. This can create a wave that never ends. To eliminate reverb at wave pools gutters can be made.

Safety on spear gun that is a lever you pull down on the top back corner of the gun.

One-piece curved dive mask. This will be a modern take on the old school one-piece dive mask, but will have better peripheral vision because of the curvature.

Glass fishhook so the fish can't see it. Glass weights as well.

Game Show: Miss spelled words: Sentences spelled with percentage of scrambled letters, first person to guess it wins and contestants take turns.

A knife can be mounted where the blade of said knife can have a sheath that is inside a spear gun handle. This makes the knife more convenient. The knife can secure itself to the inside of the handle by snaping or clipping in, or by magnets. Magnets can be place on the end of handle of knife to connect with surface of sheath. An elastic loop can also secure the knife to the speargun.

A magnetic weight belt for diving can be made so that it would protect from shark attacks. Large magnets can also be placed in a speargun, or in a bag for this reason.

To reduce resistance on a spear a swiveling barb can be made flush with the spear. To the convince of the diver a flashlight can be built into the end of a speargun frame. It can screw in and be deep enough to hide all or most of the flashlight body.

To prevent a phone from jiggling around on a runner a shirt can be made that has a pocket on the sleeve of the shirt, where it can be snugly strapped around the arm with Velcro to prevent jiggling. To give a wearer of a hoodless and collarless, pullover jacket more places to hold items two chest pockets could be made. On said jacket with or without said chest pockets could have too zipper pockets that connect on the lower front side of the shirt. A hooded pull over sweatshirt can have two zipper pockets that connect on the lower front side of the shirt. To help reduce the smell of body odor a pair of underwear, thong, bra, shirt, pants, and jacket can have a smell built into them. A pair of socks can have a built-in smell that is meant to smell good.

To give a hat a better and more secure fit a strap can wrap around the circumference of the hat and tie in the back.

Socks can be made thicker patches of fabric covers the heel and ball of the foot specifically. Socks can have three or more different fabric thicknesses. Around the opening of the sock can be a stretchy material similar to the waist band of certain types of underwear.

To keep a waterproof jacket as dry as possible a plastic layer can go over the seams of stitching on the jacket. Said plastic layer seals the seams from water leaking.

To make a soft can comfortably layer of fabric waterproof a layer of plastic can be placed over the fabric and hot water can be poured over the plastic. The hot water causes the plastic to bind with the fabric, creating a waterproof surface.

To prevent seams from tearing on clothing a strip of cloth can be directly sown over the seam to reinforce it. Rubber glue can then cover the two surface seams

To make a shirt or jacket have better range of motion in the arms the fabric in the back, shoulders and/or arms can be made stretchier than the rest of shirt or jackets fabric.

To make gloves easier to put on they can be lined with chalk on the inside. This also helps prevent the hands from getting sweaty.

To make ankle socks less likely to slip off someone's foot unintentionally a grippy material and be attached to the inside of the sock. This can be a line of rubber on the inside perimeter at the mouth of the sock opening.

To make the edges of clothing more comfortable for people with sensitive skin a liner of fabric can be stitched to the clothing from one side of the edge to the other. This prevents abrupt endings on the edges of clothing.

Synch ending exposed from the outside on hat. Stretchy material that make up the synch can be flat and about an inch wide and about ⅛ to 1/16 inch thick.

To make a flannel give more range of motion in the arms pleads can be made between two panels of fabric that are higher than the shoulder blades and farther than an inch inward from the arm fabric panel.

A short or long sleeve shirt can be waterproof so it can keep the person dry while no insulating a lot of their heat like a jacket would. This is good for areas of hot and rainy climates.

To make a rain jacket more comfortable it can be made out of a soft cloth like a sweatshirt, but have a waterproof outside layer. This can be done by covering the outside of cloth apparel in a liquid material that will dry on as a solid and flexible water repelling surface. A liquid repelling substance can be sprayed on apparel to prevent the apparel from soaking up water.

To get the fabric on clothing have a great fit the fabric can be laid over a hot surface. The fabric can then be pulled tight around the surface to, change the shape of the fabric to be more similar to that of the hot surface. This can make the fabric want to find around the person more ergonomically.

To eliminate seams on apparel a liquid can be fitted into a mold. Once that liquid has dried it hardens in the shaped of the mold that is the shape of an apparel item.

Cloth that is spun into the shape of a shirt, jacket, pants, or shirt with out the uses of stitching.

To minimize lines of skin irritating stitching on a shirt or jacket only two lines of stitching need to be made. A line of stitching from the bottom of the shirt to the sleeve on each side. Or a shirt with a line of stitching from bottom of the shirt to the sleeve and stitching from the sleeve to the head hole, only on one side. Pants, leggings, or shorts can be made with only one line of stitching from the bottom of one leg to the bottom of another leg.

Sock with top stretchy liner made from different material. Material like waist band on underwear.

To make a collared shirt more comfortable when buttoned all the way up the fabric that goes around the neck can be made stretchy.

To help a foldable touchscreen phone not rotate more than 180 degrees a precisely flat or angled cut could be made where they fit flush and at a perfect perpendicular 90 degree angle(rolled in edges that create an uneven backside is what current phones have.) To make this possible one or more pieces could be made from a hard or soft rubber or plastic. Another way to make this junction snap into position well is with the use of magnet to attract the two side together. The magnetic currents could be altered by use of the smart phones technology.

A touch screen volume control bar can present on the top surface of a smartphone.

As a place to hold a pair of glasses, headphones, or pen when not being used a piece of fabric can be stitched on a shirt. Said piece of fabric can be stitched on except for an area near the bottom and an area near the top. Said two areas of open stitching are made to allow a pen, temple of a pair of glasses, or head phones to penetrate.

Headphones can be made with a screen/touchscreen surface.

Wireless headphones could be made with vibrating capabilities. This could be used to improve music experience and for text or call notifications.

Phone case with speaker that can connect with the phone.

A screen cover can be made to go over phones, televisions, laptops, computers and other screens that block harmful blue light.

A television that plays main tv channels like the news, sports, comedy, movies, history channel and more can have a button on the remote that allows the user to rewind what they are watching by five, ten, fifteen, 20, 30, 60 or more seconds incrementally. This can be done without the show/channel being recorded. As the user is watching live news, for example, the user can go back an incremental amount of seconds or hold down a reverse button to rewatch something that they want to see/hear again. When the reverse button is pressed the video is played in reverse for as long as the button is held done or when another button is pressed to play the video/tv channel at normal speed.

A television remote can have the ability to make a cursor appear on the screen. Said cursor is like a cursor of a laptop or computer. When a button is pressed the cursor feature can be turned on and when that button is pressed again it can be turned off. A censor at the end of the remote can project the cursor in a straight path onto the screen. This can be helpful when typing with the tv remote. When the cursor is over a letter a selection button on the remote can be pressed to select the letter. This cursor can also be used to select any number of things that appear on the screen and can be especially useful for video games and youtube.

To help channel surfers know if what they are watching is on commercials or not a symbol can be added that shows up if the channel is on commercials. Said button can be shown on the tv guide and bottom channel label. A button could also be added to the remote that takes you back to the channel once it is off commercial. Just press the button on the channel while it's on commercial and then you can go watch another channel until the first channel is off commercial and the remote button feature will automatically take you back to the first channel. A TV remote could have the alphabet as primary buttons. A touch screen TV remote can have the alphabet keyboard available on the touch screen.

A sealable plastic bag can be easily rid of excess air by having tube with a one way valve, where the user can suck the remaining air out.

On a digital system that saves and displays documents, it could have a feature to search for words within the document where it is able to bring up multiple words. The software will search and locate the series of words if they are within the same order, or similar. Said system could have software design so that when the arrow control buttons are pressed on the device it takes you to the next or last usage in the document.

High tech glasses that use artificial intelligence and is able to display thing for you to see like texts, and online documents can be made tinted or transitional so that they can be better used in outside conditions. Said glasses can have their tint change with precise software instructions or bases on light censors.

Smart glasses could give the user navigation directions with a line of the path they should follow. When on a road the glasses can clarify stop lights, street signs, and crosswalks by emphasizing the signal with visual display.

Smart glasses could be made so that if you look at an object the glasses can focus on it and magnify the object like a magnifying glass or microscope. This could be a zoom of ×10 up to ×1000 or even more. To make this possible the glasses would have a camera or a set of cameras that specialize in varying magnification. The device can recognize your hand to under stand the object to be focused in on is what the hand is holding. Video stabilizing software can be used to keep the image the user sees relatively stable, as the movement of the hand or head increase with magnification.

Smart glasses with two or more cameras for varying zoom magnification or other specializations. In this style of glasses the arms of glasses go around ears but don't tough one another behind the head.

On smart glasses a clear of colored earpiece can connect to the arm of the sunglasses and reach and fit inside the ear as headphones do. The cord that connects the earpiece to the arm of glasses can be clear or colored as well.

A smart pair glasses can have a protruding an retractable part that goes out of and retracts into the arm of the glasses. Said part can have a speaker to play music close to the eardrum. Said protruding part can have a soft flexible rubber or silicon tip to not damage the eardrum in case of an accident. Said protruding piece can be in the shape of a straight or curved line that curves back towards the ear. With straight line design the speaker can face the ear drum. Another design can be a in the shape of a capital L or reverse capital L to put speaker near the ear drum. With either the protruding part design that can be retractable or the earpiece with cord design the end speaker part can wrap around the back of the ear and have a connection to the end of the arm of the pair of glasses. In said cord piece and protruding part can have wires that connect the speaker to the electronic computing module in the frame or arm of the glasses, where if it connects to frame wire run along the arm.

Smart watch with two or more cameras for varying zoom magnification or other specializations.

A case for wireless headphones could be made where the case cups the headphones but does not completely cover them. Magnets could help hold the headphones in. They could also snap into position. The headphones could rest closer to the phone than the rest of the outer surface of the phone case. This would be important to make the headphones to be attached with a lower profile design.

An online platform could have advertisements that can be rewound or played in reverse or to go back 5, or 10 seconds if the user was intrigued by the advertisement.

An online platform that displays video content for amateurs to post could have a user-friendly feature where if the curser/mouse is over a video than the full title of the video or movie can appear for the user to read.

When the user has their curser/mouse over the video icon/display image or text a selected video cut that represent part of the larger film can be played with volume, without the size of the video changing and/or an icon bar below the video.

When writing a text document and a word is spelled wrong, the document software can have a feature where it underlines, highlights or alters the word so that the user can see that it is incorrect in some way. If the user hovers its curser/mouse over the word, without even clicking, the proper spelling or grammar suggestion may appear for the user to select. If there is one strong recommendation by the software then it can replace the incorrect as soon as the curser is over the word or phrase, or even as the curser is moved toward the direction of the word or phrase.

A smart phone can detect the surface tap on the back of the device. This can be beneficial for playing games.

On a limited time social media post, when editing the photo or video for posting the user can have the ability adjust the amount of filter. Filter being an effect that changes the colors and contrast of the image/s or video.

As an alternative connection for belts a binding system can be set in place.

Traditional Flannel shirts and jackets provide limiting range of motion to the arms. To make up for this flannel shirts are made with extra long sleeves. However, it is annoying and uncomfortable to have too long if sleeves. A synch ending can be added to said flannel so that the extra length of the sleeve doesn't go down farther than your wrist. Said synch ending can be made of material similar to that of an underwear waistband.

Sliders are similar to flip flops except they only have a strap that goes from one side of the foot over to the other. For comfort and fashion there can be multiple straps that cover the foot, ideally two or three, this strap can be adjustable with Velcro.

To make a collar more ergonomic with the shirt and shape of the person an arc shape can be made into the end of the collar. This arc fits around the wearers shoulders and chest for a clean even fit.

To create a more comfortable waterproof jacket a cotton containing fabric can be covered in a waterproof coating.

To help shoelaces from getting untied unexpectedly, normal shoelaces can be made stretchy and elastic. A stretchy lace makes a very tight knot. Over time of use this knot may become so tight that it can't be untied even if you tried, but the user can still slip on the shoe because it is stretchy.

Button up shirts are uncomfortable and unattractive on people when then shirt is too small and it causes openings in the shirts between the buttons. To solve this problem the fabric lining the strip where the buttons attach can be made from less stretchy material. A strip of Velcro can also parallel the line of buttons to prevent openings between buttons.

To prevent gaps in the shirt between buttons from the shirt being too tight a stretchy material can attach the button to the shirt.

A more comfortable type of style of cuff that can be put on the end of jacket or shirts sleeve can be a cuff where the ending is folded back over the sleeve then buttoned down or slack is pulled from one side and then folded over and buttoned down and/or folded over once more. Said styles of cuff can also be used at the end of a pants leg.

To give the wearer of a hoodie more range of neck motion when wearing the hood, a strip of stretchy material can be added at the lower part of the hood or at the base for as long as it does not make a full loop.

To make a pair of leggings that don't have stretched out ends at the ankle and waist a more stretchy or elastic material can be added to said ends. This stretchy material that can line the end of the leggings can be like a waist band on certain types of underwear.

To make a logo or ornamental design pop on an article of clothing or shoe said logo or ornamental design can be made from silk, glass, suede, corduroy, or velvet where the majority of the clothing or shoe surface isn't. Not including buttons, buckles, but includes laces.

To improve the range of motion for a pair of pants stretchy material can be added near the knee area that is stretchier than the majority of the pant material. The same can be done to the elbow on a shirt or jacket.

A synch ending can be put on an open pocket to prevent items from spilling out. This pocket can be in athletic shorts, sweatpants, and in a hoodie.

A beanie can have a stretchy and elastic synch ending to help secure it to the persons head and increase insultation. This stretchy material that can be like a waist band on certain types of underwear.

To make jeans have a more secure fit around the ending near the wearers ankle a synch can be made of stretchy material.

To completely prevent glasses tans a pair of glasses can be made of only transparent material. This means the hinge can be made of glass or clear plastic, or not have a hinge.

To make it easier to button and unbutton an article of clothing the material around the hole for the button to go through can be made stretchier than the surrounding material.

To prevent a beanie hat from getting soaked wet it can be coated in a layer of silicon.

To make a hat fit a range of sized heads a hat with an opening in the back can have a stretchy material that connects the opening at the bottom said material can be made of jacquard or another stretchy material that doesn't scrunch up when not stretched out.

A front brimmed hat can have woven plant material in the back half of the hat, such as straw.

To make shoes look better they can be laser treated. This can distress the outer layer of the shoe. A layer under the distressed layer prevents the shoe from having holes in it.

A company's logo can be stitched on the knot of the tie as a good place of brand recognition.

A button up collared shirt or jacket can be made without wrist buttons to reduce weight. Instead the stretchiness of the shirt lets the hand in the wrist opening.

Line of stretchy material across back, shoulder and arm to improve range of motion on shirt or jacket.

A shirt can have a neck synch that expands more than relaxed size when worn. This will give the user a snug fit.

Sport coat with no buttons or snaps on wrists.

Joggers made with Jacquard synch at ankle. Jacquard material on shirt or jacket collar.

Pants made of a cotton or cotton and polyester and/or latex blend fabric that has thickness of 0.006 inches to 0.02 inches.

To strengthen a pocket plastic can line the outer edge of a pocket without there being a zipper.

To give a sport coat collar or lapel volume an induced crease can be added in it. This can be done by heat molding.

To make a collar fit more ergonomically an inward induced crease or curve can be made. To make the collar fit around a tie well an outward induced crease or curve can be made. Said creases or curves can be made from heat molding.

To make a suit fit more ergonomically a shape ergonomic to the shoulder can be heat molded into the sport coat.

To prevent the sleeve of a shirt or jacket from sliding over the users hand. Said sleeve that has buttons can be made with an induced crease that keeps the sleeve creased up. Said crease can also be done on pants. This makes the sleeve off of the wrist and the pant off the ankle.

A clothing article can have a two staged synched ending, where two synchs are stitched together. The synchs are in descending order so that they get tighter towards the end.

For brand advertising purposes something can be printed, sowed, or patched onto the area of the tie that has the outer facing knot.

A towel can be made where when it is brought around the waist of the user a button can fit into one or more buttonholes to receive it so that the towel is secured for changing.

Jeans or pants can have a split ending where a button is used to connect it and the button is made to be outward facing when once folded.

The end of a lace can have a piece of glass attached to prevent the unraveling of thread.

To make a shirt or jacket wrist ending that has one or more buttons or snaps, can have a more ergonomic fit the wrist ending can be made of a stretchy material that is more stretchy than the majority of the rest of the shirt.

A jacket, especially made for snow sports can have the end of the sleeve connect into fingerless gloves and mittens or gloves can be zipped onto the end of the sleeve. This zipper can run around the circumference of the wrist. Said fingerless gloves, mittens, or gloves can also be built into the end of the jackets sleeve. For the gloves and mittens there can be a zipper that runs along the length of the hand and wrist either on the top or bottom. When this is unzipped the user can take their hand out for better finger function.

Neck synch on apparel that has multiple thicknesses and/or widths.

To make a beanie cover more of the wearers head without covering their eyes the edge brim of the beanie can have a curve that gets away from the wearer's eyes.

To make an underwear, short or pants fit better around the wears waist and butt the circumference band of the waist can made with a downward curved shape towards the groin.

Polo shirt with dress pant clip instead of buttons. Said clip can be used on wrist fitting and on a hat.

Old style watch where hands write numbers. As the time changes so does the numbers by rotating little arms that configure numbers. For example, when a 5 changes to a six the an arm can rotate that was hidden under another arm to connect the open bottom potion of the 5 turning it into a 6. This process can be done for all the numbers.

A shirt can have a pointed arm hole that goes down the wearers latissimus dorsi. Flannel with stretchy wrist cuff can be made of Jacquard or waist band material. The back panel on a shirt can be made of a heavier cloth than the front; this will slightly pull up the front giving the shirt a unique fit.

Neck collar where the part over the back of the neck hangs down longer. It would be shorter over the trapezius muscle to better fit the body. This neck collar design is not a folding collar but a normal collar for a t-shirt or expensive t-shirt with jacquard/underwear waist band like material. This design gives the neck collar of the shirt a curved pattern so that it curves over the trapezius. To do this a stitching on either side of the collar can be made where the collar is sewn together at an angle and don't match up flat or in-line.

Ergonomic curve of neck synch to better fit around muscle and bones.

Velcro patches with skirt between them, for wrist size adjustments for jackets, flannels, rain jackets and pants. Along the wrist endings outer surface a patch of male Velcro, a space, then a patch of female Velcro makes this design.

Surf bandana can be made with a low water-absorbing material. This bandana can be made not in a square but in a shape that has two ends for tying that are long strips, and the area that covers the forehead can be folded over multiple times and stitched down into proper position for wearing as a head band.

Strap that goes under butt check on underwear or swimsuit bottoms to help lift up the butt.

A shirt or jacket can have the wrist ending creased back to give more mobility to the wrist. Said crease can be at a slant.

A tie can have one or more creases in it to make it fit better around the person or other clothing. It can have a center crease to give a bold look.

One or more extra creases on a shirt or jackets collar to better fit the person or a tie.

A shirt or jackets collar can have a heat molded shape.

To prevent a zipper from unzipping unintentionally, a snap or piece of Velcro can be attached to the end of the zipper handle to attach to the surrounding surface, or to a strap that goes over the zipper.

A small groove on the end of a zipper body can snap into a groove on the end of the zipper track.

Stuffed synchs, collars, or endings on clothing articles for added warmth. Neck collar that is stitched down completely or partially. Skintight pants made of polyester based fabric that is thicker than 2 oz.

A collared shirt or jacket without a neck split. This means without any buttons and/or without a split in the front of the neck that is longer than 4, 3, 2, or 1 inch. Without any split at all it would be like a t-shirt with a collar.

Non frayed hole in pants. Where end of hole is stitched down on the inside.

Shoe tongue that has a more ergonomic ending with the base of the ankle and/or lower shin, so it doesn't slide to the side. This more ergonomic design can have a split or divot in the middle of the tongue. Another way of preventing the tongue for sliding is by putting a snap/button or Velcro that connects the tongue to the body of the shoe. Said snap/button or Velcro can be on either side of the shoe tongue and can attach to either side of the shoe body that is near each side of the tongue.

Jackets that open down the middle of the torso are usually closeable by buttons or a zipper. An alternative method of closure can be from a Velcro strip.

Induced crease on hood to make it have a more precise fit.

When using a ruler to draw a straight edge it is hard to draw the same distance from the ruler every time. A ruler can be made with a slot in the middle for an accurate line to be drawn. On one end of the ruler can be a point or spike that the ruler can rotate around so the ruler can act as a compass. Said point or spike can be spring loaded so that a spring hides it when not in use. When a button is pressed on other side of point the spike can protrude and grip the surface. The spike can lock into a protruding position. A ball can roll on the other end of the ruler.

A building block that is a cube that offers attachments on the surface of all six of its sides. Where three of its slides are female and three are male. Each surface opposite to one another also has the opposite attachment, either female or male.

To help kids color inside the lines a coloring book could be made with ridges around the lines of a drawing.

The graphite of a pencil with a wooden body lasts much longer than the eraser does. To make the pencil last as long as the eraser, the eraser should be reattach-able. This can be done with a clip, clamp, snap or screw in motion.

A mechanical pencil can be made that dispense rectangular shaped graphite for writing. Mechanical pencil led with a sharp controlled angle. This makes handwriting much more dynamic. Triangular, pentagram, hexagonal, heptagonal, octangular, nonagonal, or decagonal bases on mechanical pencil graphite can be made. The same can be done inside a wooden pencil.

To prevent papers that are stuffed in the pocket of a binder from falling out a clip on the top of the binder above the binder could clamp on the papers and secure them. Or a part of on the top of the binder could protrude perpendicular to the face of the binder holding the papers to block them from slipping out. Said protruding part could attach to other side of the binder when closed and secure the binder from opening and from papers coming out.

A more convenient way of storing a pencil or pen in a binder than in a pocket is by a snap. This snap has the inside circumference close to that of a pen or pencil but doesn't completely surround the circumference of the writing utensil, so the writing utensil must be snapped in. Said snap can be attached to the binder, or on the surface of a bag that attaches to the binder by its rings, or multiple snaps connected by a base structure can be attached by means of loops the fit in the binders' rings.

When drawing a poster, it takes a long time with thin markers. Markers could be made specifically form posters by having a wider brush that is 0.75, 1, 2, 3, 4, 5, 6 or 7 cm to make it quicker to draw large images.

To have greater efficiency for an artificially created wave in a wave pool that breaks as an a-frame, land should be in the middle between the left and right break. This increases wave efficiency because there is no unused wave energy at the part that is land. Surfers and spectators can also walk out their can get a closer look at the action.

An A-frame standing wave can be made by a current of water like a river by a 3-D base structure that rests on the bottom. It can be in a “V” shape where as the two lines of the V distance from one another the more the structure protrudes toward the surface. This makes the wave steeper and even barrel. As the structure protrudes it does this with a curve to create a smooth and steep wave. The same can be done with half the V so that it makes a wave that is either a right or a left.

To increase distance of waves at a circular wave pool the bottom can be contoured so that waves break in a spiral shape. With this design all the waves would be breaking the same way either rights or lefts.

A wave pool with multiple breaks can have some waves made to break differently for the preferences of different surfers. Some waves can be steep barrels others can be softer and crumble gently. This is all determined by how quickly the bottom goes from deep to shallow. An artificially made bottom for the purpose of surfing that has different stages of bottom shape to make a different shaped wave along the break.

A water slide can be made that has turns and then at the end has an incline so that it gives the person airtime before landing in the pool.

A waterslide that has a jump at the end into a pool, where the pool is giving off air bubbles to make the landing softer on the person.

Slingshot that launches a person up a water slide, so they get airtime and then land into a pool. A slingshot that launches a person into a body of water, or foam pit from a waterslide runway or a controlled track.

Circular wave pool where the wave is created by a spinning device. Said device can be a hydrofoil wing that spins like a screw.

In order to get a skateboard to pump efficiently and so you can create propulsion from pumping, so you don't need to push with your foot the hanger of the truck needs to be elongated and flexible, especially the back truck.

The top deck of a skateboard can have a double concave design to give the rider better traction. This creates a divot for the heel and ball of foot and curve for ark of foot.

To make scooters safer for ankles. A soft material can cover the sides of the scooter.

To make skateboarding trucks grind farther the part of the truck that makes contact with the rail can rotate. This reduces friction and lets the rider ride the rail longer. To make it easier to balance on a truck grind the truck surface can curved. This makes the rail want to be in the middle of the truck when grinding.

A swing for four legged animals. Four holes are made for the harness so the dog can run. Each leg hole can have adjustment straps for a snug fit. The harness covers the chest and stomach of the animal. The top of the harness offers one or more points of attachment so it can be attached to a rope that is placed in tree or someplace high. The animal then runs and swings up into the air.

To simplify walking gear for a pet a walking leash can be extracted from a collar. It can have a spring or bungee system inside the collar that stores the leash in an organized way.

Dogs love playing with towels, but they always tear them and ger them dirty. A towel can be made extra tough for dogs to use as their toy. A dog toy or stuffed animal can be sewn into one or more of the towels edges or corners. Said stuffed animal can have a squeaky toy inside it. Said towel can be larger than 18, 24, 32, or 36 inches in length.

To create an incentive for a dog to play with a toy. Items can be stitched inside a fabric dog toy. These items can include additional toys, like a ball or chew toys, as well as food.

An envelope can be made with a stamp already put on or printed on it. So when a person buys that envelope it comes with a stamp already on it and ready for use.

When products are hung on display in a store if they are a small product then they are hung by hole cut out of cardboard/paper. These cut out cardboard holes tend to rip. Plastic packaging don't tend to rip but they are more expensive and worse for the environment. My solution is a cardboard/paper packaging with a plastic, or other material stronger than cardboard to reinforce the top of the hole or the part above the top of the hole.

To make packaged products easier to open they could be sealed by glue that is perforated. This perforation means there are incrementally areas of no glue. A machine could be made to make these incremented layers of glue.

To make it easier to open an envelope without tearing it to shreds the envelope can have a perforated top edge or perforated horizontal line below the top edge along the length of the envelope.

To bring excitement to gifts a gift bag can be made with a sensor so that when the bag is opened music starts playing. Magnets, or hooks, lace or clips can be used to keep a bag closed.

A music playing app can be made with songs on an album or playlist that can be reorganized into different orders. This can be on an artist created, or user created album. To change order the song can be selected by holding your finger over it, it then becomes movable and will stay in the order it is dropped off respective to other songs. Once it becomes moveable the icon representing the song can be bolded, italicized, font style or size change, or start shaking.

To change the size of a tool a sleeve can slide over the tool to make it a bigger size. A surface bump or cutout can be made on the sleeve so that it can be slid.

To make screws less likely to strip they can be made deeper, and flat heads can come to a point. A corresponding drill bit can be made as a male mold to the deeper flat head hole.

A finger planer, such as one to shave off small strips of wood, with ergonomic grooves for the finger to rest in. Comfortable plastic and or rubber structure can be made for the fingers.

To prevent wrenches from slipping off bolts a groove or ledge can be built into the bolt. A corresponding wrench can be made that has a protruding part to slide into the groove or ledge.

A bolt can be made in a star like pattern where between two points is an inward point that the parameter of the bolt goes inward at. This inward shape of the male bolt and the female mold that is used for the connector to turn it, provides strong connection to limit slipping, and stripping.

To make it easier for hairs in a razor to wash out, the razor blades can rotate to parallel. This gives the blades more space between each other making it easier for water to wash the hairs away.

A razor can be made, where the razor blade/s can be slightly curved. This curve helps funnel the hairs and could create a closer shave.

A razor can be made where a liquid or shaving gel/foam or soap can be dispensed from the razor. This can be done with a push or squeeze on the handle. A spout can be located on one side of the razor blades.

Razor with replaceable guards, that could dispense soap as it interacts with water. The guards with or without the razors attached.

An electric trimmer with a vibrating cutting technique can have a vibrating exfoliating pad that can attach above and/or below the cutting area. This exfoliating system can have a removable and reattach-able exfoliating surfaces. Said surfaces can also dispense soap and skin care ingredients. Or a permanent exfoliating surface can be made from silicon or a rubber. Both exfoliating systems can also be used by a mechanical razor that is not electrically powered, but the exfoliating part can be electrically powered.

An electric trimmer can be made with both top and bottom guards on either side of the vibrating cutting piece.

An electric trimmer can be made with a curved trimming edge. The edge shape of the vibrating piece can be rounded or curved, as opposed to the current flat edge design.

The vibrating cutting edge of an electric trimmer can rotate/swivel around a point.

A hose for a kiteboarding pump can be made with grooves that spiral at a very low slope or are straight. This prevents the hose from cracking. Another way to prevent the hose from cracking is by having it made from a rubber, like a rubber gardening hose. To improve the fit and functions of foot straps, foot straps can be made to be stretchy and elastic. To prevent a pump from opening and being susceptible to sand damage a latch can be made to hold the top down. To make a kiteboarding seat harness have more range of motion for the rider, specifically for bringing the knees closer to the chest for a grab, the seat harness can have an open area on the back side between the waistline and leg straps, or stretchy material of said area. Another way to increase range of motion is by having the leg on the front side of the rider to be to not be directly connected to the waist part of the harness. This makes the leg straps sit farther down on the rider freeing up overlap area when the rider moves their knees toward their chest. Another way to give more range of motion is by having each end of the leg strap connect to the waist part separately. This creates a space that allows for greater range of motion. To prevent the leash from restraining multiple handle passes the same direction in a row a track can be made that goes around the waist of the harness for the leashes attachment, so it can swivel around.

Life vests can be made with a grippy inside, so it prevents the life vest from riding up on the person using it. Foam can also cover the strap that goes between the wearers legs.

A surfboard or kiteboard can be made with flex so that it responses with the wave better. This kitesurf or surfboard can be thinner than an inch thick and meant for surfing waves.

A weather app that notifies its users when certain conditions are about to happen or are happening.

Stretchy straps on harness or lifejacket to make them give a snugger fit.

To prevent a zipper from sliding down unintentionally a strap can go from one side of a material and attach to the other side. The two sides are separated from the zipper. The handle of the zipper can loop around said strap and attach to itself, to hold zipper in place around strap. Arm of zipper has snap for attachment to strap or other surface.

Slider bars for kiteboarding and windsurfing harnesses give the rider more comfort when riding especially when riding toe side. However, slider bars are made of rope that quickly wears out. A slider bar can be made of wire, so it doesn't wear out as easily. Wire can be coated in rubber or plastic.

A slider bar can cover the full circumference of the harness. This will allow the bar to slide all the way around the rider. This can be done by a track system that has groves so that bar part does disconnect.

To make a kiteboarding or windsurfing harnesses' many straps easier and quicker to tighten. Bindings can also be put on foot straps that aren't made with a foot pad. Two pairs of binding adjustment systems can be built into a foot strap to get a proper size adjustment to the upper and lower part of the foot. Said foot strap can be for foot strap built with a pad or without.

To make it easier to get up on a kiteboard or foil board grip tape can cover the curve of the boards rail.

### Combo 11

A reading app where the user can read books that they buy or rent, and the app can let the user swipe the page from right to left, or left to right, and also allow the user to scroll up and down on the text. When the page is turned the app can detect where the eyes of the reader are, so that it can start the next page on what they are about to read. Another method could be to have the beginning of the last paragraph, or second to last paragraph if is short to start at the top of the next page. This set up can also have a scroll bar in both the vertical and horizontal direction when either one is being used.

A reading app where the user can read books that they buy or rent, and the app can let the user swipe the page from right to left, or left to right and have a scroll bar in this horizontal direction. And the scroll bar can have markings that show different chapters that can be labeled and when the user clicks on it they can be taken there to the beginning of that chapter. On this reading app it can show the user what chapter they are on as they are reading. This can be shown at the bottom, next to the page number.

An online mapping service where streets and satellite imaging can be accessed by the users. This can be for a flat map or a spherical global map. When it is used on a computer, the user can change the orientation of the screen. When this happens, a compass heading can appear in a corner of the screen. The user can change the origination of the screen by the movement of two fingers on the touchscreen keypad, which is a touch-screen below the letter buttons on the keyboard. A rotational point of axis can be fixed between two fingers on the keypad. As the fingers move the viewing area of screen is rotated. Another way to change the origination of the screen is with a direction icon that can appear on the screen overlaying the map. This icon can be on a pivot with two ends or can be spherical. When it is selected and dragged it can rotate the screen to the right or left based-upon if it is dragged to the right or left. A rotation to the right it the same as a clockwise rotation and a rotation to the left is the same as a counterclockwise rotation. Another way the screen can be rotated is if there is a selection of buttons that appear on the screen. The buttons can have coordinates of multiple directions at multiple degrees. There could be two buttons to select on the screen, one can give a degree amount it could rotate the screen to the right and other button could rotate the screen to the left. The amount rotated can be changed in settings. The user can press a 10 degree turn 5 times so that it turns 50 degrees.

Pressing the “O” button on the keyboard can cause it to zoom out and pressing an “I” can cause it to zoom in. Any other keyboard buttons can be used for these two functions respectively.

On an online mapping service can have a scale that gives the user a reference distance. This scale is in the form of a line segment that can have perpendicular lines on each end so the user can clearly see how long the segment is. Next to the segment is a distance in units. When the user makes a selection on this scale or on a menu item, the unit measurement can be chosen, this can be a selection between the metric system and the imperial system. One of the systems can be selected as a default. Another selection can be made of what size of measurement can be selected.

A video meeting app where a bar can tell you who is screen sharing and view options and can be moved up and down. When the video meeting app window size is reduced to ¾ of the full screen size or less, less than half or less than ¼, than the heading that says who's screen is being shared can disappear or be below or to the right or left of the selection of the window size, which include the “-” minimize icon, the square or multiple square icon that reduces or increases window size, and the “x” icon that closes the window. When view options is selected and then curser is over the selection drop-down box, said box can out for longer than 3, 4 or 5 seconds now matter how many times the view options button has been selected during the meeting. When the zoom ratio selection is made from the drop-down box the shared screen of the meeting that just had its size ratio selected can be scrolled side-to-side with a two-finger drag on the laptops touch screen selection with is below the keyboard and is mostly used for moving the curser.

Also, on the video meeting app there could be a selection where you can stay in the video that you are in and are connected with the audio but can choose to mute the video audio of the meeting while in the meeting. The user could also be able to disconnect and reconnect with the audio while in the meeting. Someone in the meeting most likely the host can call you back into the meeting audio with a specific sound that notifies the user who muted or disconnected with the audio. The host can be able to see who has their audio muted and disconnect. On this meeting app when you search for the participants it can show the live feed of their video recording in the search menu. It can also show the live feed of the video of the person in the chat area next to what they wrote in the chat.

A cell phone can have a setting where the phone can ring for phone numbers in your contacts and not ring or vibrate for unknown numbers.

A social media app can allow the user to record a video that could have that audio and/or face filter added to it where it lets you make a video that goes over 30 seconds. It could have a time limit at 45 seconds, 60 seconds, 90 seconds, 120 seconds, 150 seconds, 180 seconds, 5 minutes or no time limit.

A social media app where it lets the user make a video with a filter that lasts over one minute and can have a time limit of 90 seconds, 120 seconds or no time limit.

A social media app where it can access your camera roll for photos and videos. Once a photo or video is chosen, a selection for adding audio can be made. This enables the user to search a song or audio and select when the song/audio starts. This selected audio would start when the video starts by default, and can controlled by a trimming parameter. The length of the bar would be displayed as a horizontal bar. The trimming parameter as two moveable ends where in between is the selected area.

A social media app can introduce you to a new filter by showing a post of three videos where a filter is being used. My idea's are the following. A post that 4 or more videos of the filter being used. It can also show two examples of the post being used side by side for comparison. These different video examples on the post give the user examples of how they can interact with the post, and directions for a game that played with an interactive filter can explained through text or audio on that post.

A hair dryer can have a spinning dial for fan speed and heat control. Said dials is beneficial because it gives the user the ability to fine tune the fan speed and heat temperature they want. As the dial is spun for the fan speed, as the degrees of dial turn increase so does the increase in fan speed. Said dial can be facing with its circular perimeter out like a steering wheel or with the edge of the parameter of the edge sticking out like that of a wheel of a car where the unseen portion is in the wheel well.

A package of premade waffles where there could be packaged in a box of 12 or 18 and have a diameter of the waffle is made smaller and is between 2 inches and 4 inches.

A package of premade waffles where there could be packaged in a box of 6 and have a diameter of between 3-5 inches, where the waffle has chunks of real brownie, cake batter, sprinkles or have marshmallows and/or graham crackers in it.

An internet search engine could have a search bar where you type in a word and on whatever document or website the user is visiting the search engine can highlight/bold or make noticeable the words on that are on that page. All the words that have been found through out the document or website can be organized in order with a few words of the sentence around it so that the user can select. Once the user selects one of these the search engine can take the user to the part of the document where that word is.

A car can have a surface flush with the hood panel that covers up over part of the windshield; and at this panels end it can connect to the windshield and be flush with it. This design can look sleek and be aerodynamic. This car can have windshield wipers that pop up out of a flush surface of the car; can be above the windshield or on the side of it or below it; and has the ability to retract into a chamber under the outside surface of the car.

A social media app can have a face filter that takes the right or left side of your face and mirrors it onto the other side. A selection can be made to have the filter switch sides of your face it mirrors. This switch can take place while a video is being recorded.

### Combo 12

A snow vehicle can have a track like a snow mobile, where it is centered under the vehicle. This snow vehicle however can be large enough to hold two or more people to sit side by side with to one another. The vehicle can also have a back seat which and sit two or more people side by side, there can be another row for people to sit behind that. To steer their can be a rudder by braking on one side of the snow or the other. An alternative way to steer that it may also have is one or more ski's in the front. When the angle of the skis is changed so the direction is changed. The single track that propels the vehicle can be over 4 feet wide, wider models can be made to seat more people where the track can be over 6, 8, 10, 12 feet wide.

A snow mobile can be made with a outer shell that protects the rider/s from the weather. This shell can have a clear window in the front and on the sides and even on the back, so that the driver can see in all directions. The cover can come down to the riders feet. This design allows the snowmobile to have a heater and air conditioning to regulate to the internal temperature. A door on one of the side can let the riders in and out.

An insurance company can allow the customer to send them video of their insured property that has been damaged, especially a vehicle. This video is then processed by the insurance company to see if their property is actually damaged and then is used as evidence in court or against another insurance company. Sending a report can consist of photo/s and/or video/s of the accident, as well as a description of the accident, the date and/or time of it, and possibly an oath to tell the truth by either checking a box that specifies that the customer is telling the truth and/or by a signature of the customer.

A lawn mower, weedwhacker, or blower can all have string-pull start-up system to get their motor running. To make this start up system easier, it can have one or more pulleys that the pull-string travels through. This will reduce the force required to start the engine. Said pulleys can be visible on the outside of the equipment, attached to the frame, other pulleys can also be placed inside the covering of the equipment's body so that it is concealed.

A pair of diving flippers can be heat molded to one's foot or one's bootie while it is being worn. This will give the user a great fit and can be done with a heating process of the flipper. A flipper can also have an interchangeable fin so that different lengths can be used on the same flipper.

A microwave can have a rotational dial for setting the time of cooking. A full rotation can be 60 seconds and the dial can be spun multiple times.

An online mapping service that shows the Earth through satellite images can give the user the ability to select by season or date. This allows the user to see what the Earth looks like in summer or winter. Specific dates that at least include the year and/or months when the satellite images where taken, can be given as options for the user to choose from.

An online mapping service that shows the Earth through satellite images and stars when zoomed out can also show images of the moon from different distances. Then when strolling over towards stars the stars and constellations can be in sections. Constellations can be labeled, and each star can be labeled. When the curser is over the star or clicks on star information about said star can appear. This can include star type, distance from sun/earth, size/weight/temperature of star, what galaxy/universe the star is in, as well as the orbital path of the star. Said orbital path of star can be shown with a line. Planets can also be shown and found in said mapping service. Were the user can see images of the planets at different distances and zoom in and navigate the surface of the 3D planet where all surfaces around the equator of the plant can be scrolled through and viewed by the user. Information like distance from earth/sun, orbit time, rotational time, tilt/procession time, and size/weight/temp/elements of planets can also be given to the planets when curser is over or clicks on planet. As well as orbital path shown with line. In this mapping service all planets and moons in solar system can be set at actual relative distance and size to one another, and the user can zoom from earth to planets and moons in solar system. Said planets and moons can be placed in current positions relative to one another in the solar system. Universes, galaxies, and solar systems can also be labeled in said mapping service. When over earth said mapping service can tell the user what the element/molecule make up of certain areas of the earth can be done with a specific selection is settings.

A piece of gum can be shaped into a sphere where it has a liquid core in its center. A piece of gum can also be shaped into a 3-dimensional diamond shape, where two ends have acute angles and there are four obtuse angles between the two ends. A piece of gum can be shaped into a 3,4,5, or 6 sided pyramid. A piece of gum can be shaped as a cube and have a liquid core. When chewed this core gives a sweet burst of flavor.

A virtual reality goggle headset where a microphone can protrude outward from the headset so that it is near the mouth. This will give the user a good microphone to speak into just like a gamer headset. Said virtual reality headset can also have headphones that covers the users' ears that are built into the headset, or not have this feature while still having the microphone. Said microphone can have an arm that reaches it out toward the users mouth and in this arm it can have a cusp where it bends inward toward the mouth.

An online reading app or website can let the user click keyboard arrows to move to the next page or go back a page, the same can be done by clicking arrow buttons on the right/left side of the screen to move the next page or move back. In this format the user can slide two of their fingers on the keyboard touch screen, or touch screen of the lab tops display window so that the amount of information on each page can increase or decrease. When two fingers are slide towards one another more information is added (more lines of words on the page/size of font can be decreased) and when two fingers are moved apart information is decreased and there are less words on the page and the size of the font is increased.

A popsicle stick can be made of edible material. This allows the customer to eat the popsicle stick with the popsicle. Said popsicle stick can be made with chocolate, granola, wheat, flour and other ingredients so that a hard edible handle is made.

On a social media app an account can be added to a group such as comedy, sports, fitness, beauty, technology, or others. They can choose to be added into one or more of these categories so that their posts can be seen in that category. They can also be added by the app. The category/s they are in can be seen on their homepage. If someone clicks that category from their homepage, they can be taken to that category which is full of similar posts.

A social media app can have a post viewing format where the user scrolls down the feed by swiping up on the touch screen. This is the main post viewing format, and there can also be one on the app where it has three rows of post to choose from. Once one post is clicked on the user can scroll down and view more posts. In said social media app it can be possible for their to be adds within a posts video. This can happen especially in a longer video. The user can click on the screen of the add and the add can be ended or the add can take seen for at least five, ten or more seconds then can be skipped with a screen tap.

A cereal made of corn or rice puffs can be made in the shape of a wave, lightening, eyeball, five, six or seven pointed star, crescent moon shape, (were the stars and moon shaped cereal are not chocolate colored but can be yellow, white or blue), apple shape possibly including stem and even leaf, a circular shape with a zig-zag pattern around the perimeter so that it resembles a Reese's peanut butter cup, a four legged animal or a bird, or dinosaur of any kind especially a two legged t-rex, a whale, dolphin or fish, seashell, turtle, flower with stem and possibly leaves, trees, surfer, skier, runner, basketball, baseball, football, volleyball, baseball bat, smiley face, or face of any kind.

A social media app can have an interactive filter where the user can move their head to choose between more than two options. This is done with an object that is moved by the motion of the head.

A mochi ice-cream can have mochi balls within the ice-cream part.

A soft can candy can have patch of sour sugar within the candy. It can have a sweet sugar on the outside coating the candy so that it is first sweet then sour. The same can be done with a hard candy, with or without sweet coating.

A soft gummy candy can have one or more pieces of more chewy candy within the gummy candy. This will create a satisfying texture.

A social media app can have a filter where it can randomly pick a song for you to sing. The instrumental for the song can play and the lyrics can show up. Also the words can be highlighted or bolded when it is time to sing that word. This can also come with a background filter that makes it look like the user is preforming.

A social media app can have a filter where the user can make a music instrument make it's sound by tapping on it with their finger. There can be many different instruments to touch so that the user can make some cool beats. These instruments can make completely different sounds not just different tones of a similar sound. The filter can also come with a background instrumental that will set the tempo for the beat. Said background instrumental can also be added to filter where instrument sounds are made from head movements in various directions. The background instrumentals can be selected from a menu of multiple options. Said menu can come be selected by swiping right or left on the bottom of the screen where there could be icons for each of the instrumentals. Said background instrumentals can have vocals and can even be recognizable and even popular songs.

A social media app can have a filter where a line is brought down from the top of the screen as the bar travels across the screen it reveals a photo or video on the other side of it. The original photo or video that was shown before the bar passed is no longer viewable, except for the cut out of a person, which is detected by the app, and the original background is removed as if it was green screen. The new background is that of what the traveling bar has revealed. Another feature a filter can have is as the bar is brought down it takes an image data in line segments as the bar travels down. The bar speed can be selected, so that it can travel slower or faster according to the users liking. The user can user this bar to warp their image, the app can distinguish background from the person and the person can stay warped but the background go back to normal. The warped person can than continue to move and speak in a video as their body and face remained warped. This warping can be saved and used as personal filter when ever and can even share the filters they created with others.

A social media app can have a game where main object must stay untouched by incoming objects and these objects can come across the screen at a variety of trajectories. The background of the screen can make it look as the though the object is traveling forward in a straight line or in a line that has curves the main object must stay on course or it is game over. The main object is steered by the motion of the head. A motion to the right or left causes the main object to move to the right or left. There can be objects that if you run into them they can give you guns to shoot down the objects, that can be used by blinking, and bombs that can be launched with the motion of the mouth opening and closing. Moving the head up and down can cause the main object to up or down. The tilting of the head can cause the main object to tilt at a respective angle, so that it can fit through the obstacles. The speed of the game can increase as the game is played and can also be set at certain speeds or levels before the user starts playing the game.

A music playing app can show the lyric of a song and can show who is singing the certain lyrics by having the artists name appear before or to the side of the lyrics that the artists vocalize. Different colored or font text/font size can be to distinguish the different artists. The chorus or hook can also be written in a different colored or font text/font size. When the lyrics are fully opened in the app at the bottom of the lyrics is the pause/play bottom, on either side of this can have a play forward/backward button. When the backward button is pressed it can restart the song from the beginning and when pressed again it can start playing the previous song. When the forward button is pressed the next song can play.

On a music playing app the user can select to see the lyrics of the song. Said app can show the songs entire lyrics and highlight the word/line as they are being vocalized. The written lyrics window can automatically scroll down the lyrics to keep up with the words being vocalized. The vocalized words can be centered in the middle of the lyric viewing window. If the user moves song forward or backward the lyrics with automatically sink up with the proper place in the song so that they are compatible. The lyrics can show who is vocalizing the certain lyrics, by having the artist's name appear in parentheses/different font/italics before or to the side of the lyrics that the artists vocalize. For example, as the lyrics are being moved to keep up with the song the artists name can be to the side of the line that is being vocalized. Different colored or font text/font size can be to distinguish the different artists. The chorus or hook can also be written in a different colored or font text/font size.

A social media app can have a filter where if makes the user guess a movie/country/brand based upon a emojis/letters/images; once the user has guessed they can tap the screen to reveal the answer, once the answer has been revealed they can tap the screen so that a new hint for them to solve can appear. Once the answer has been revealed for a certain amount of time the filter can reload, this can start with a sentence/clause describing the objective of the game, then the new challenge can appear.

A social media app can have a filter where the user tries to guess a U.S. state based upon emojis/letters/images, the same can be done for any city.

A social media app can have filter that reacts when the user opens their mouth to have a graphics come out of the mouth once opened.

A social media app can have a filter that has insects/birds/snakes/animals/fire/snow/wind/frost/sound waves/bubbles/colored gases/hearts/images/their own face come out of the mouth when the mouth is opened.

A social media app can have filter whereas the person has it on them their body hair starts to grow, their face changes and they turn into a werewolf or sometime of part animal monster. Another filter can have the persons turn into a skeleton or rotting corpse as they have the filter on them.

A social media app can have a filter where it makes the users eyes appear as fire in any color. It can also give a moving colorful pattern in the eye such that resembles a culdoscope. It can also make the eyes shoot out laser beams or culdoscope pattern.

A social media app can have a filter where it can make your eyebrows move, this can make them dance it a comical way. It can also remove your eyebrows so that it looked like you shaved them, with or without also making your head bald.

A social media app can have a filter where it puts horns or antlers on the persons head. It can do this with or without distorting your face into an animal. By taping on the screen, even on where the antlers appear the antlers/horns can change into a different antler/horn.

A social media app can have a filter where it changes the users' eyes to being that of a reptile or feline so that the pupil is vertical or horizontal slit. It can also give the reptilian blink where a membrane slides over the eye from the outside corner of the eye. This filter can also have the skin of the change to a scales like a reptile.

A social media app can have a filter where the users face can change from theirs to another person's face as the filter is on. This transition can be slow, and the speed can be changed, and the user can choose which face to have theirs morph into an it can be from one to another to another and another up to as many as they want.

A social media app can have a filter where if gives the user two or more heads on their body. The other heads can be theirs in real time or can have another person's face on it.

A social media app can have a filter where the face of a person spins around on their head. Once they blink it can stop their face in the position it was in when blinked.

A social media app can have a filter where the user's nose can grow outward as the filter is on. It can even grow right after the user is done talking, this will make it seem like they are lying. The continual growth on a filter can be done on the users lips, jaw, breasts, ears, eyes, hair, facial hair, head, forehead, eyebrows, and nostrils.

A social media app can have a feature where the user's voice can be autotuned when they vocalize. Their voice can also be made deeper/higher pitched or altered in some other way by skewing the original vocalization. These voice changes can also be controlled so that the autotune and pitches can be set at certain levels within in a range of setting options. Said voice changes can also be featured on a social media filter, where the voice pitches are changed without the speed of a video being changed.

On a social media face filter, it can have a caption that is imposed on the screen this caption can describe the purpose of the filter or be a question or command; said caption can be automatically read aloud by the app, and this can be done without this audio being add to the video by the user.

On a social media app a separate type of post that can't have multiple images on the same post that can be swiped through, and can have a shorter time limit for video, and can also be viewed in a window stored to the right of the normal posts; can have the date of when the video was posted.

### Combo 13

A social media app can have a face filter when each time the user blinks the eye color or filter effect given by the filter changes. This can be done when there are 3 or more different eye colors or 3 or more filter effects.

A surfboard made without a hard fiberglass outer layer can have fin boxes that are connected to one another by means of a hard material like plastic or fiberglass, to provide stability to the fin boxes. This connection of fin boxes can be a flat surface on the top, bottom or middle of the board, and can be referred to as a plate. The fins can be built into said plate. This further enforces stability of the fins to increase performance. Said plate can be put on a fiber glassed board as well. Said plate can cover the bottom surface of the board to the tail and up the center past the fin boxes.

A surfboard made without a hard fiberglass outer layer can have fin boxes that don't screw in from the top. Instead, they can firmly attach to interior foam and an layer of plastic or rubber can cover the bottom surface of the board which also covers the fin boxes and secures them. These fin boxes can have fins built into them. Said layer of plastic or rubber that can cover bottom surface of board and fin boxes with fins built in or not, can be on soft top with fin box screws that attach from the top side of the surfboard, also known as the deck, where the rider lays and stands on.

A surfboard can be made with 1, 2, 3, 4, or 5 plastic stringers that run the length of the board for strength. There can also be several stringers that run at diagonal angles that can be wooden or plastic.

A video game can have settings for gravitational force. This will change how things fly through the air. Most video games have very unrealistic gravity. When driving a car or motorcycle or other vehicle the user might want to see what would happen in the game if the gravitational force was accurate, this is where this setting becomes useful, however it can also make gravity extra light or extra heavy.

A social media app can have an icon on a post next to where the music used in the post, where said button can represent if the song is currently trending. When said button is pressed the app can take the user to a selection of posts that all trending songs, where the songs can be different. This section can also be reached with a selection of trending songs or when trending music/songs is searched. This selection of trending audio in a social media app where trending audio differs can give the user exposure to different trending songs in one place.

A social media app where the camera is not the center window/section of the app, and/or the app can have a section of posts in rows of three where at the top of this section can be a search bar; can have a section of posts that all have different filters. This can help users look through all the different filters available on the app. In this section their can be no posts that don't have a filter. The filters can also be categorized by games, similar challenges, beauty filters, and face altering filter effects. This section of posts can be found through the search bar or by clicking on an icon on a post. The filter title can be on or above the posts. In this section you can search for filters by their titles/names.

A social media app (or online video posting platform) can have settings for video speed, (this can be when the user wants to edit a video that they want to post on the app where the video can be from a devices camera roll or recorded on the app, or for viewing content that is already posted), where a slower video speed can have three, four, five, six or more options. In video speed settings there can be four, five, six or more speed settings that play the video faster than the original. The most customizable video speed setting can be done with a bar control. Said bar control has a control where the user can slide a speed selection across a bar so that if the finger slides one way on the control the speed is increased as it slides that direction and when the finger slides the other way the speed is decreased as it slides that direction. For videos that have already been posted, once the selection is made the video will continue to play at the selected speed.

A social media app/internet website for where users can upload their videos to edit their videos on; can have a speed dial/bar to control the speed of their video while editing or while viewing a video that has already been posted. As the dial or bar is moved the speed of video can be changed, either increased or decreased. As an icon on the dial or bar that shows where the dial or bar setting is at is moved the speed of the video can be changed, either increased or decreased. The benefit of this feature is a fine tuning of the of the video speed. Now in the editing process the user might want to change from one video speed to another, the user can select the with a dial or bar or inserted number how many seconds the user wants to the video to take in intermediate time between one speed to another.

A water gun can be loaded by pressure from having the handle squeezed. The gun can have the handle made from flexible material so that this is possible.

A water gun can be loaded by having the gun spin around the persons fingers where the users finger grips a piece that said piece is not spun while the gun is spun, and this loads the water gun with pressure.

On a social media app when a user makes a post, after the post is posted the user can also add another account to the post so that both accounts have posted this same post. Said post can show up on both accounts homepages as well as their follower's feed. Said post can be called a collaboration. The request to collaborate can be sent after the post is posted. Once the request is received by the other account/s then the post is collaborated.

A social media app can let the user post multiple videos in the same post.

On a social media app, where the app lets the user edit multiple videos into a single video edit where multiple different video clips are displayed side by side in the editing process, the user can reorder them by holding and dragging them with their finger into proper order. This can be done without a specific selection to reorder.

A social media app can have a filter that gives an image or video a moving distortion effect. This effect is commonly seen it “trippy” that is great to look at when under the effects of hallucinogenic. This effect mimics the “breathing” of still things that is experienced when under the influence. This filter can make what is being viewed and add motion to it which can alternate between forward motion and the opposite motion, specifically focalized at the edge of an object can be the epicenter/boarder/divergence of these motions.

On a social media app where the app lets the user edit multiple videos into a video edit, on the editing system where multiple videos are displayed side by side and are in draft of a video edit to be further edited the videos can have their display changed in this stage of the editing process. So that they can be wide screen or narrow screen displayed. The app can also allow the video to be positioned in the new display so that the user can move the video frame to the right or left or up or down so that it fits proper for the video; same can be done when selecting the cover image for the post. When selecting the cover image from a video/video edit the user can scroll through the video and select any frame.

A floss for cleaning teeth can have incremental segments of thicker string, this will help the user hold the floss and the thicker floss can also be used to clean teeth with wider gaps. One a single floss roll their can be two, three, four or more thickness' of the floss. There can also be marking on floss so that the user will know how much length to cut each time it is used.

A social media app that has a discover section of media post where it is organized in categories based on hashtags, filters and music/audio; where you can message an account photos/videos off of your camera roll.

A social media app can let the user message another account photos/videos off of their camera roll. When either of the accounts clicks on the photos/videos (or sent posts) they can scroll from one to the next, back and forth of all that was sent previously in the chat, in the full screen view or near full screen view of said photos/videos.

On a social media app where the when the user opens the app it doesn't start with the camera, and/or the middle section of the app isn't the camera; said social media app can have an icon that can be selected in the messages that can rotate a photo or video 90 degrees, said photo/video can be sent from camera roll. On said app their can be a section that has a collection of a variety of filter, and audios for the user to browse.

A social media app can have a game where the main object must stay untouched by still and/or incoming objects and these objects can come across the screen at a variety of trajectories. The background of the screen can make it look as the though the object is traveling forward in a straight line or curved track, the main object must stay on course or it is game over. The main object is steered by the motion of the head or tilt of the device/phone. A motion/tilt to the right or left causes the main object to move to the right or left. There can be objects that if you run into them, they can give you guns to shoot down the objects, that can be used by blinking or any specific facial or head motion, and bombs that can be launched with the motion of the mouth opening and closing, or any specific facial or head movement. Moving the head up and down can cause the main object to up or down, and the main object can be placed on or respective to the nose or other facial feature. The tilting of the head can cause the main object to tilt at a respective angle, so that it can fit through the obstacles. The speed of the game can increase as the game is played and can also be set at certain speeds or levels before the user starts playing the game.

An app or website or device can allow the user to search for a word or phrase that is written in the document. It can let the user look for two or more words in sequence and even punctuation. When you search “and then;” it will search for all the places that have this sequence in the document or page and then highlight and scroll to the area that has this. If there is no matches then the closest results can be listed.

An online video posting website where users can upload their video in that can be in excess of an hour, and have comments below a video on the left side, while having suggested videos in a vertical column on the right side of the screen that extends below the video being played or paused; can let the title and caption/description of the video be translated into another language. An icon near the title or caption/description can be selected, that could read “translate” once this icon is selected a list of languages can appear and the user can select one and then the text is translated to that language. On said website, below a video there can be suggested videos in multiple columns below the played or paused video. Said columns can be centered or to the right-hand side of the playing or paused video. Below the playing or paused video there can be a section to show/extent comments or to hide comments. If comments are shown/extended, then the said columns can be moved downward or be removed. On said website their can be an icon that can look like a microphone next to a video caption or comments, when this icon is selected it can read out the text aloud of the corresponding caption or comment. On said app when the curser of a device is placed over a suggested video the video can play with sound, this feature can be managed in settings. When a video is selected and it is playing or paused, and the devices mouse is over a suggest video it can play a gif of that video that is longer than 3 seconds, 5, 10, or even 30 seconds; it can also play part of the video continually until the video is up or until a time limit that is over 3, 10, 20, 30, 60, 180 seconds is meet.

A social media app that has a discover section of media post where it is organized in categories based on hashtags, filters and music/audio; can have a filter that inserts the user's mouth or eyes into a still image that can be a painting, and can let music play from another app while said social media app is opened.

A social media app that has a discovery section where there is a search bar at the top of this section and feed is organized below in rows of two or three, and the middle section has a single row of feed; on said app there can be posts that have a pop up, when selected it can take your device to see the app store and have a particular app shown for consideration to download.

A social media app that has a discovery section where there is a search bar at the top of this section and feed is organized below in rows of two or three, and the middle section has a single row of feed; on said app the user can make a post of just text.

On a social media app or online website as you log in it will ask you your gender. It can give you four or more options to choose from. It can also give you three primary selections where besides male and female the third selection can be called “custom” or “other”. When the third selection is chosen the user can have a selection of options to choose from which can exceed three (not including an option of not disclosing your gender), five and even ten. These selection options can include “Lesbian”, “Gay”, “Bisexual”, “Queer”, “Transgender”, “Intersex”, “Asexual”, “Cishet (gender)”, “Demigender”, “Questioning”, “Gender-Binary”, “Gender-nonconforming”, “Gender Normative”, “Gender Fluid”, “Transgender (Female/Male)”, “Multi-gender”, “Genderfuck”, “Polygender”, “Transfeminine”, “Transmasculine”, “Transsexual”, “Trigender”, and “Intergender”. It can also ask you to select your pronouns and can give you options that exceed three. The number of given pronoun options can be 4, 6, 8, 10, 15 or more. The pronoun selections can be “She/her/hers/herself”, “He/him/his/himself”, “They/them/their/themself”, “Ze/hir/hirs/hirself”, “Ze/zir/zirs/hirself”, “Xe/xem/xirs/xemself”, “(f)ae/(f)aer/(f)aers/(f)aerself”, “e/ey/em/eir/eirself”, “per/pers/perself”, and “ve/ver/vis/verself”.

A car can have a logo on the front hood that is a 3-dimensional protruding figure like that of a human, or animal and not an angel that can be made of a clear material and a light can be underneath or in it so that when the light is turned on it can illuminate the figure.

A harness can be made for a dog that gives it full body support, so that it can support the dog when it is fulling suspended in the air. There can also be one or more attachment points on the back so that a rope/s can attach. The rope/s can than be attached to an overhead object so that the set up allows the dog to run and swing up and down as a fun exercise for the dog. This can also be made strong enough for a human to use as well.

An online search engine can have a list of results show up when something is searched, below the title and link of document/website there can be four, five, six, seven, eight or more rows of text from the article/website for the user to look over. An icon can be selected on a search engine that can be in the shape of an arrow pointing downward, when selected one or more times several more rows of text can appear, an upward arrow can also appear so that several rows of text are hidden.

A language teaching textbook/app/website can start by teaching the letter's/charter's/symbol's sounds of phonics. When a new word is introduced in the language being taught, the phonics of the word can be placed near it either above/below or left/right of the introduced word. Also placed above/below or left/right of the introduced word can be the meaning/translation of said word. The same can be done for when a sentence/s in the taught language is written. The same can be for when a letter/charter of the taught language is introduced, and the name of the letter can also be can also be written near it either above/below or left/right of it. When the taught language has different writing styles the multiple types of scripts can be placed above/below one another in letter/charters, words and sentences.

On a language teaching app, the app can alternate audio between your native language and language your being taught in letters/charters, words, and sentences. This can happen while your device is not on, but the app is still running an outputting its designed audio. The letter/charters can first be introduced, then words, then sentences, then multiple sentences between translation and taught language.

On a social media app where accounts can post multiple photos and the photos can be displayed one photo larger than the rest before the images have been selected, and where people can write on other people's accounts, and where birthdays can be notified, and public groups can be made, and where relationship status can be shared and updated; on said app when the user scrolls over a post that has a video the video can play automatically with or without sound without the user tapping on the video. Said video can play with the same size screen view of the video that the user sees when scrolling towards the post. An icon can be selected that lets the audio of the video play with out changing the screen view. The audio can also start playing automatically when the video starts playing automatically.

A social media app where the in the home feed section of the app users can post what they write, alone, and also photos/video, as well as articles, where the center section of the app can have a selection of live audio/videos, where the section that has a search bar at the top of it has several columns of feed where each column has posts one above the other and none side by side and to get to another column the user can swipe across the touchscreen or select the column title at the top of the screen; in said social media app the there can be a section where the camera is open so that the user can make and then edit their own content, also in this section there can be camera and face filters that edit the users face into a variety of effects and even uses the motion of the head and facial expressions to play an interactive game, and in camera filter can edit the colors/contrast/exposure of camera. In said social media app there can be an option to edit a written post or the caption of a post that has a photo or video; this can be done by selecting a button at the top right corner of the post or by selecting a button below the post. Once this button is selected one or several options can appear one of which is called “edit” or “alter” or “change” once the selection that can have one of these names is selected the user can then have the ability to rewrite what was written in their post, or reply to a post. If someone reposts a post, then the account that posted the post, edits what was written in the post, then the repost doesn't receive the editing changes that happened after it was reposted. Said app can let the user post multiple photos and videos in this app. The user can also edit the image/s of the photo/video posted and can edit the number of photos/videos posted in this new editing service. On said social media app a photo/s, video/s, text or reply to a post can be posted where it is not indented to the right, but is centered on the page, and can touch to border(edge) of the screen on one or both sides. When the user scrolls down and there is a video which starts to play automatically, the audio can play automatically as well, or when the volume on the device is adjusted, this feature can be personized in settings. In the search section of the app, at the top row of common selections can have seven or more categories for selection; some can be named “Music”, “Beauty”, “Comedy”, “Politics”, “Hunting”, “Adventure”, “Nature”, “Science”, “Art/s”, and “DYI”. On said social media app the user can have the ability to post something for a limited time. This means after a set amount of time the post is unavailable. Said time can be customized by the users. Said app can also have a feature where once a photo or video is selected the user can scroll left/right or up/down to view more related content that the app generates, this can be in the home or discovery section, or any place that is not in an account where the next photo/video is the next photo/video that account has posted. On said app when a video is playing a tap on the screen can pause the video and another tap after can cause it to play again. When the screen is double, or triple tapped it can cause the video to be liked. A slow tap where the user holds down on the screen for a certain amount of time can also cause the post to be liked. If the user makes a zig-zag swipe on the screen or a specific swipe pattern like of an “X’, “O” or heart shape the post can be liked. If one side of the screen of a video is tapped, it can cause the video to fast forward and if the other side is tapped it can reverse. This can be in increments of 2, 3, 4, 5, 7, 8, or ten seconds.

A social media app where a limited time post can have the amount of time posted customized so that it is less or more than 24 hours. A respective icon can appear to indicate around the profile pic of the user in the area limited time posts are placed. A limited time post can appear on the main feed of a social media account so that the users followers can be more exposed to it.

On a social media app a slow tap where the user holds down on the screen for a certain amount of time can also cause the post to be liked. If the user makes a zig-zag swipe on the screen or a specific swipe pattern like of an “X’, “O” or heart shape the post can be liked.

### Combo 14

A social media app that has a discovery section where there is a search bar at the top of this section and feed is organized below in rows of two or three, and the middle section of the app has a single row of feed; said app can have filters that are sponsored by a company, this will be a form of social media marketing. Said company can be charged by the social media app to have the filter up on the app.

In said social media app two or more people can share a post. This causes the post to be seen by all of the followers that shared the app and appear on the accounts of all of the users that shared the post.

A drink can be made with creatine, not super creatine but regular creatine. This will be for muscle growth. This drink can have chocolate, peanut/butter, strawberry, vanilla and other flavorings. This drink can also have caffeine to boost energy levels, and even carnipure carnitine.

A candy comprised of two can have two rectangular cookies with chocolate chips/toffee/brownie/fudge/, chocolate/peanut butter pieces in a candy coating, with Carmel, and both coated in chocolate.

A machine that can be secured to a boat or have a system of wheels that can transport the device along the deck can be made of these following components. A machine operated rope pulley that can dispense and retrack rope at speeds that can be modified manually or digitally on a electronic or touch screen device, guard that the rope can be fit through but the crop an algae/kelp cant fit through so it so that it is pinched off and is collected in a bin.

A wetsuit can be made with a rubber glue that covers its seams; this rubber glue can then pressed with a textured surface to give it a specific imprints. The imprints can be in the form of a logo, name, any type of writing, repeating patterns. The imprints can run the length of the rubber seam, can the imprints can cause the edge of the rubber glue to be made in a specific pattern.

A wetsuit with a rubber glue to cover the seams can make the edge of the seam changed into a specific pattern that can strengthen the seam or be for decoration.

A wetsuit can have small holes in it that are drains and where the drain has a valve so that water can pass out of the suit but not in.

A social media app can have a filter where it takes part of your body and fits it symmetrically on the other side. This can be for arms, torso, legs and feet. This can be done digitally on the phone or with a mirror reflection line that runs vertically mostly centered on the screen.

A gun holder can be made into a jacket/hoodie that has low pocket/s. A firm strap like a belt or back brace can cover the waistline, the holster is attached to the belt or back brace that is inside the pocket.

A climbing shoe can have tread on the inside of the ball of the foot, just below the big toe on the inside surface of the climbing shoe that doesn't directly touch the ground when a the shoe is being stood in.

A driving service can offer a service where they drive your car back to where you need it for you. This can be done with or without the same driving service driving you in there car to a destination.

A longboard surf fin which has a perpendicular bar in the front base of the fin for attachment and a vertical whole in the back base of the fin for attachment. A fin box can be made for said fin where it is just the length of said fins base, can said fin can't side at all. Similar to this fin box design is one that allows the fin to slide only a short distance, this can be under 5, 4, 3, 2, or 1 inch.

To make a zipper system waterproof, the teeth of the zipper system can have a softer material on the exterior where the opposing teeth touch each other. This softer material can be a rubber, or silicon or plastic. Part of the slider and stop/bottom stops.

A household blender can be made where there are multiple powered spinning shafts that have blades mounted on them. Each one of these spinning shafts can be located in a different spot in the container. The spinning shafts can set at angles. Design can have two, three, four, five, six, and even seven shafts. The container of the two shaft design can give the container a more rectangular shape.

A wetsuit can have section in it that fills up with CO2 gas or helium for emergency buoyancy. A flotation vest that can be meant for wearing under a wetsuit can inflate with helium.

A surf leash can be made extra strong and thin to reduce resistance. The leash and be thinner than 3/16″ which is 5 mm. It can be made from urethane and have a stronger core which could be made out of wire. The thickness of said leash can be 2/16″, 3/32″, 1/16″, 1/32″, 1/64″, 4 mm, 3 mm, 2 mm, 1 mm.

A sock can be made to be extra slippery for the purpose of putting on a wetsuit or sliding on hardwood floors. The material that makes the socks so slippery and be nylon, polyester, or polymer, and/or latex fabric that makes the sock slicker. There can also be a spray of material that can be used to decrease friction of a sock for these two reasons.

A wetsuit can be made with a colored rubber strip that covers the exterior of the seams as a lamination glue. This can be for wetsuits that do not have a front zipper that runs from the upper chests down towards the belly. These colored rubber seams act as a watertight seal to cover the stitching on the wetsuit. Said rubber for the rubber seams can be off-black, grey, silver, off-white, white, yellow, orange, red, green, brown, blue, purple, violet or any other color, or any shade or tone of the mentioned colors.

A wetsuit with a back zip can have the back zipper at an angle that is not parallel with the spine of the wearer of the suit. In this design the zipper ends at one of the sides of the users neck this makes it so the zipper doesn't bunch up and put pressure on the back of the head or neck of the wearer.

A wetsuit with a back zip can have a design where the pull string has an opening where it can be pulled through.

A skim board can be made where the top deck is coated by a rubber adhesive or a rubberized paste that is water tight.

A snap back hat can have a parts that snap together be letters where it can spell a word or brand name.

A hat that can either be a snap back or stretchy fit hat can have a brim where the center of the brim is flat or close to flat and toward the edges of the brim with extend to the left or right side of the wears face can have a slight or more aggressive curve.

A coffee protein drink can be made and be sold bottled or served made fresh. This can be promoted as a health drink.

A surf booty can be paired with an internal sock product. This sock can be low friction, light and thin. It is put on first to make it easier to put the booty on and also makes the booty have a performance fit when surfing. The material its made from can absorb little water. It can have a split toe design, and can go up to ankle level or above.

A rubber adhesive product that comes in the form of a spray or liquid can expand its volume with tiny air bubbles while drying.

A wetsuit can be made with a neck collar design that curves over the trapezius muscle which attaches to the neck. This makes the suit fit more ergonomically.

A wetsuit can be made with a different material or thickness of material on the back of the bottom of the legs. This can stretch more and be easier to get around the heal of the wearer.

A wetsuit with a chest zip or back zip can be made with no kneepads. Where the wetsuit is not made for open water swimming and doesn't have smooth rubber/polymer surface.

A surf booty can have a section of different material or thinner material on the back strip of the booty, so that it will be easier for the user to get their heal into the booty.

An eyewear product can have lenses, a tube that goes through the frame or is attached to the frame, an extension of the tubing that connects it to a source of liquid, and an extension of the tube that goes into the mouth of the user so that they can drink.

A candy can be made with a sugary sticky core that has pebble sized hard candies suck to it along the length of the core and the shape of the candy can be in that of a cane. A harder core inside the sticky sticky core can be made so that the candy holds a specific shape specifically of that of a cane.

A sausage or sausage like product such as a hot dog or vegan sausage can have a specific shape where along its circumference it has 3, 4, 5, 6, 7, 8, 9, or even 10 flat surfaces. The best design I believe is either 4, 5 or 6 flat surfaces. As someone cooks the sausage the roll it from one flat surface to the next, this allows for the sausage to be evenly cooked. In its packaging the sausages can be sitting on a surface that ergonomically forms to the set shape of the sausage's flat edges. To make these flat edges a machine can press the sausages into a shape. I string of sausages are led into a groove where a top piece puts pressure on the sausages and forms them into their desired shape.

A handgun can be made where the top of the barrel/slide and/or rear sight can lock in with another gun that has a compatible design so that they can be used to cock the slide of one another.

A quizzing game where players can answer questions on the website of the game, where an identification code for the game can be typed in to let the player attend that quizzing game. In said game the user selects an answer option where the quicker they answer the better their position in game will be. When a user selects an answer, the player can be told what place he answered the question compared to other players. So, the first person the answer would see that they answered first. The answer options in this game can also show the written or numerical answer on or near the answer options instead of just on the hosts screen.

A bottle of liquor can have a cap that can hold 1 ounce-1.5 ounce or slightly more liquid so that users can use it as a shot glass. A ridge or marked line can made inside the cap at a height that marks a specific level for a shot to be poured.

A hand ascender that is made for ascending climbing rope can have the ability to being a right- or left-handed ascender. A divider can be in place where the left and right “biting” systems are divided. The biting system is where the metal piece which can stab into the rope and the rotating system that allows it to swing in and out of biting position. The left and right biting systems can be of set or have off set carabiner attachments. The benefit of this design is that as the users ascends the stress of the ascending arm can be changed and have a slimmer profile than other two handled designs.

A hand planner can have specific settings for how deep the blade is placed this can be done by having ridges or levels built into the edges of the blade.

A hair trimmer can have feature where the trimming clippers cut at an angle to the guard; this allows for smooth fades. With this hair trimming the clippers can be rotatable so the user can choose the angle the clippers are to the guard. The clippers can have a smooth or incremental angle measurement setting that can include flat like normal clippers. The clipper angle can be changed by means of a dial. The clipper angle can rotate from one side to the other.

A hair trimmer can have a retractable guard that can extend and retrack to 0.4 cm, 0.6 cm, 1 cm, 2 cm, 3 cm, 5 cm and more. This extension can be facilitated with a rotation of a lever, rotation of a dial, or moving of a part along a track. Each of these ways to change the length of protruding guard can have a corresponding measuring system that tells the user the length of the guard. When the guard is retracked it goes under the surface of the body of the trimmer. This guard depth can also be changed electronically with the user pressing an extend button or a retrack button, where as long as the button is being pressed the guard is being changed.

Surf booties can have a colored rubber glue seam sealer.

A hat that can be a flat brim or a curved brim can have a design in the hat that is heat molded in, and has 3-dimensional features pressed into it.

A curved or flat brim hat can have to layers of fabric, the outer layer that is distressed with holes in it and a fabric layer underneath.

A truck can have a bed where the bed can extend and the back end of the truck including the taillights can extend with it.

A truck can have a tailgate door that can have an extension platform on hinge possibly hydraulic. The platform can form to be at 180 degrees and extend to past into steps, or into a ramp, it can also fold to form an enclosure for people, chickens, young livestock in a division separate from the truck bed.

A surf leash can be made with lights along the length of the leashes cord. This can be used for night surfing or just to look cool.

A device made of strong stretchy material that resemble the tendons of the human hand or foot. It can supply the foot or hand with relief from the forces the device takes in from stretching. This device can be all one connected piece to a particular area of hand or arm, or thumb, finger/s. The device can lay flat or rounded.

A paper towel and sweeper pad can be made of a hemp fabric.

A fur hat or hat with ear flaps can hold beers, one or more on each side and even could hold some on the back.

A fishing pole can have a drink holder, said drink holder can be placed below the fishing pole and can swivel so that it is kept upright. Said drink holder can mount on any fishing pole.

A dish cleaning product can include a scrubbing surface that could have bristles and/or a sponge, a handle, a chamber that can fill up with a soap, and a battery or electric powered rotation on the bristles or sponge or whatever cleaning surface is. This takes the work out of cleaning tough stains and can be used for cleaning the outside of a house, car, or anything. The battery or electricity powered scrubber can also vibrate the cleaning surface and/or shake it back in fourth.

A balloon in the shape of an airplane can have propellers that are remote controlled.

A pair of running shorts that don't come down past mid-thigh but only cover upper thigh can have a liner that snuggly fits on the body and doesn't go past mid-thigh but only covers upper thigh. In said liner can be a phone pocket and another pocket that is smaller for keys or other smaller items. Upper thigh can be defined as above the middle of the thigh, or the top ⅖, or ⅓ of the thigh.

A container can be made for resin or paint where the user can dunk the end of a surfboard or skim board in it and then take it out so the paint or resin can run down it. This can be used for the nose, rail, or tail of the board. A special rest for the board to rest upright can be at slants so the liquid can flow around it; or thin protruding objects like nails can be used to minimize the liquid flow disturbance.

A pair of shorts or pants for climbing can have a pocket in them that is meant to hold chalk. It can have a special lining to keep the chalk in and have a closure, so it doesn't fall out. The closure can be a zipper, snaps, or Velcro.

A gummy candy with sour coating and possibly a liquid core can have a colored cap with white dots. Said candy can also be in the shape of a troll/hobbit/gnome/wizard/bird or alien. Said alien can be green with big eyes, and flying saucer gummy can also be made that can be 3D.

A psilocybin supplement can be made in the form of a gummy, drink, or food product.

A foldable and detachable fabric panel can be made for the collar and cuff of a sports coat, or dress shirt.

Pins can be made for a collared. The upper chest panel of the shirt could be made with the pin backing built in, or the pin backing can be on the other side of it. The top pin would then pierce the collar and attach to the backing. The same can be done with magnets.

A chewing gum can have a sour/sugar candy coating.

A chewy candy can have a coating of sour/sugar. Said chewy candy can have its main ingredients include, glucose/corn syrup, sugar, vegetable oil, hydrogenated palm kernel oil, gelatin, and tapioca dextrin. Said candy can also have a liquid core of sweet flavoring, with or without the sour/sugar coating. Said candy can have one or more inner cores that are made up of a different colored layer of chewy candy. Furthermore the candy can be colored and individually packaged in a rectangular prism shape.

A navigational app can let the user choose the icon that depicts their location. A selection of different vehicle types, shapes, emojis and images can be selected as said icon. When the location icon travels the navigational app can show the future directional path to take without a path of where the vehicle was. Road lines that are yellow or white can be shown as such. Multiple lanes on road can also be shown. And the navigational app can direct the user through a building. It can show rooms, hallways, elevators and stairs. At the elevator or stairs their can be information that tells the user what level/floor to go to. The navigational app can detect the elevation of the user to determine what level/floor they are at. As they arrive at a floor the structure layout of the floor can be shown on the app can the directional path as well.

A chewing gum or gummy candy can have a coating of a fizzing candy powder or an inner capsule of fizzing candy powder. This can be achieved with malic acid and tartaric acids.

An app or website can have a platform where it has ideas for products and services that promote start up business. The format of said platform is like a social media platform where the user swipes up or down to view the next item of content and the content can be “liked”, saved, shared, or commented on.

A surf bootie can be made where it has a rubber surface around a finger loop strap that helps the user put on the bootie which is located on the back of the Achilles tendon. From said finger loop strap and rubber surface surrounding it a rubber surface can extend upward toward the calves continuous for 1″, 1.5″, 2″, 3″ or more and can continue to the top of the bootie or within a ½″ of the top of the bootie, when the top of the bootie is longer than 4.5″, 5″, or 6″ from the base of the heal. At the top of the bootie a rubber pad/bump/divot on the exterior and rubber pad/divot/bump on the interior can act as a grip to put on the bootie. The top of the bootie is where the user first enters the foot.

A neoprene bootie can have a loop or handle that is located on the front of the bootie over where the wearers shin would be. A strip of rubber can cover the length of the shin to give strength to the bootie, and strength to the loop.

A neoprene bootie where the sole of the bootie can be mostly made of a rubber material can also have spaced strands of fabric material or strings of fabric that can restrict its stretch to only a certain length. This can cover the toe areas so that they don't stretch out and break. A surf bootie can be made entirely of a rubber material and can go up to ankle height or high sock length.

A car or truck can be made with retractable roof lights. The lights can retract to lay flush with the exterior of the vehicle. They can be located on the roof just behind the top of the windshield, or on/near the front end of the car, possibly just below/above the grill. A selection can be made from the interior of the car that operates the lights and where they are up or retracted. These lights can have many features, one of which can be sirens. This feature will be great for undercover cops. It can also have the feature of a projector, so that images, and videos can be with it and the projector can have rotational controls.

A car or truck can have projector built into it so that it can be aimed outwardly and can be used to watch movies, videos or look at images.

A car or truck can have lights and a projector that can pop-up from the hood, and retract to lay in-line with the hood.

A hat with a curved or flat brim can have a camera/light in or attached to the brim.

A sports drink with electrolytes can be slushy flavored. An energy drink caffeinated, or another stimulant can be slushy flavored. A gummy candy can be slushy flavored and be recommended to try frozen and can have a better texture when frozen or chilled. This can be from a liquid pocket inside the gummy candy.

A small compact sports camera can have a strong waterproof case. On the surface of the waterproof case can be a layer of silicon that prevents water droplets from obstructing the image. A silicon spray bottle can be made for this very purpose. A feature of this camera can be a selection that lets the user immediately delete a video; this can be done by a button selection, or combination of presses on a button so that this is not used when not intended. This camera can also have a feature that saves recently deleted information and can bring it back if accidentally deleted.

A wetsuit can be made with a textured surface over the chest and belly area of the suit. This will texture the surfboard wax instead of flattening it.

A truck tailgate can be made with a rotating part that extends across the top length of the tailgate and can end before reaching the end edges of the tailgate or extend all the way to the edge. With said tailgate the top folding platform can be folded down, and then the main tail gate can be folded. A similar design is a tailgate that has an interdependent fold that goes from the top towards the base of the tailgate.

To let a truck tail gate fold inward to reduce wind resistance, a horizontal joint along the lower part of the tailgate can allow it to fold inward.

A truck's tailgate can be folded down and then once in this position the tailgate can slide under the surface of the truck bed until the top part of the tail gate is locked into place. This can be done electronically with an electronically powered system or manually either way the tailgate follows a track which it can have wheels that roll in this track. Once locked into place a lever can be pulled on the top of the tail gate to unlock the tailgate from this position so it can be rolled out. It can be locked into place with the same mechanism that a car door lock or a tailgate locks which is with a male and female parts. The male part is a metal bar, and the female is a clamp which was to rotating parts. When a lever is pushed the clamp is opened.

A truck bed can have storage spaces under the surface of the truck bed, this storage can be opened with an electronic button on a key or a button near the truck bed storage can be pressed to open. An electric motor can power the opening of said storage space.

A truck with a tailgate that folds down as a flat platform can have a food/drink cooler in the bed of the truck. To access the cooler the surface of the truck bed can be opened, and the cooler area can be below. There can also be a drain to let the melt water escape.

A flush vehicle door handle and the charging/gas panel that covers the exterior of the vehicle can be made much more precise so that they are not visible to the naked human eye when closed. These items now are made with around a millimeter of space, and this enables us to see the outline of the shape. The edges of the panels are also slightly round, to make the outline invisible the edge can not be round but at a sharp angle.

A protein powder can be made from ground up ants and even mixed with crickets.

A drone can have two or more cameras in its camera positioning area, if the drone is under 895 grams, and three or more cameras in its camera positioning area at any weight where a thermal camera is not included. Where the camera positioning area can be controlled to point in specific directions when flying. Said positioning area can be a gimbal. The benefit of having 2, 3, 4 or even 5 cameras on a drone is that each camera can be best at a certain distance or function. A drone of any weight can have 2 or more cameras where the cameras which are on a gimbal are protected by a near spherical protector. A drone with a camera that has a mechanical shutter can have a near spherical camera protector. A drone that has a thermal camera can also have a spherical camera protector that covers the gimble or positioning area. A drone can have a laser beam that can be controlled with the remote, to point in the desired direction. A drone can have a feature where items can be deployed from the drone by remote control and the item can have parachutes so that the food or item that is being transported isn't destroyed. A drone can be controlled by the motion of the head based upon the sensors of the google headset that shows the drone's camera view. This is a type of motion sensor technology that would be very intuitive. The censors would know what the resting head position of the user is. It would be possible to have forward backward speed be controlled by a manual remote, but the turning, pitch, angle of the drone can be controlled by the motion of the head. It the user wants the drone to move faster forward the head can be leaned forward and moving your head backward would make the drone go in reverse. A piece that also has sensors can be placed around the neck or on the shoulders of the user so that the motion of the googles would be respective to the neck/shoulder censors. Should motion can also contribute to the maneuverability of the drone. A glove or finger piece can be used to position the drone. Buttons on this can connect/disconnect this as a controller.

A drone with a camera that has its camera above the propeller blades can have its camera on a two or more-axis stabilizer.

A drone with a camera that has a one axis stabilizer can have two or more cameras mounted on the same area.

A drone can have a built-in electronic line dispenser that can be controlled by the remote. From the remote controls the line can be dispensed or retracted. The electronic spinning of a part can wind up or dispense the line. A drone can also have a built in claw or pincer that can be controlled through the remote of the drone.

A drone can have an attachment for a fishing line on a reel. The reel can be motorized to reel in the fish.

A surf wax container can be made of insulative material. This can include foam or Styrofoam and/or a thin sheet of aluminum. The container can have a zipper to access the wax.

A car or truck can have containers in the car that are for trash or recycling. They can be located under the seats, near or under center compartment structure, and can be able to slide out and be dumped. A trash bag could be made to fit in it.

A wind wing for hydro foiling and other activities can have two near center struts with handles. When the rider rides one direction they can prefer to hold onto handles with the strut nearest to them. A wind wing can also have multiple handles on the leading edge. This will be useful for the rider if they want to stagger their hand position. A wind wing can have a total of 4, or 5 struts for structural support, and can be made it 6 meter, 7 meter, 8 meter, 9 meter, 10 meter, 11 meter, 12 meter, 13 meter and 14 meter for lighter wind and other activities that need more to harness more power.

A thick garment can be made that can strap around the back and can protect the femoral artery when someone is cutting something.

A social media app can let the user post interactive polls with their viewers. These posts can be restricted to a time limit, and can be longer the 15, 20, 30, 45, 60, or 120 seconds long.

A device that is built-in, placed-in/on a shirt/jacket or placed around the neck of a user can blow cool air on their neck/head and spray water and mist to cool them down in hot weather.

On a touch screen device that is recording a video the user can simply swipe up with a finger/s to zoom in and swipe down to zoom out. This can be done once the selection to start a video has been pressed and a finger to hold down selection to keep the video recording is not necessary.

A motorized boat can have an anti-flipping device. To prevent from flipping backward at high speeds weights can be mechanically moved at the bottom of the boat to move forward and keep the nose weighted down, at slower speeds this can move back.

An expanding absorbing material that is put in wounds to reduce blood loss and be enclosed with device that is liquid tight can makes a seal with the skin by means of an adhesive.

A phone/tablet/laptop case can be made that a part that can slide out that redirects soundwaves to amplify the sound of the speakers.

A surf bootie can have tread on the bottom in rectangular shapes near a square centimeter in size and with a thickness of 1.2-5 mm thick. A tread can also be in any shape that can protrude from the bottom surface, which can be called thickness, by 2 mm to 7 mm and have a wavey line design for tread.

A vehicle can have headlights/taillights/high beams that can rotate. The light itself can rotate or what reflects the light into a specific pattern can rotate.

A pair of tweezers can have 3, 4, or 5 arms that join at a fulcrum. At one end of the tweezers arms is the tip which is what contacts the subject and at the other end is the fulcrum. A fingertip cover can fit snug around the fingertip so that the finger can have control opening or closing the tweezers.

A slip-on shoe usually has two sections of stretchy material on either side of center on where the shoe tongue would be. My design for a slip-on shoe has the two stretchy sections and a third in-between them. Said third centered stretchy section can be in the shape of an arc with non-stretchy fabric inside the arc. Another design is to have one or more stretchy sections go from opening of shoe all the way down to the rubber border at the base of the shoe, this can be for a shoe with or without an elevated heel. A shoe with or without laces can have 1 or 2 stretchy sections on either side of the tongue. A stretchy section can make an arching shape that isolates a less stretchy fabric panel that can be where the tongue would go or be around the achilleas tendon area. A shoe can have two stretchy sections on either side of the achilleas heal that can continue to the rubber border. A shoe can have one stretchy section that cover the achilleas tendon area and continues down to the rubber border. A shoe can be made with a total of 3, 4, 5, 6, 7, or 8 separate stretchy sections.

To make vacuum bagging have less steps a product can be made. This product is plastic bag with a cloth the provides cushion in its interior. These to parts can be attached and made into the general shape of board design.

A computer shortcut to select all words and/or images in a document can be ctrl alt c/s or any letter in any order. This way you won't have to wait for all the document to be selected.

### NP August 2022

A surfboard can have a CO2 canister propulsion system. The canisters of compressed CO2 or other gas can be mounted on the bottom of the board, on a fin or in the tail of a board. When the gases are released under the control of the user, it propels the board and the rider forward. The canisters can be interchangeable and refillable. The release of the canister can be mechanical or electric through the board or remote controlled. A board with a foil attached to it can also be powered by the release of a pressurized gas like CO2 where the canisters can be attached to the wings, fuselage, or mast of a hydrofoil system. This will most likely be remote controlled.

A skateboard can be powered by compressed air canisters. When the gases leave the canister a fast speed it can hit a propeller like area on the inside of the wheel to drive the skateboard and rider forward. This can be controlled mechanically, electronically or with a remote control.

A fashionable belt can have a surface that illuminates and is a screen, the user can swipe between designs it can display. This can be battery powered and can have a charging port.

A hydrofoil can have a rotational connection on the fuselage so the fuselage and wings can rotate to be inline with the mast. This will make it easier to store of the hydrofoil since it will take up less space.

A wetsuit can have a back zip and a hood.

A hydrofoil can mount to a board by means of a spring bar that has a rotating bead. As the base of the foil is being mounted into the board when pressure is applied the bar bends and the bead rotates into a groove to receive the bead. Once the bead snaps into its groove the bar is no longer bent, and the foil is attached.

A gummy candy can have a sweet or sour coating and a sour liquid core. This candy can be molded into the shape of a person/animal or a sphere.

On a social media post where the caption is below the post the user can have the option of selecting a font color, font style, bold, italics for the caption.

A smart phone case or smartphone can have bright lights on the perimeter of the front phone screen. The purpose of this to shine light on the users face so that they can see their face more clearly for putting on makeup or just to take high quality photos.

Board shorts for surfing can be made with a pocket with a looped fabric for car keys to be tied to. A pouch that can hold electronic keys and keep them dry in a board short pocket.

A wetsuit can have a pocket or pouch that holds in a watertight capsule. Said pocket can have a screen that can be typed on and touch screen through. The perimeter of the screen can have magnets that are meant to some into close contact with the magnets on the perimeter of a phone or phone case. Another method of attachment is by snaps, clips and/or lever locks. Said pocket can be located between the elbow and wrist/hand. The structure of the pocket and be rigid and stiffly formed. Could be made of materials like plastic or a polymer.

A jet ski can be made with a phone/tablet mount with the ability to accept a product made by another company. This can be mounted on the dashboard of the vehicle. A special case can be made that is waterproof for the phone/tablet and allows specific attachment to the jet ski aka personal watercraft. The attachment can also provide charging to the phone/tablet, and other ports of the device to be accessed. The device can be taken from its mount and still be attached to the vehicle by a cord connection. This lets the users stand up with their devices and even move with it.

A motorized camera mount can be meant for a camera that much smaller and is only around 1″ thick, 2″ wide and 3″ long. The motorized mount can offer attachment means of structured loops that fit snugly with fitting loops that can be secured by means of a screw that runs through the loops and fit with threading attached to the end opposite of entry to tighten.

A speargun can have knife sheath built into the butt of the gun. The butt of the gun is past the trigger and handle; and is used to be pressed against the chest when loading the bands. A knife sheath can also be located on the handle grip, or anywhere on the frame or stock of the gun.

A wetsuit can have a mount for a smartphone or walky-talky to attach to. A leash can attach to the device that can recoil back to the mount. The mount can be made of a plastic frame and have clamps or mechanical locks to secure the devices. These mounts can be placed on the wrist of the wetsuit or on the chest near one of the shoulders.

A toy mask for children can be made that has a movable jaw that moves when the users jaw moves. Said mask has feathers on it and when the jaw is moved the feathers on the mask stand up straight. This motion can be mechanical or electrical. Where information from the jaw opening sends a signal to extent the feathers. The feathers are rotated at the base by being pulled by a cord.

A pair of glasses can have one or more magnets in either the primary lens frame or auxiliary lens but not both. They can attach to one another by means of magnetic attraction between magnet and metal.

A pair of glasses can consist of a primary lens frame and an auxiliary lens where they can connect by means of magnetic attraction. The auxiliary lens can be made without a frame that covers the perimeter of the lens. The auxiliary lens as well with the primary lens can have no nose bridge frame. These lenses can be one-piece for the spectacle system, as opposed to one lens for each eye with a nose bridge frame in between. In the one-piece design, the lens covers the area that the nose bridge would cover. A strip of metal/magnet can be placed on the inside of the lenses so that they can magnetically attach with out a frame. For glasses with a frame the same metal/magnet strip can apply so that there is a strong connection for the auxiliary lens frame attach to primary lens/frame. For glasses that have a nose bridge, auxiliary lens can attach individually and without an auxiliary nose bridge.

A pair of glasses can have a frame with magnets or metal pieces imbedding in the frame. These glasses have no lens in them. A pair of lenses or a single lens that covers the area over both eyes and the nose bridge can have one or more magnets or metal pieces imbedded into them. Said frame can have an “L” shaped inside perimeter, this allows the lens or lenses to have a surface to rest on a surface that comes up to make the surface of the lens flush with the frame. The magnets or metal can be on either surface of the “L” shape inside perimeter or both. This design allows the lens or lenses to pop out and be interchangeable.

A pair of glasses can have a base frame that remains stationary and a secondary frame that can rotate. The base frame has a circular groove for the secondary frame to fit into and rotate inside of. Ball bearings can be located inside said groove between the frames so that the secondary frame can rotate with low friction. Each of said circular grooves in said frames can be located over the lens of each eye, right and left. The perimeter of said secondary frame can be ornamental and have different perimeter structure than base frame/s. The lens of the glasses can be either attached to the base frame so that it is stationary or to the secondary frame so that it can spin.

A pair of glasses can be secured to the user's head without any arms that are supported by the ears to keep them up. One way to do this is to have one or two arms on either side of the glasses frame that do that protrude less than an inch or just over an inch. A spring or elastic part can be used to make these small arms put pressure on the face of the wear so that they are secured. Said elastic part can be a metal/plastic/polymer that is slightly deformed when wore and this makes it give pressure on the face. The same method of attachment can be done, spring or elastic, with a panel attached to either edge of the glasses frame. A third method is to have a spring or elastic mechanism to put an inward force on the nose bridge of the glasses. This will put pressure on the nose to keep the glasses on.

An ear cleaning device comprising a handle and cleaning tip, where the tip can be made of silicon, or another rubber. The tip can have spiral shape with a sharp edge so that when the tip is rotated ear-junk can be scooped out and removed without pushing it in deeper.

A social media app that has a discovery section where there is a search bar at the top of this section and feed is organized below in rows of two or three, and the middle section of the app has a single row of feed; can have posts that have multiple photos or short videos and a selected timing where the photos/videos are presented as an automatic slide show and music can play throughout the slideshow of all the content on the post.

A soft top surfboard which has a top deck made with a non-rigid material, such as foam with rubber padding or laminated with a rubber or plastic layer; can have a top deck surface that has a tread pattern that protrudes from the surface of the deck more than 0.5 mm, 1 mm, or more that 2 mm, 3 mm, 4 mm, 5 mm, and even more than 10 mm. This textured surface provides grip so that surf wax is not need. The ideal depth of texture I would design would be around 3 to 4 mm.

A soft top surfboard that has a top deck made with a non-rigid material. A laminated layer of rubber and/or plastic can cover the outer surface of the top deck, beneath this layer there can be a thin layer of foam followed by a foam core. Said surfboard can have metal screws that enter from the top deck of the board to secure the fin boxes.

A soft top surfboard which has a top deck made with a non-rigid material can have one or more wooden stringers for strength.

A globe that has a stone surface of varying stone types can have stones which are color coordinated with the surface of the planet.

A gummy candy with or without sweet and/or sour sugar coating and have the active ingredients of pre-workouts, and/or creatine, and/or protein concentrated mixture, and/or super creatine, and/or carnipure carnitine.

A spray paint bottle can have chambers of different colored paint. It can have a nozzle with the different colored paint to exit within millimeters of one another.

A pair of sunglasses can have two cameras within several millimeters of one another. One can be for close focus and one for more distance focus. A third camera can be added that is also near the others that can specialize in long distance focus, and a fourth for even farther focus. It can also have one or more light censors.

A dinosaur toy can be battery powered and have features. When a button is pressed on the toy, or the toys remote the feathers on the dinosaur can stick up. This is a battery powered movement. The legs the dinosaur can walk and be controlled by a remote.

A mushroom chip can be made for nutritional or psychedelic purposes. A dried mushroom can rest on or be sandwiched between a potato which is then cooked in oil so that it becomes a chip. It is then seasoned and packaged into a bag. The same can be done with corn chips and mushrooms.

A glass bottle/jar can be made with a two or more different colors of colored glass in the bottle. In the manufacturing process, when the glass is melted it can be mixed with a glass of another color or multiple melted colored glass. Each of these melted glasses is cut to a specific portion and then travels down a shoot to a towards a funnel where they converge and form one piece of glass. Then they are put into a mold and have air pressure hollow them out, then they cool. A similar but alternative method is to have long strips of different colored glass that run down a shoot to be conjoined into a singular glass body. The new glass body is then cut into portions of bottle size and put into mold, pressed with air and then cooled off. The method of mixing colors in either of these processes can be somewhat randomized so that each glass looks unique. The same process can be done with plastic water bottles, where different colored plastics are mixed together throughout the bottle.

A spray paint nozzle can have a feature where the a moving part can be pushed by the users finger and as it is moved it slides over the exit point an scraps it clean. A spring can push the scrapper back so that it is out of the way for painting.

A pair of underwear can have a small pocket on the waist band of the underwear. This pocket will be big enough for small items like headphones, a few keys or supplements.

A pair of underwear can have jacquard bands on the bottom of the leg endings.

A pair of diving flippers can have adjustable heel straps that don't have a buckle that completely disconnects the strap on one or both sides. The straps can or cannot have the ability to rotate. These straps can be adjustable with or without incremental bumps that catch and stop the strap from sliding. Without these bumps the strap can adjusted various ways one being a buckle with no moving part but has three bars where the strap can be woven through them, and the other being a ratchet with a rotating lever and a surface with teeth, when the lever is rotated up the teeth are rotated away from the strap can when released the lever rotates down and the teeth catch and secure the strap.

A pair of diving flippers can have a heel strap that is made of stretchy material. This can be of elastic webbing, or of rubber/silicon/latex. The strap can be of jacquard or waistband-like material. This stretchy heel strap can be a fabric, or have sections of this stretchy fabric. These stretchy straps can be uniform or have non-stretchy sections within the heel strap. This can allow for the heel strap to not need a length adjustment system. Thus allowing the flippers to be lower profile, so it doesn't get caught on kelp.

A diving flipper that has an inclosed heel can have the inclosed heel made up of a stretchy fabric like a latex material. Said material can be stitched together to make an inclosed heel. This enclosed heel can have the stretchy material only cover the very back edge of the heel that needs to stretch the most when put on or can cover sections on either side of the ankle.

A dive light can have a screen on it that informs the diver of various information, such as current depth and length of dive, in time and distance covered. It can even have GPS coordinated information. One or more buttons on the dive light can pertain to settings of information that show up on the screen. One of these buttons can be a stop/start/clear for a stopwatch. The battery that powers the screen and its functions can be the same as the one that powers the light, or it can have different smaller batteries that power said screen.

A Hawaiian sling and/or a speargun can have measurement along its length. This can be in either of the main measuring systems.

A compact sports camera can have two or more cameras in the same camera frame. Said camera frame is a structure that encompasses the camera/s to keep the camera safe and it can protrude from the surface of the camera.

A compact sports camera can have a screen on the same side as the camera frame and this screen can be a touchscreen. This screen can have a feature where it can shine bright light with a flashlight. This screen or lights on the camera side can exceed 25, 50, 100 lumens. This is especially useful when filming underwater.

A social media app that has video content posts where a variety of engaging features, such as “liking”, commenting, sharing, and more, can have these icons for selection arranged in a vertical positioning structure on the left side of the post.

A social media app or website usually has a different structure on a smartphone app than on a computer or laptop. While using a social media app on a computer or laptop a video post can be skipped forward or backward by an incremental amount of time such as 5 or 10 seconds when a keyboard arrow is pressed. To skip forward the arrow that points to the right can be pressed and to go backward the arrow to the left can be pressed.

A social media app can have a section of the screen where when touched by the users finger reacts different another section on the screen. This lets controls remain simple. For example their can be two sections on the screen of a post. On one the section holding the screen can pause the video. On another section holding the screen doesn't pause the video but when the finger sides up the video can fast-forward/skip forward and when slide down it can reverse, skip backward or slow motion. When the finger slides to the right it can fast-forward/skip forward and when slide to the left can reverse, skip backward or slow motion. Any of the said finger movement in said section can cause a speed up or slow motion of the playing video. The more the finger is slid from its starting point of contact the more the slow motion is slowed down and the more the fast-forward is speed up.

To find a specific word or phrase in an online document it is easy to use “ctrl f”, holding these to keys allow the user to search for words or phrases in the document. However when doing this if you are off by just one charter then zero results will show. Lets say you want to find the paragraph or sentence when the words “cat” and “dog” are used but you don't know the words between them. A designated button or key can be used at the end of the words to separate them. Said key can be a “;”, “*”, “{”, “'” or “˜” or any key, preferably ones that are rarely used.

What this does is it allows the computer to check the document for sentences or paragraphs or where both cat and dog is used. It can also allow the for three or more words or phrases to be searched for when the designated key is separating them. Said system of searching can also be used on a search engine to find the best website/article/document.

A mouth guard to prevent teeth grinding when sleeping, can also be used to lengthen the look of the user's jaw, and even be chewed on to strengthen jaw muscles. Said mouth guard is made of two separate parts. Each part for each side of the mouth, right and left. Said mouth guard can have an ergonomic shape to cup around the users' molars. Said mouth guard is made of silicon or rubber. There can be holes going through the guard so that it has more response when chewed on.

A pair of shorts can have a buckle/clip where the outside surface of the buckle/clip has a bottle opener. A close toed shoe, without a heel, can have a bottle opener on the bottom surface of the shoe, said shoe can have a rubber/polymer bottom. A belt can have a bottle opener on the outside surface of the belt.

A bottled drink can have five, six, seven, eight, nine or ten flat sides.

A bottled drink can have four flat sides where two, three or four of them have clear sections in them so that someone can see through to the other side they can see graphics on the inside of the label on a through the bottle. For a circular bottle there can be clear sections in the label to see graphics on an opposite site all across the circumference of the bottles label. This can be done with a clear strip that wraps around the circumference or patches of clear spots scattered along the circumference of the label.

A pair of short, especially board shorts which are meant for water wear and absorb less water than most shorts, can have one or more sections along the top waist band of the shorts only going down one or two inches can be made of a panel of stretchy and elastic material for a comfortable and snug fit.

A floatation device for a small underwater camera can be comprised of a peelable sticky layer that can permanently attach to the surface of a camera case, a body made of foam or other floaty material that holds air, and a mouthpiece that protrudes from the body or back surface of sticky layer. Said mouthpiece can have a stem to distance from the body and a rubber guard on the surface of the mouthpiece for comfort and safety. Said stem can have one or more holes to enable airflow for the user. One or more of said holes in the stem can have an attachment for a snorkel. The snorkel can make a watertight attachment by means of screwing together with respective male and female threads, a clamp, or a snap with respective male and female grooves. The other holes in the stem can be sealed with a panel that attaches in any of the said ways for the snorkel and can have a small protrusion that can be used as a handle. A loop handle can protrude from the body, stem or sticky layer of the device, said loop can have an adjustment part with rotational lever to secure the loop to a certain size so that it can say around the neck or wrist of the user.

A mount for a compact sports camera that attaches to camera case by means of specifically spaced flat surfaced protruding loops, where the loops are specifically spaced other specifically spaced loops to fit and slide into one another. The loops on the case can be called female and loops on the mount can be called male. The holes in the loops are able to fit a bar with a threaded end and at end of one female loop can have a part to receive the threaded bar, this secures the case to mount. On a mount with said system of attachment, a stem can have an “L” shape and at end of stem can be a mouthpiece. Said mouthpiece can have a hole for airflow that is in a parallel line with the mouthpiece. Since the stem is in a “L” shape we can call this a two a two-pillar structure. A hole for airflow can be made from any surface on the pillar that the mouthpiece is attached to. The square/rectangular area of overlap of the two pillars can also have hole for airflow on any side or surface.

A bottle of liquid sunscreen can have two or more colored/tinted sunscreen inside. This can be done filling up the bottle with different colored/tinted sunscreen next to one another. This process is very similar to how toothpaste is filled with different colored lines of toothpaste. This will create a cool design when the sunscreen is applied. The same can be done for sunscreen in a stick that is applied like a glue stick or deodorant. To accomplish this for a more solid form of sunscreen a strips or sections of different colored sunscreen can cut, then pressed into its container adjacent to one another. Said container can have a twisting part that pushes up sunscreen when twisted one way and lowers when twisted opposite.

A surf bootie can have an external pad that overs the bottom of the foot and continues up the Achilles heel. Where it is over the Achilles heel tendon it can have a strap to help the user put the bootie on. Said external pad can continue up to the top of the bootie wear it ends near the calf muscle. Said pad can be of rubber and have textured surface for grip.

A surf bootie can have a bottom sole thickness of less than 5/16″, ¼″, 3/16″, or ⅛″ and have a bottom surface texture of ridges on a pad that exceed 1/32″, 1/16″, ⅛″ or 3/16″. Said pad can be made of rubber. Said sole can be the entire material of the bottom material of a bootie that is between the bottom of the user's foot and the ground. This includes said pad of texture.

A wetsuit can have a recoiling apparatus, this can be located on any surface of the wetsuit. It can include a frame which holds a recoiling spool with a circular spiraling spring. A part with a groove can be attached to the frame, this is for said spring to attach so this end of spring stays fixed. A spool can have said spring inside it, with the other end of said spring fixed to the spool. Said spool can have teeth that catch when it is spun only one direction, a part that engages with teeth by being pushed towards it with a spring, can have a button that is pushed outward by a spring. When said button is pressed a lever push said part that engages with teeth away from teeth so that the line and spool recoil. A pad to cover this recoiling device and secure it to the wetsuit, and a part at the end of recoiling leash that is to big to be recoiled in and this part can offer attachment to a device. Said device can be a camera with or without a case, or a walkie talkie or a cell phone/cell phone case.

A shirt, jacket, shorts, underwear, pants, neoprene garment, wetsuit, hat, glasses, watch, ring, or phone case can have a thermochromic pigment as a component of the fabric or as a coating on the surface. A pattern of sections of fabric and/or surface can not have a thermochromic pigment so that when the temperature is changed so that the thermochromic pigment is changed the contrast to the non-thermochromic fabric/surface can pop, and color patterns can change. Also said items can have sections of fabric composition or coating that can include two or more different types of thermochromic material/molecules so that these sections turn different colors relative to one another in the same temperature.

On an app/website/downloaded writing software when the user types a word that is misspelled, said word becomes underlined. When the user makes a selection click on the misspelled word options of words the software thinks the user is trying to spell can appear. Next to said option words in parenthesis synonyms of the option word can appear.

A remote-controlled submarine with or without a camera, also known as an underwater drone, can have one or more propellers that protrude from the body of the craft with a part called an arm. Said arm can have a joint that is powered so that it can move. A propeller can protrude from the top surface of the craft and when the arm is moved it can protrude from the bottom of the craft. When the propeller is moved to the bottom position it can allow the craft to plane on the surface of the water as a boat. Said underwater drone can have a camera that is on a platform. Said platform can extent straight outward, this extension can be powered by the electronic component of the craft. This extension can be possible by interlocking parts that can slide past one another and fit inside one another, like a collapsible antenna. It can also extent with one or more parts that have interlocking tracks. Said tracks can fit with gear. When said gear mechanism is powered it moves along the track extending or retracting the part based upon the direction the gear spins. Said part can also be called a mast, since it upholds the camera.

A submarine/torpedo pool toy can have a sleek hydrodynamic body that is made of rubber or plastic. It can have one or more propellers that have spin or are fixed to the body of the submarine/torpedo. A hole in the back of the submarine or free spinning propeller can be made to receive a pole which is attached to a handle. On the end of said pole a circular surface pattern can be made where there is a repeating right angle like design where the adjacent side is faced down and attached to the rest of the pole. The opposite side and hypotenuse are on the outer surface of the end of the pole. The inside of the hole in the submarine/torpedo can have one or more slots with right angles or over-vertical angles that receive surface end of pole. A handle can have two arms at either end of handle that protrude perpendicular to handle and two loops at end of each arm that encompass the pole and allow the pole to spin with low friction inside the loops.

A spring can attach to the pole and be wrapped around it. The user holds the handle in one hand and pulls the string with the other. The quick rotation of the pole causes the submarine/torpedo or propeller to rotate quickly, thus accelerating the submarine through water. The same principle of creating a propelling submarine/torpedo toy can be accomplished with a wind-up propeller. This can be done with one or more spiral shaped spring where the end inside of the spiral spring is attached to a rod that can be rotated by the user. A gear and ratchet can be used to control the speed the spring unravels. The ratchet allows the gear to only spin one direction. The gear is connected to the propeller directly or indirectly by means of other gears. When rod is spun then released it cause the spring to spin propeller in a controlled way to steady release stored energy. One or more rubber bands can be used with this method, adding to or replacing the spring/s. A hook on the frame of submarine/torpedo can hook one end of the rubber band and a hook on the rod can hook the other end of rubber band. Now the rod can be spun, and this loads the propellers. Gear and ratchet do their job. The propeller can be released, and the craft can shoot forward through water. A slot can be made to hold propeller/rod/part, so it stays loaded. When the propeller/rod/part is pushed forward it slides out of slot and is released to spin.

A candy can be made to go around the rim of a drink. It can have the same general circumference, and diameter of the drinks edge it wants to fit around. For a canned drink this can be the ridge that the user puts their lip around. A groove in the candy can be made on its bottom surface so that the can's ridge can fit into the groove thus securing the candy to the can. The candy can be a chewy candy like Sour Punch flavored straws. It can also have sour coating like said candy. The candy can also have a sugary coating as well, with or without sourness. This can rim candy can have corn starch, sugar, wheat flour, fruit juice and citric acids as its main ingredients. Once one area of the rim candy has drank over, this adds the sour/sugar to the flavor of the drink. The candy can then be rotated so the user can drink over a different surface of the candy. Once the beverage is finished the candy can be taken off and eaten. The surface of the rim candy can be covered in malic acid and tartaric acids to make it fizz like Zotz candy. A strip of paper that can be dissolvable can have this sweet/sour/fizz coating to be put over a drink. A fold in the paper can be made to have it cup the can's rim. The sour and/or sweet and/or fizz coatings can cover a piece of plastic, or glass or solid structure. The structure can then fit over the rim of a canned drink or a long neck bottled drink, so that the user can drink over the sour/sweet/fizz surface.

A hollow tube of candy with a sour and/or sugar coating can be made where the tube is longer than 2″ and the candy is chewy or hard. This can include a licorice candy like a Red Vine that has said sour and/or sugar coating.

To relieve dryness of throat a device that sprays a liquid on the back of the user's throat can be made. A button can release a spray just like how a cologne or inhaler sprays a fluid. Said fluid can have a high viscosity so that it stays covering and moisturizing the surface of the throat.

It can even be sticky. The active ingredient of the spray can be menthol, benzocaine, and/or dextromethorphan.

A drink can have Super Creatine and Carnipure Carnitine. The combination of these two ingredients will make a great energy drink of brain focus and energy.

A drink can have Carnipure Carnitine and have real sugar.

A drink can have Super Creatine and have real sugar.

A windmill can have rotator blades that spin and collect energy from the spinning motion, where said rotator blades are attached to a rotator blade of a larger windmill that also generates clean energy.

A security camera can have a laser pointer, speaker, and projectile firing device. When a person enters an area that is not supposed to be entered, the camera can locate the person and shine a laser beam at the person, and lock onto the person and follow them as they move. This will intimidate the intruder so that they will flee. The speaker can then give the intruder a message. The message could be that they will be fired at in a short period of time if they don't leave. Then a gun attached to the camera system can fire at the located target or targets. Said gun can fire real bullets, rubber bullets, paintballs, or plastic/metal bb's. This camera system can use facial recognition to determine if the individual is an intruder or not. Faces of the people who are not intruders can be uploaded to the software of the system. A movement code that can consist of a gesture or a series of movements done in proper order can tell the camera system that this individual is not an intruder. If a proper intruder is located and lock onto as a target from the camera the laser locks onto a specific part of the body and a speaker message is automatically played. This can happen in either order, with or without the laser being initiated.

A rehab facility, vocational retreat, ocean harvest center or home can be located on an offshore structure. Said structure can be secured to the bedrock by beams, like an oil rig; or a more cost effective structure can be floating. The floating structure could be made of wood or metal, can have multiple anchor points to prevent drift. The configuration of the structure can have an open center for swimming. Around the inside or outside perimeter of the structure can have a net and/or chains that go down to a depth and connect to seal a protected area from sharks. Levels of boards can be submerged for fish and crustaceans to make there home. The board levels make shaded hiding places and can be raised or lowered in the water column for scientific research or harvesting. Kelp and crustaceans can attach to lines and the chains so that they can be harvested for food. Solar panels and windmills can be mounted on the surface of the structure. Platforms can be made for sea birds to have a safe nest, with border panels so the nestlings don't slide off. On the outside of the structure's perimeter platforms for sea mammals to rest can be made. This structure can be a beautiful place to observe nature and biology in a scientific way.

A vehicle's headlight and/or high beams can have the brightness controlled by a rotating dial so that as the dial is turned the brightness of the said light/s can gradually increase or decrease based upon which way it turns. The dial can have 3, 4, 5, 6, 7, 8, or more incremental adjustment positions for brightness, or have no incremental positions which allows an even more smooth transition of light adjustment. This is done by dial turning allowing more or less energy to power said light/s. This feature can also be controlled by a part on a track so that as the part is slid on the track it can increase or decrease light respectively. This feature can also be controlled by a touchscreen interface.

A guitar to help people quickly learn new songs can have lights along the neck in various positions. These lights can light up to tell the user what fret and string/s to hold. There can be individual lights on each fret under each string. As long as the light is on the user should hold down the indicated string in each position. As the lights change the user can follow along and learn a new song quickly. This guitar can be coordinated with an app so that on the app the user can search for songs to learn and can listen to the song as they follow along. This means the guitar can have a wireless connection to devices. If the user wants to create a song this can be recorded on the app by fret and string use within the timing of a song. As the user plays the guitar this can be recorded in the app. Or this can be recorded manually in the app by the user, so they write about fret and string sequence and timing.

A pillow can have two indented surfaces for the heads of two people that sleep close to one another. Said pillow can be of foam and said indents can hold this form.

A hat with a flat or curved brim, and a flex fit or snap back adjustment feature, can have one or more sections of the hats surface fabric panel where it is made of a stretchy material. Said stretchy material can have descent percentage of latex, rubber or polyester for stretch. Said stretchy material can also be woven in a way that gives larger stretch and holes by having the woven strips in larger segments. Said panel can include the back half of the surface of the hat, which can be plastic mesh in some common designs. The back of a hat would be where the snap back device is placed, and the front is the brim area. Said sections can include strips on either side of hat in the general middle area. These can be in the middle triangle shapes in common hat panels, or can be rectangular or any shape. Said shapes can converge at top of hat or only cover area a few inches or less from the bottom edge of the perimeter of the hat. These panels make a snap back more stretchy fitting and can allow a hat to be made without a snap back or a flexfit design.

A spear gun can receive and fire micro-shafts. Said micro-shafts are shafts that are not full length, essentially their length is less than the length of the stock. This micro-shaft can have a barb or flopper. The benefit of no flopper is to be able to easily take out of small fish, or for it to fall out of a shark. One main benefit of this product is to firmly warn off curious sharks in a non-lethal. This device will be able to break the thick skin of the shark, but this will not create an injury that will affect them. The tip of the micro-shaft can be dull and/or flat to not pierce the skin. The quick impact will spook them. The size of the micro shaft can be from 16″ to 10″ this will be best for small fish, 10″-1″ for shark or crocodile safety. There is no need for line attachment.

A spear gun can have a shaft groove on bottom side of the stock or in a section of the stock that is cut out for this underside area. This is where the micro-shafts can fire from. The same band in the gun can swivel around and be used from here. A long mechanical arm can me it be fired from a trigger in the same trigger guard, or a trigger be right near the shaft connection.

A trigger mechanism for a spear gun can consist of a trigger release from a rotating dial. Said dial can be cylinder or rod running parallel with the shaft. It can consist of an attachment point to the gun that swivels at each of it ends, teeth that interlock with the shaft when in the right position, and a lever platform to push with the thumb or finger to rotate the dial so that the teeth no longer make contact with the shaft and thus it is fired. A safety can be an elastic band, or arm rotated by a spring that holds the platform in the locked position.

A Hawaiian sling or a pole spear, which are very similar, can have a sheath for a knife in the tail end of the frame that is near the rubber band. The knife can be very skinny to fit in line with the frame of the sling. The handle of the knife can be very circular to be flush and hydrodynamic with the frame of the sling. Spiral grooves/ridges in the inside of the sheath can allow a screw together attachment between the knife and sheath. A snap, clip or latchet methods can also be used to secure. Said knife and sheath can be located on the behind where the rubber band is located. This area that has the sheath could also be a storage compartment that holds items. Said storage compartment can also be located in a speargun body.

An ergonomic pad to comfort the back of pelvis and lower spine when doing abdominal workouts. The pad can be made of foam and have an indented “V” or “U” shape. This design can comfort the sacrum bone when lying one's back. This “V” or “U” shape can ergonomically match the sacrum bone structure, and their can be other divots that are ergonomic for the ilium bones on either side. This pad can continue up past the head of the user as a full-length pad. This pad can also only extent to lower back, in which case the pad will thin out into a yoga pat thickness at its upper board that ends at the lower back. This smooth transition from pad to no pad is key to keeping a healthy back during workouts. This gradual transition board can be used for any pad that is meant to go under your hips.

A device can secure itself to the back of a bike, dirt bike, or four runner that has one or more wheels. The device can be attached to the frame, bike seat stem/seat post or fender of the vehicle. When the rider does a wheelie the wheel/s on the device meet the ground. This prevents the rider from falls backward went learning. This is essentially training wheel/s for wheeling. The device can be adjusted to extent to different lengths and be set at different angles for wheeling differently. Said device can have shocks to have a smooth feel when engaged.

An ice cream treat can consist of a section of ice cream, then cookies and candies that can be whole or crunched up can be laid upon the ice cream. Next the ice cream with the toppings in put through a process that coats them in a layer of chocolate. A machine can deposit puddles, or strips of a liquid topping like caramel, chocolate, fudge, marshmallow and more.

A yoga mat can have a curving shape in the thickness of the mat. This can be to have a more comfortable and ergonomic shape. A curve can be made to support the arch of the lower back, cushion the back of the head, support arch of neck and back, and have ergonomic foot supports when standing that fill in the arch of the foot.

A social media app can let two or more accounts edit the same post in the same format. Each of the accounts can edit the video/s, photo/s, caption, text, audio, location, and tagging in the post. This will allow a platform of team cooperation. This is like Google Docs for social media posts. When some is editing a feature, their name can be shown near it. What they have edited can be saved and later looked out so their editing can be reversed.

A document writing app or website like Google docs or Office Word can have a feature that shows how someone has edited their document. When some is editing a feature, their name can be shown near it. What they have edited can be saved and later looked out so their editing can be reversed. A history of each person's changes can be viewed in a chronological order in a pop-up window/section. The lines that were deleted can be viewed as such can can be restored.

A social media app can have a system where when someone makes a post, another account ask to collab on the post. A notification is sent to the account that made the post if that user agrees then the post becomes a collab. Said post is then uploaded onto the other accounts page. Both account names are at the top of the post and the followers/subscribers of both accounts can shown this collab post.

A nozzle can be made on a toy spray product, like a silly string can. The nozzle can have a hole shooting the spray straight forward in line with the length of the can. There can be two tabs on the outside surface of the nozzle to push back and spray the toy. This inline design is perfect to be mounted in/on the frame of a toy gun. A trigger mechanism of the toy gun can be used to push the can forward and this will cause the nozzle to be pressed in by the frame of gun, thus causing the string to shoot.

A device can be made that secures itself to a dumbbell or kettlebell on either end and a strong bar connects them. This bar is then used as a weighted workout bar for your home gym. You can do curls, bench press, squats and many more exercises with it. Bars two points of attachment can attach to said weights by a clamp, a strap secured like a belt, a clip, snap, a lever and buckle like a ski boot, and straps and one, two, or three bars in a piece that the strap is woven through like a backpack strap.

A watch can produce a holographic image with two or more points of light being projected upward. When each of these light projections is overlapped with the other hologram can become more complete and more detailed. Their can be 3, 4, 5, or 6 of the holographic light projectors on or near the frame of the watch or any device.

An ice cream treat can be comprised of; ice cream, taco shell/waffle shell, ice cream, taco shell/waffle shell, also can have other another alternating pair of ice cream then taco shell/waffle shell. Each of the ice cream layer can be flavored and can have any topping in it including chocolate and caramel sauce. Each of the taco shells/waffle shells can be covered in chocolate or caramel sauce. Taco/waffle shells can be covered in Carmel or toffee sauce for any ice cream treat.

When using an online mapping service or app when a special section is made to make the curse have a line following where the curser goes. It can show a color or area to signify if the landscape slopes downward, flat, or upward. Selections can be made to mark paths with this information on it.

A shipping container or a container for truck transport can have a plastic liner which covers the inside surface of the container and has a hole for offloading and/or an attachment for controlled offloading, that can be opened and closed. There can be an large opening in the top for loading up the container, said opening can have a controlled and sealable closure. This liner allows the enter container to filled with product.

An online mapping app or website can have a measuring feature where you place a point and place another and measures the distance between an origin point, said app/website can show the measurement change (+/−) in elevation difference between them. Said app/website can show the measurement distance between each point made with the measuring tool.

An online mapping app or website can have the ability to change its view to a 3D view. When it does this it lowers the viewpoint if necessary and brings it to a downward looking angle. Once in 3D viewing mode the angle of view can be changed, by a tool that only deals with this angle change. This can be down with a selection on the screen of the app/website that can have arrows, a dial, sliding bar, + and − buttons and more. The arrow up/down or left/right on a keyboard can also be used for this.

An online mapping website/app can have a topographic range that can be specifically typed. Once the range which as been set in with a high and low value, a color can be selected to appear on the surface area of the mapped that fits the range which was set. A light shading of the color can cover the satellite image of the surface of the earth. Multiple ranges and colors can set.

An online mapping website/app can have a line drawing tool, wherever the curser is clicked a point is added in a line with other points. A selection can be made to make another object with the line drawing tool, where the previously drawn item stays on the map. Each different line can have a different color.

A surfboard stomp pad can have three separate sections that each have a kick.

An image editing software can have a setting where you can make and save you own specific filter. Said specific filter can have saved levels of multiple alterations the software can offer such as contrast, brightness, saturation and more. The specific filter can be named by the user and when the user edits a video it can choose said specific filter.

A pair of glasses can consist of two arms that go over each of the users' ears, a bar that connects the two arms together with rotating joints, a nose piece that is supported by the nose and connects to the bar. Said bar can have curves and have magnets or magnet objects place in it as well has the nose bridge and arms. The lens is separate and can have magnets or magnetic objects which can attach to the magnets or magnetic objects that are in the other parts previously mentioned. The lens can consist of a right and left lens each able to attach, or a single lens that spans over both eyes and the nose.

A social media app can have the icons for “liking”, commenting, sharing and more on a vertical column on the left-hand side of the screen or on a horizontal row across the screen.

A social media app that has a home section for posts from accounts that you primarily follow which can be scrolled through vertically, a search section that shows posts that are in the interests of the user in columns of two or three, can have an editing feature for making posts that has an audio bar located near a video bar. Both of these bars can be trimmed, and arranged respectively to one another. The front end of these bars can be held to slide them into position.

A social media app that has a home section for posts from accounts that you primarily follow which can be scrolled through vertically, a search section that shows posts that are in the interests of the user in columns of two or three, above these columns in the search section there can be stories or limited time posts of accounts that tend to pop up in this section.

A social media app that has a home section for posts from accounts that you primarily follow which can be scrolled through vertically, a search section that shows posts that are in the interests of the user in columns of two or three, can let an account make a post that has over 10, 15, or 20 photos and videos.

One or more pre-rolled cannabis products can be packaged in a clear plastic or glass tube.

An electrical trimmer can have a triangle shaped guard that can have one point of rotational attachment to the bottom of the trimmer. Any shaped guard can have one point of rotational attachment on the bottom of the trimmer, this attachment can be centered on the guard or on one end so that it swings a radial path. These guards can be interchangeable. There can be ridges on the guard and grooves on the bottom of the trimmer, or vice versa, to secure the guards at specific placements.

An electrical trimmer can have a platform with a slot for guard attachment on the underside of the trimmer. Said guards can slide into grooves of the slot of the platform. This platform can be moved up or down by a lever or by pushing it forward/backward on a track. Some of said guards can be at a slant angle to give a fade.

A sherbert or an icecream can have deposits of sour sugar, like what would be found on the outside of a sour gummy candy. These deposits can be spread out within the sherbert or ice cream like chocolate is spread throughout ice-cream cartoons. A popsicle can also have said sour sugar deposits or a sour sugar coating.

A one-wheel transportation device can have one or more wheels or rotating tracks on either end of the board so that instead of nose diving or scrapping the trail it can roll out of it.

A mask that has eye holes to see out off, and has an exterior that resembles a dinosaur can also have feathers, real or artificial, that are attached to the surface of the mask. When a button is pressed or when the jaw is moved, these feathers can stand up, lay down, or go to positions in between. This is done electronically with battery power inside the mask. Where the feathers attach can be rotated by the electric module.

A drone can have a microphone on or near the camera. This microphone can be set up with a noise canceling feature. Just like how air pods can noise cancel the sound of wind when on a call, this drone microphone can cancel the sound of the propellers and wind. The general sound of the propellers can be inverted to cancel its noise.

A floatation device for an underwater camera can include a peelable sticky layer, a base layer of foam, and a protruding piece of foam that is easy to bite so that it can be a mouth mount.

For an automated voice, settings can be made to select tone. This can allow the software system to change the tone of the voice and choice of words. Tone option examples can include, happy, excited, confused, angry, passive aggressive, and more. This can be great for navigation, or asking questions to a voice responding interface like Siri.

A drone can have a glove/hand remote that can have sensors that can allow the user to point in a direction so that the drone can either turn to face that direction or the camera can face that direction. A headset that has sensors can allow the user to face in a direction so that the drone can either turn to face that direction or the camera can face that direction. Said glove/hand remote and said headset can be used at the same time when flying a drone, where one or the other controls the camera direction and the other controls the drone position.

A car/vehicle seat is usually made up of three sections. The bottom seat, backrest, and headrest. A massage mechanism can be built into any of these sections to massage the user as they drive. A neck massaging device can be attached to or below the headrest, or built into the head rest to protrude and massage the user's neck. A car/vehicle seat can be made up of four sections where the backrest section is divided into two sections. This allows these two sections to be at different angles and adjustable to rotate into different positions for the user's comfort. Said backrest section can be divided into three, four or more sections that have angle adjustment for the user's comfort. And these divided sections have massage mechanisms built in.

An airplane can have passenger seats that face backwards so that it will be safer in a crash and will reduce neck whiplash. A plane seat can have massage mechanisms built into the chair and have foot massages built into the floor or portable passenger use.

A dog food in a large bag can have kibble mixed with rod like treats that take longer to eat, or rod shaped kibble.

A kiteboarding bar can be made a bump on each side of the center of the bar. This bump can have cushion on its outer surface so that it doesn't injure the face. This bump allows the rider to press their thumb against it for steering leverage. A bump in the center can be used for this purpose. A raised platform or a grooved section can cross center and protrude out to both sides; an indent in center or on either side can also be used for this purpose. The indent can be shaped to be an ergonomic thumb hole and can even rotate or spin to reduce friction from a turning thumb. This thumb hole can go all the way through the bar, so that the user can fit their thumb through this hole for steering control. The inside surface of the thumb hole can spin circular infinite times.

An electronic register tablet, device, software or app can allow the owner to set up 4 or more percentage sizes of tip amounts.

A martial arts choke strengthening device can be made with two or more platforms and one or more large springs. Each of the platforms can have a squishy exterior and can resemble a part of the body that is being choked. The springs connect the platforms together and when the user squeezes these platforms the springs fight against it and he gets a workout. This device can have four platforms, one long piece, and three smaller pieces that arc over it. This can be seen as an upper body workout for the forearm, bicep, shoulder, chest and back, as well as martial arts equipment. A squishy pad or mat can be the texture of the exterior and can have ergonomic curves, even of a person being choked and ergonomics for the arm and chest of the squeezer.

A chest exercise is the repetitive squeezing motions of a product that has two platforms and a spring hinge between them. This spring hinge area can be made with one or more springs for the user to work against. The user can press their hands together or elbows and forearms on the platforms to get a great chest muscle burn.

### Randos

A cutting board can be with ergonomic grooves for a fish to fit into so it can be secured for cutting. This makes fileting it easier because it straightens the spin.

Social media apps have face scanning software that detects your facial movements as actions in a game. For example, there are games where when you blink it detects it and uses it as a way to stop a moving piece and the goal is to stop it at a specific time so that it lines up properly. This is the challenge of the game. My idea is similar, but it can also be done with the motion of the mouth, eyebrows, nostrils or tongue. Either when the mouth is opened or shut this can record the timing of the action. The raising or bringing down of the eyebrows can be used as the action for the software to recognize the command. The same can be done with the flaring of the nostrils. The movement of the lips, tongue, eyeballs, nostrils and eyebrows can be used in the action of a game. These can be used to move an object that has the goal of avoiding obstacles in its course, and these obstacles can be moving forward with new obstacles appearing. And one type of game can have the main object jump upwards as an action is recognized and without an action the object falls. The movement of these body parts can be recognized as the action of a command. Another type of game can have the main object follow the path of the motion of these actions as a way to avoid the upcoming obstacles that can be constantly incoming until the game is lost by the main object hitting an obstacle. The movement of the tongue/eyes/eyebrows can also be used to draw, as its moves its course can make a path on the screen. The raising of the eyebrows can cause the camera to zoom in. The more times the eyebrows are raised the more it zooms in. If the eyebrows are brought down like a scowl or frown, the camera can zoom out. In a game with incoming obstacles the raising of the eyebrows (or smile) can cause the main object to move up and the lowering of the eyebrows (or frown) can cause the main object to move down. This can be done so that the obstacles can be avoided and once an obstacle is hit the game is over. If one eyebrow is raised the main object can move to the one side and if the other eyebrow is raised the main object can move to the other side (same with a crooked smile), the same can be for the winking or squinting of the eyes, or the moving of the mouth, lips or tongue. Another game could have a ball or object that bounces of one or more surfaces that is the edge of the screen the user's tongue, nose, eyes, lips or mouth (or head position) can reflect the moving object. (The respective tilting of the head can cause movement of the platform object that the moving object bounces off.) If the user misses the moving object and hits the opposite screen edge than the game is lost. As the game continues the speed of the moving object can increase, and the said games can have speed settings. In the previous said games a graphic can appear over the nose or previously mentioned body part. This graphic can acts an object for the games moving object to bounce off of When drawing with the nose the nose adds a black or colored path to the screen instead of taking away color from the screen.

A social media app that has face altering filters can have a filter within a filter with a filter. So that when you select a filter you get specification options within that filter and from that selection there are more specification options that the user can choose from. A filter within a filter can have the selection options of different animals. So that the user can select this filter and from that selection the user can choose between multiple filters that alter the face of that user to look like different animals.

A balloon can be made of a rubber, latex or neoprene were the balloon stretches and expands as it is blown up and is made in shapes where there are multiple branches and prostitution. This allows for a more complex and even intricate design. For example it could look like a star fish or a T or X like shape. The shapes can also have multiple tubes that interconnect and create loops.

A cookie with filling in between two flat layers of cookie, possibly round, could have a perforated lines that make up a shape. The point of this is to carefully break the cookie along these lines so that it makes the shape perfectly.

A car can be made with a grill that lights up the name of a word with 4, 5, 6, 7, 8, 9, 10, 11,or more letters.

A container for a gum, breathe mints or candy can have an ability to launch the candy into the air. This can be done with a track and a spring and a lever to pull back the surface the item is launched from. The platform stops at the end of the track and the item is then airborne. Another way is with an arm of a mini catapult. The arm can be attached to the top or bottom of the box. The arm can be pulled back past a bar that can stop the motion of the arm to give the item the proper projections. The end of an arm has a dish where the item can be loaded then can be pulled down lower and let and let go to launch it.

A vape pen could have a cooling system built in or attached to the end that cools down the smoke before it enters the mouth and respiratory system. This cooling agent can be powered with the battery of the vaping device.

A vape pen can have a chamber for water or another solution to act as a coolant and filter for the smoke. This section can be unscrewed or have a drain and valve so that the water can be easily replaced to clean it. Or it can have an electronic coolant system. That uses battery power to cool the smoke before it goes into the user's mouth.

Round wafer cookies where the top and bottom are wafer layers and the middle has a crème or fruit flavored filling.

A respiratory mask to protect people from viruses like covid where the mask doesn't have straps that go around your ears instead it uses an adhesive to stick to the user's face.

A Halloween mask made of flexible rubber or plastic outer layer can be made with a head strap or face mask on the inside of the mask to secure the face to the front of the mask. Foam pads can cushion the mask and face of the user. The masks outer layer covers the back of the head, so the inside head straps are not externally visible.

A flexible plastic or rubber Halloween mask can be made with eyes that can be seen through by the wearer as glasses or goggles. The outside of the mask near the eye can fit flush with the surface of the lens. This will make a realistic mask and one that is comfortable. The glasses can be strapped to the user like googles for a secure fit. It can also be fitted with a strap or laced back, where it can be tightened and tied.

A hat can be made with a downward curve towards the back of the head to give best fit.

A compact waterproof camera can have a float that attaches to the waterproof casing by means of an adhesive or ergonomic shape and has an opening so that the functional buttons of the cameras can be used.

A hydrofoil attached to a board for riding can be made with a propeller and said propeller that can fold back to have less resistance when riding a wave. When the propeller is powered, the centrifugal force opens up the propeller again. Said propeller can be powered by an electric motor which is located in the body of the board. A propeller designs for said hydrofoil device can have counter rotating propellers. This means that there are two or more propellers that are powered by the motor that spin in opposite directions. Said propellers can have outlined shape that intersect through another blades outlined shape. In order to power both counter rotational propellers, two powered rotational shafts can be used which are both powered by the electric motor in the body of the board. One of rotational shafts can be inside of the other and these two shafts rotate in opposite directions and power the propellers respectively.

A hydrofoil can attach to a board by means of a flexible bar and rotatable ball or cylinder. Where the two pieces can snap together.

A slackline webbing that is wider than 2.0″. This makes it easier to walk on, could range from 2.0″-6″. This also makes the line stronger. A two inch wide slack line webbing can be can be 0.125″-0.025″ thick.

A honey stick can be made with a diameter wider than 0.5 cm. A diameter of 1 cm-2 cm would be better because it would hold more honey. The container of the honey tube could be edible and could be made of a wafer like material.

A wave pool can have a cushion padded bottom for safety. The cushion could have a foam core with a plastic or rubber exterior.

A joint or blunt can have two or three filters. One can be rolled up thick paper and the others can be foam, filter, or paper. Extra filters can make the smoke more pleasant or the user, especially when near the end of the joint or blunt.

A surfboard wax remover can be shaped like a mini hoe, that is like the farming tool. It can have a removable or permanent razor blade and can have a plastic or wooden handle. The edge of a wax remover can be concave to better scrap from a curved surface.

A razor blade can be made for handheld use by having a plastic grip on top.

A min-cigar with a mouthpiece can have a foam filter in and before the passage way.

A paint brush can have an interchangeable junction between the brush and the handle; with ball-and-socket like connection or buckle clip. Said ball-and-socket like connection could be a ball snapping into a cylindrical tube, where two spaced ridges form the ball containment area, that is pushed in to snap into the connection between the brush and handle. The junction could also be made with a screw and thread connection.

A soft candy tube covered in sour sugar can have a liquid/squishy/gel-like substance inserted into the candy tube. Said candy tube can be squishy or hard and have a sealed end so that the liquid inserted doesn't run out and spill.

A candy cane can have a chewy core or a liquid core.

Laptop that has directional controls (four cardinal directions; up, down, left, right) on a keyboard above the shift/zxcvbnm row. The best row for these directional buttons is the 1234567890 row, or above this row.

A suction device made to suck the venom out of a snake bite. It could be battery powered so that it could be a small portable device, to carry while hiking.

A massage gun that has two or more motorized movement joints. This can give a vibration and a pulsation at different tempos. One control on the massage gun can control the amount of vibration, and another control part can control the pulsation. The pulsation can have its range controlled so that it distance of pulsation can be shortened or increased.

A massage gun could have a more complex tempo control system where it can change its motion into specific tempos. These tempos can be designed to relieve muscles of different densities.

A massage gun can have a mechanically motorized motion in addition to its main movement. This can make the tip spin like a drill as is massages or make the tip vibrate.

A massage gun can have a mount that rolls along the surface like a paint roller supported on one or two ends, or from the middle so it remains strong during it vibration and movements. A mount can have two rolling parts with a space between them. The space is for the spine and the mounts massage the muscles along both sides of the spine. Said mount that rolls can have an irregular shape or tread to better massage deep tissue. Said irregular shape could have a rolling hill shape along the outer surface.

A massage gun can have a percussion tip that has two points of contact where the tip surface is of foam. A percussion tip can have three or more points of contact for massaging the body. A percussion tip with two or more points of contact can have a rotational part where the rotational part can increase or decrease the distance between the percussion tips point of contact. Said rotational point can be set in place and adjusted when a ball against a spring is pushed in then when rotated into proper stop the ball can lock into a slot to secure it.

A massage gun can have an oval shaped motorized movement mechanism. This can work well with the rolling mount. Said oval motorized movement allows the pulsation to be combined with a perpendicular oscillating movement.

A blender can have two, three, four and even five mechanically rotating props where electricity motorizes these spinning knives to cut to ingredients. With multiple spinning props, they would spin the ingredients into each other's blades. Each prop could have blades at various heights on the prop.

Yoga ball with indent for ergonomic seat on top. The divot for the seat can resist the outward pressure of air by having a string or material connection to the opposite surface of the ball. This can also be used to made the bottom surface of the ball more flat, thus stable.

Lined paper for writing could be made where the space between the lines is a quarter inch or less, or half a centimeter or less, or 3/16 of an inch or less.

A public or private media platform with post of videos, photos, music, and articles; where the view can choose how you want your suggested content to be organized. The two main settings could be, relevant to current topic and diverse topic options.

An arcade game where there is a steering wheel to drive a vehicle and a handheld gun where the user points at the screen to shoot. The same can be for a video game where a gun remote can be used with another remote for the car steering. The other remote can be a steering wheel remote where it can have a stand, to rest on so it can be controlled with one hand. Said steering wheel remote can rotate on said stand and even unwind as a car does when driving out of a corner. Said steering wheel remote and gun remote can both be wireless.

Steering wheel on pedal kayak.

A textbook for a school course can be made with reflective/shine text and illustrations. This text can emphasize words or images.

For education purposes a game could be made that reflects the real changes in the stock market through history.

A phone charger can be made without a flexible wire part. It can have a rotatable joint between the two ridge structures supporting the attachments or be one compact rigid structure.

Image can cover background of album song list on a music playing app. This means as you are scrolling through the songs of an album behind the text of the song names is an images or images or even a video/gif.

Camera smaller than 3.5 inches wide can have a removable protective case, where the cameras lens can protrude outward for focus, or another effect.

A protection device that emits an immense sound that could have multiple frequencies to deter harmful animals.

Attachable or built-in spinners for skateboard wheels. These spinners would be just like the spinners on cars and are placed between the skateboard wheel and the bolt that keeps the wheel on the truck.

Gloves made from hemp cloth. Three and/or four-barrel shotgun design. A musical album cover can be a Gif rather than just a still picture and a music playing device/app can loop the gif.

Vibrator that has an ergonomic shape that cups the clit in a half pipe-ish type of way.

To increase the efficiency of ice by increasing its surface area, ice can be made perforated cut, where the inside is cut from the outside. This is efficient when storing, then once in use the ice center and shell separate creating increased surface area for cooling.

A device can be made to pop pimples by pressing a circular part around the circumference of the pimple. The diameter can be controlled.

To avoid ice burns an ice pack could be made with a softer fabric like outer layer, or a softer out layer sleeve that is made to be put on over ice packs to avoid ice burns.

Public or government land that can be rented by a company or private ownership to make money off of the land in their percentage of profit goes to local government. The company cannot make money directly from the nature of the land but only the product or service they provide. Customer complaints goes to the government as well as the company.

To camouflage in low light even when someone has night vision goggles would be to have a suit that emits UV light. Since UV light is invisible to the human eye it will made the person look invisible to the night vision goggles.

To prevent mold from growing on a surface a paint can be made with a mold and moss killing ingredient.

To make toasters more efficient a lid can move over the top of the toast to seal in the heat.

A toy set can be made that comes with one or more motors and lets the user of the build stuff with the motor. The set could come with gears, wheels, propellers, frames, equipment to make frames, and batteries. This toy well help kids to learn how things work.

To make video games more user friendly to beginner players the speed and acceleration of the view turning controls can be adjustable.

Some kiteboarding kites come with an extra set of bridles that tune the kite for a specific style of kiteboarding. To make your kite switch settings the kite must be landed, and the lines need to be reconnected to new bridal pair. My innovation is a kiteboarding bar with six lines. The lines are attached to all the bridles. To engage one bridal pair over another the lines of the engaged bridal pair can be more taught then the unengaged pair. To do this the line the pairs of line can be adjusted in length relative to each other.

To make it easier to attach a kiteboarding bar to the slider bar an intermediate device can be made that has a carabineer like opening that can easily attach to slider bar by having the slider rope being placed inside the apparatus. Said apparatus can have a rotating part that reduces friction on the slider bar.

To make it easier to do a water start on a directional board, foil board or windsurfing board a heal groove can be made in the top deck of the board close to the rail.

To give socks a better fit they can be made with ridges for your toes to partially fit into.

To make a hat have a better fit around someone's head and not get in the way of their ears, the side profile of the hat can have the shape of a downward curve, instead of a normal circle.

A pair of glasses can be made with an edge cut that is not close to perpendicular to the main surface of the glass or lens composite to give a cool optical view when the user looks through that edge. However, this distorted view can be distracting to some users. To prevent this optical distortion from bothering a user a non-transparent material can be placed on this edge. To give the user a reference of frame the glass or lens composite around the edge/perimeter can be a different color than the middle. This perimeter to center contrast can repeat itself once, twice or many multiple times like layers on a tree.

To prevent from getting watch tans the strap, lug ends, case and crystals can be made from a clear material.

In order to make a pair of shorts, board shorts especially, have more range of motion in the legs, a strip of stretchy material can be added to that runs from the bottom of the pant leg all the way through to the top of the waist. Shorts could also have a stretchy strip that runs from one leg around the butt to the other leg with-out the interruption of a pocket zipper that does not stretch. To prevent the short fabric from getting stuck over the knee cap and limiting range of motion the front of the shorts leg ending can be shorter than the back. This can be done by having an oval shape or a split where the back is longer. This is especially necessary for board shorts meant for surfing or taking out into the water.

To make button up shirts more comfortable by increasing arm and back range of motion the item can be made from material that actually stretch instead of stiff material that is weaved in such a way that the surface area can slightly change. Said material on flannel that can stretch more than 5% of its original size. This stretchy material can be just around shoulders and back, and less stretchy material can make up the rest of the garment.

Magnetic building sticks comprised of two main parts; magnetic object and magnetic sticks. The magnetic objects can have flat edges, in many different tetrahedron shapes to induce complicated building patterns. Such as pentagonal prism, hexagonal prism, heptagonal prism, octagonal prism, dodecahedron, icosahedron, octahedron, and tetrahedron. The magnetic sticks where magnets are on either end can be over an or 1.5″ or 2″ or even 5″ this enables the builder to create bigger structures. Windows with magnetic/metal edges/perimeter can be included in building set.

To make a pair of pants that are made mostly of a material that is not very stretchy, like jeans, a strip of stretchy material can be added along the leg of the pants. The same can be done along the arm of a shirt and along the torso of the shirt as well. A pair of pants can have this stretchy strip without the interference of a pocket zipper that is not stretchy. Said stretchy strip on pants can go from the outside of one leg, around the butt and down the outside of the other leg without interference of a zipper.

A button up shirt or a shirt with collar buttons can have synchs at the end of the wrist that keep constant pressure with the wrist so that it keeps the sleeve in proper position.

To make flip flops stay on the wearer's feet better the strap and piece that connects the strap to sole can be stretchy.

To make shirts, or jackets have a better range of motion for the arms. An area around the arm hole can be made of a stretcher material. This material can go all the way around the arm hole or just part way.

A hat can be made from one piece of uncut fabric, not including the brim. It can get its shape from a heat mold.

To prevent a puffy jacket from making nose when the arm is rubbed against the body the outside fabric of the puffy jacket can be made of silk or a fluffy or furry material.

To prevent the sleeve of a short sleeve shirt from bunching up on the arm when the bicep is contracted, the sleeve can have a shorter front side that goes over the bicep than the back side that goes over the triceps. These two different lengths can be connected by a curve or a cut slit.

To enhance the shape of a persons legs a diamond shape can be put on a pair of shorts or jeans wear the widest point of the diamond is close to the widest point on the persons thigh. A diamond shape can be put on a pair of jeans wear the widest point of the diamond is near the widest point of the persons calf, or knee. To enhance the shape of a persons arms a shape can be made on a shirt, or jacket wear the relatively widest point of the shape is near the widest point of the wear's shoulder, bicep, and/or forearm. To enhance the shape of a person's lower body curves a shape can be made on a pants or shorts wear the relatively widest point of the shape is near the widest point of the wear's hips, thigh, and/or calf.

To help a sweatshirts arm range of motion the arm hole can be made extra-large. To prevent a jackets sleeve from twisting unnecessarily a wrist synch can be made to keep constant pressure around wrist. To make a jackets hood and neck more adjustable a lace system can be made below the hood and said lace can go around edge of hood for hood size adjustment. To prevent a hood blocking the wearers field of view, especially when the wearer turns their head, a hood can be made where the middle edge of the hood, the part near the persons face, is tapered back more. To increase the comfort in a sock the fabric on the heal, ball and toes can be made thicker than the rest.

To make shoes last longer for people that skateboard in them a layer of rubber or plastic or an additional layer of fabric can cover the top surface of the shoe entirely over what is normally cloth.

Candy coating on ice-cream where said coating is ‘hard’ or isn't melted easily unlike a chocolate coating. This coating can be made from mostly sugar and corn starch.

A breakfast cereal can be made with an artificially brightly colored cereal with white frosting or chocolate icing that is partially or fulling covering the cereal.

Chocolate, Caramel, chocolate coating of ice cream that is attached to an ice-cream cone.

Ice cream carton with complete/mostly complete layer midway through the carton where there is ice cream on either side of the layer. Said layer can be made of chocolate, caramel, toffee, cookie dough, or brownie. Said layer is a horizontal plane of non-ice cream ingredient/s.

Malt ball with liquid caramel or liquid chocolate center. A candy treat can be made where inside the candy is a dry sugary and flavorful deposit. Chocolate covered coffee bits mixed into ice-cream. Mochi bits spread and mixed into an ice cream in a cartoon.

Seams on wetsuits are the first to break and let water in. A long lasting wetsuit can be made with minimal seam lines less than 20. Said wetsuit can have knee pad attached over wetsuit material to reduce seams. Said wetsuit can have only one line of stitching on each shoulder and arm. Said wetsuit can only have one line of stitching on each side of the torso, and butt. Said wetsuit can have only two or less lines of stitching on each leg. A wetsuit can have heat molded parts to eliminate the need for a seam.

To prevent water from entering wetsuit booties, gloves, or hood the ending open to water such as ankle, calf, wrist, or face openings respective can have a coating of plastic or rubber material that that covers the very ending of items material around the opening.

To convenience smart phone users, when a navigation and music app are both running at the same time they can both be showed on the same lock screen. This gives the user the ability to see the map and control music at the same time. A music app can give the user the control of what time in the song the music plays from the lock screen. This can be done by finger dragging or tapping on the time bar of the song.

A smart phone can be able to self-clear its tabs. This can be done after a certain number of hours the app hasn't been used and this can be set in settings.

A smart phone with a touchscreen that can elongate and contract, the touchscreen is able to stretch, or another screen can slide out from under the first.

To make zip ties reusable the track that has teeth can have a track with no opposing teeth or a side/both sides that has no boarder so that the catcher can move out of the path of the teeth and can be placed back up at a different position.

To make an artificial reef make a well forming break the front part of the reef can have the shape similar to the function: Y=square root of X. To make an artificial reef good for aerial maneuvers and barrels the reef can have a ‘U’ shape to it as opposite to the common linear left and right break ‘V’ shape.

An artificial reef can be created using a tilt slap construction. The slabs can be made from concrete. This will limit the amount of necessary material to make a shallow reef.

An artificial reef can be made with underwater turbines attached to it to create electricity from the wave motion. These turbines are place right at or after the wave breaks to get maximum amount of energy from the wave. This artificial reef can make the wave barrel from its shallow depth to have the waves disperse maximum amount of energy at one point. These turbines can be facing the wave perpendicular or parallel to water movement.

An artificial reef can be elevated from the ocean floor by beams or pillars. Then concreate slabs can make up the bottom of the reef.

An artificial reef for improving underwater habitat can be done by dropping trees in that area. They can be weighted by being dipped in cement on one or more ends. They can be connected to a line so they can be suspended at the perfect depth, when not weighted by cement at all or enough to still float. Also, concrete rubble from demolished buildings or streets can make create habitat, and can be dumped by a split hopper barge, in linear, circular, or crossing patterns. This will create so many hiding places for fish, crabs, lobster, abalone, and more. This can be used to improve biomass of marine protected sanctuaries or any area, fresh water or marine. A crane aboard a ship, on land, or standing on the ocean floor can also set up these structures. These areas can have parking lots near them that sell pay pass, weekly or seasonal parking tickets or charge parking by the hour. Resorts can be near these areas that charge users to stay for access to these reefs for the appeal of surfing, diving or fishing. Real estate houses and apartments can be made near the reefs to increase housing costs or the reef can be made in front of already made houses and apartment/condos to drive up housing prices.

A wave pool can have a gutter on one or more sides of the pool to help minimize rebound swell that messes up the new waves.

A wall can be placed in a wave pool or in the ocean for the purpose of redirecting wave energy to form a more powerful wave for surfing.

An artificial surf reef with rolls along its surface/multiple reef stages for different sized waves. Bigger waves would break on the first and lower reef protrusion/reef stage, and smaller waves would break on the next and shallower reef stages.

To prevent the surf leash from spinning around the surfers' ankle the leash can be made to be ergonomic around the ankle and Achilles heel. Said leash can be made with a rigid shape but can flex slightly. From the top view this ergonomic shape can look like a ‘U’ with outward curves on both ends of the ‘U’ and can then have inward curves on both ends.

A surfboard can be made with a plastic bottom that wraps up to over and around the rails. The top deck inside the rails could be a soft top. The plastic could continue around the rails and encompass the top deck as well, creating a rigid plastic exoskeleton for the surfboard. The top deck could be textured for grip.

To prevent a surf leash from tangling around kelp and to reduce its drag, it can have a recoiling device. Said recoiling device can be mounted at the tail where the leash plug would normally be. The ankle strap can be removable and interchangeable. Said recoiling device can recoil the thin surf leash by means of a spring-loaded system. This can recoil the leash to a certain length and from there the leash stays at this shorter length. It can include a frame which holds a recoiling spool with a circular spiraling spring. A part with a groove can be attached to the frame, this is for said spring to attach so one end of spring stays fixed. The spool can have said spring inside it, with the other end of said spring fixed to the spool.

Gardening gloves with grooves that fit into each other at the end of the finger to pinch off larger vegetation with your fingertips. One or both of the pinch finger can have a groove that has protruding walls on either side of groove to receive the other finger's cutting part.

Joystick lock device, where in order to unlock the device the joystick must be moved in a certain pattern. A locking device that has multiple buttons and unlocks when the buttons are pressed with the proper timing. If buttons are pressed in proper order but not with proper timing or held done for proper amount of time than the device will not unlock.

A pencil with a hexagonal shape can have a level built in it to convince builders.

A swivel hinge can be built into a cable or wire so that it can untwist itself.

A shower can have an extra feature that allows you to drain the water that has been sitting at the top of the shower. This water hasn't warmed up and is uncomfortable when it hits you before the warmed-up water has. When a lever or feature is used the sitting water can drain out of the lower spout.

One way to easily make a very good artificial reef for surfing is to have a one or two foundations. The foundation that is closer to shore is raised higher than the optional farther out foundation. A slab of material is then placed on top of the foundations to make the artificial reef bottom that effects how the wave breaks.

To make it easier to exit the ocean, instead of a cement staircase, a sloped path with/without foot holds/stairs can be made out of a soft rubber or plastic material.

A buoy can generate energy from waves by having an apparatus in the rope that turns a turbine that creates energy when a force from a wave is put on the rope can cause the apparatus to elongate. This buoy can be place right where the waves break and can made with large surface area for maximum resistance.

A zipline with two multiple attachment points along its ride allows for a curved path. This is done with two cables that have a coating of rubber or plastic and allow the line to still be flexible. Incremental attachment points encompass the cabels flush with the coating, and have a protruding body with a hole for a support line to suspend the system. A special double pulley device encompasses both coated cables so that they stay on them and don't detach when riding, but have a gap so that the incremental attachment points protruding body can pass between.

Artificial reef for creating amazing waves for surfing the barrel super constantly can be made from loose random rocks, building rubble, roads, and concrete. This creates a great habitat for fish and kelp forests. These surf breaks/marine habitats can be made by a split hopper barge dropping rubble into the ocean to create a specific depth for a wave to break. Also great way of getting CO2 out of the ocean water. A crane aboard a ship, on land, or standing on the ocean floor can also set up these reef structures. These areas can have parking lots near them that sell pay pass, weekly or seasonal parking tickets or charge parking by the hour. Resorts can be near these areas that charge users to stay for access to these reefs for the appeal of surfing, diving or fishing. Real estate houses and apartments can be made near the reefs to increase housing cost or the reef can be made in front of already made houses and apartment/condos to drive up housing prices.

A truck can have an automatic tail gate, that can reposition from a button on the car keys, truck interior or near tail gate. The button near the tail gate can be on the rear-fender near the taillights. When this button is pressed wires send a signal to enables an electric motor to lower or raise the tailgate. This movement is done by coiling/unraveling a wire or rope by means of the electric motor. The wire/rope is attached to the tail gate and travels to the interior of the truck bed or rear-fender. When the wire needs to make a corner one or more pulleys can be used to keep the wire/rope in track and reduce resistance. This tailgate feature can also be accomplished with and electronic hydraulic system. This included one or more hydraulic cylinder on either side of the tailgate, levers with rotatable joints, an electric mechanism that controls the movement of the hydraulic cylinders in both directions. Wires connect the electric mechanism to the button, when button is pressed signal is given through wires to the electric mechanism to move hydraulic cylinder which is attached to the tailgate by a pivoting part.

A car or truck can have a precisely timed hydraulic suspension, between the front and back suspension where it can create movement of a “gas, break, dip” where the front end of the car goes down first as the back rises, then the front end goes up as the back end goes down, creating a wave like motion. There could also be a side to side rocking motion. The two planes can be used together to create a circular motion, where opposite motions are rotated around all four wheels in a circular motion where the speed a height can be controlled.

Car, truck, or semi-truck with gas cap on both sides.

Vehicle without outside protruding car mirrors or censors that protrude more than three, four or five inches away from the body of the car.

Sensors can be built along or in the road to send information about the shape of the road, it's lanes, the intersection and current condition of traffic lights to the vehicles that can access this data base.

Car/truck that beeps to alert the driver that traffic has started moving.

An electric skateboard that can be accessed through an app and can be rented out to different customers through the app.

To make the skateboard deck lighter it can be made with a foam core and wrapped in fiberglass cloth or carbon fiber.

To make fish easier to take off spear guns an attachment part between the tail end of the spear shaft and the beginning of the line that attaches to the speargun can buckle, clip, screw or latchet together.

Antivenom capsules for portable use.

Straps that prevent umbrellas from inverting can connect the umbrella frame to a point on the handle.

Tape where the strip that the adhesive is attached to has an elastic and stretchy quality.

Bench press with an ergonomic surface for your back and shoulder blade motion. This ergonomic surface can be a divot for the shoulder blades to rotate back into.

To make an intersection more efficient the two intersecting roads can be made at different heights. One can be made slightly above ground level and the other can be slightly below natural ground level. This prevents the roads intersecting. On the lower road the left turn can go below the other sides traffic. To lower the costs of a highway exit ramp that turns left over the other side of the highway, this exit ramp can emerge from the left most lane.

To increase the fuel efficiency by aerodynamics a trucks tail gate can fold inward.

When a trucks tail gate is folded down, it can be slid inward into the bed of the truck so it does not protrude so much.

A door handle that is flush with the outside surface of the car can be opened when the handle is pushed inward, or when the handle is pushed inward, and a lever is pulled.

To convince drivers of the same car, mirror positions can be saved and automatically changed.

A gas cap can have a lock on it so that you can place your keys in it. A car can have a hidden capsule built int the grill, bumper, undercarriage, or wheels of a car. Said capsule can have a lock. Buttons can be placed on a car mirror or inward facing side of door handle that can unlock the car.

An outside car/truck mirror can be flat on the side closest to the vehicle and then curved on the side farther from the vehicle. This is done to show the vehicle's blind spot as objects pass through the blind spot. Two or more separate mirrors on a vehicles side mirror, can be placed in a horizontal arrangement, where they do not overlap.

A double layered dial system can be made to compact the controls in a vehicle or on anything. It can consist of an outer dial that can be spun either direction, and an inner dial that can be spun either direction. The inner dial can be raised from the outer dial so that it can be easily controlled. The outer dial can control fan speed of air conditioning, or radio channel. The inner dial can control the temperature of air conditioning, or volume. These controls can be vice versa.

### Combo 8

Keys and/or phone case made to specialty fit together. Phone case that can fit a variety of keys.

A face to face live stream recording/video chat on a smart phone where when a user leaves the app the video of them continues to play. In said video chat when a user leaves the app a small sized screen can appear so that the user that left the chat can see the other person/s that they are video chatting and still see whatever else they are looking at one their phone. Said small sized screen can be movable.

Ice Cream with chocolate pieces, where the chocolate pieces have solid or liquid mint filling.

Hole in wetsuit hood or hat for a ponytail to fit through. A drawstring can be built in around the hole to make a good watertight seal.

Mochi balls or pieces in an ice cream container, or on an ice cream stick or bar.

A face filter where randomly picks a filter that it alters the viewing of your face but does not grotesquely distort your face into the facial structure of an animal.

Water-proof wireless headphones with downward protruding piece from the ear.

To unsend messages the following process could be used: hold finger on message that you want to delete, the option More . . . comes up, select more . . . , click the trashcan icon, the option delete message and unsend appear, select unsend.

Canteen with built in rubber rim at the bottom to prevent dents and to help it stand.

Balls of hard small pebble sized candy covering a squishy candy core.

Truck bed where it is wider towards the rear of the truck bed than farther up towards the front of the truck bed. The front is closer towards the passengers.

To make a projector screen easy to use, what is being projected can be outlined by light on the original copy. This will help prevent the user from having the content unable to be seen by the viewers.

A water park could have as series of rope swings that lead from one to the next. In order to keep up momentum the rope swing can be “loaded” by having it pulls back and up. When the user jumps onto the rope the mechanism that holds the rope up can be released from the weight of the user. This mechanism can be a flimsy piece or a rotational device that releases at a certain force.

A water park that has a slide where it is steeper than 45 degrees and has a jump that shoots the customer up into the air at a mostly vertical trajectory with the exit ramp angle over 50 degrees.

A chocolate wafer bar can be with soft or brittle caramel/toffee between the wafer and the chocolate.

Soft toffee in a chocolate candy bar. Brittle toffee/caramel in a chocolate, peanut, and fluffy filing candy bar. A candy bar with both hard and soft toffee/caramel.

A chewy fruity candy with a sweet liquid core and a hard candy coating. A chewy fruity candy with a sweet liquid core and a sour/sweet coating.

A box shaped fruity chewy candy can have a liquid filled core and/or a sweet/sour coating.

A safety mechanism on a firearm can be located above the trigger.

A video on social media that is over a minute long. Where it can continuously play for over 15 seconds, without going to different window/or having to make it full screen/the only thing on the screen.

Images/designs of objects or people that the user can create themselves that can be typed harmoniously onto a line of text.

A car or truck can be made with five or more letter built into that grill that are able to be luminated for visual effect.

A drill bit can made magnetic so that a screw head is attracted to it so that it can be easily drilled into place. Said magnetic drill bit can be made with no moving parts.

A packaged ice cream bar can be made with one or more flat layers of brownie.

A smart phone can be made with two, three, four, five, six or seven cameras on the screen side of the phone.

On a social media post that is not a permanent post, gets removed after about 24 hours, can be edited once post is posted. Such features that can be edited in said post are caption, filter, video length, date, time, location and/or accounts tagged.

A social media post can be edited so that the photo or video can have editing done to the image quality, such as brightness, saturation, contrast, cropping and more.

A social media post that is posted for a limited amount of time can be shared for a limited time by another user.

A social media platform can have a section where posts from accounts that the user is not following show up. Said section can have two, three, four or five vertical columns. At the top of said section can be a series of posts where it is given the width of all the columns. On said series of posts with a wider width a mute icon can be available as well as a time bar so the user my fast forward.

On a permanent social media post containing multiple images, where said social media does not have the ability to have other people/accounts write on your homepage of your account, said post can be edited to have more or less images on the post, as well as the order of the posts can be rearranged.

A body pillow made with a space for a partner's arm to go under the waist area of the user. This supports the user and minimizes or resolves weight from the partner's arm.

Work out bands can be made with symmetrical lines on either side so that the user is able to more easily tell if it is symmetrical.

A truck bed can have lights built into it so the user can see what's in the truck bed at night.

A truck can have a tail gate that folds out in multiple steps so that it is easier to load items.

A phone case can be made to house a phone that contains five, six, seven or more rear cameras. Said phone case can have opening so that it does not block any of these cameras.

A phone can have two or more cameras on each side of the phone across the vertical axis of symmetry.

A phone can have a camera on each side of the longitudinal axis. Phone case made with magnets to better help the phone wirelessly charge. Four rear cameras on a phone arranged in a square formation.

A phone can have four rear cameras arranged in a square where the flash mechanism is in the middle.

A phone can have a camera that can protrude outward. This can be helpful when zooming in and out.

A phone can have multiple cameras where the external ring of the camera has a diameter bigger than 1.0 centimeters.

A phone can have four cameras in a square pattern with a light sensor or another camera in the middle of the square.

A trail camera can be made with a with its external surface being that of a 3-D model of tree including its bark and a shaped surface of a branch, burl, or thick bark. Another disguise could be moss, lichen or best yet fungi. It would attach to the tree by small spikes, screws, or nails. And would have claim a concave back surface and front surface shape that can flex to fit smaller or larger diameters.

Speakers in the shape of fungi that could be nailed into trees, and luminate.

A text able illustration of a simplistically graphic designed image representing a face expressing a specific emotion, or person doing an action, or an object, (emoji), can be made into a looping video, (gif). This can also be done with an ‘emoji’ that has a customizable design. Said looping video can be paused when tapped on.

‘An emoji’ can be made of someone from a face scan. The software can take the image of someone's face and simplify it into a cartoonish version of themselves. The user can then use this new image of themselves to send to other people. This self-emoji can then be altered into expressing different emotions and can be used to add context to their text messages.

To get more people to vote in a government election it must become more convenient. An app or website that lets people vote from the convenience of where they are will increase voting numbers.

When typing a paper, you can type your way down to the bottom of the page and the writing program keeps what you are writing at the bottom of the page. However, it is uncomfortable to have to look at the very bottom of your screen to see what you are writing. A writing program could be made where it keeps what you are writing at an adjustable place on the screen.

To organize the feed of a social media app, people/pages can be grouped. The feed that these groups produce can be view separately from the rest of the people/pages you follow. The accounts the user is following can be organized into separate files by the user to do this.

A soft top surfboard can have a single fin set up, where it has a single fin box that is able to accept a longboard fin.

A slinge prong sling can have one or more barbs that are not rotatable, or can have rotatable barbs that are smaller than 1.6″, 1.5″ or 1″.

When on the telephone and you are put on hold there can be a sound that goes off that alerts you that you are no longer on hold. This way you do not have to keep your ear to the phone the whole time you are on hold. Said sound can be an alarm that can repeat several times.

A navigational app or website that gives directions within a building and to a specific room; where stories or floors are accounted for and mapped out. A line can show the user how to navigate hallways and rooms. An icon shows stairs and elevators and tell the user what level to go to.

A navigational app or website can show multiple road lanes that are side by side to each other that have traffic flowing in the same direction. The path the app shows for the user to follow can show lane changes between these parallel lanes. This is very important for big city navigation. In a navigational app or website, it can show graphics of the traffic lines such as solid white, dashed white, double yellow, single yellow and dashed yellow as they are on the real road.

A music playing app, could allow the user to save versions of original songs that the user can personally edit. By using controls such as trim, cut section, and conjoin two or more songs to each other.

A music playing app could arrange the songs of an artist's album by the amount of plays that song gets. The amount of plays each of the songs get and the total for the album could be viewed from the apps display of the album. An album can be queued so that after the current song is finished the album can get played. When a song from an album gets queued the rest of the album can get ordered to play next. If you click the name of feature on a song or album it can take you to their music page.

A hat with a front fabric section and a brim that has a flat section and a curved section on either end. This curved section allows for the blocking of sun rays, but the flat section allows for a comfortable fit. The front fabric section, which is all fabric panels that cover the front half of the hat, can have fabric pannel/s that align with the flat then curve of the brim.

To convenience users a tab can be made of a phones voice interaction history. Said phones voice interaction history is like that of Siri. A back arrow can be pressed multiple times so that the user can go back and look at what was asked and how the computing system responded multiple times ago.

A touchscreen device can have a series of surface swipe touch patterns when a video or audio is being played. The following touchscreen controls can control the videos on social media apps and the audio on music playing apps. The touchscreen can have the user hold their finger on it. Area where the finger is first contacted with the touch screen acts as a reference point for the following swipe patterns. As the finger is slid, incremental sections upward correspond to the increasing video playing speed or the amount of timeline distance the video is skipped or played forwards. The incremental sections downward correspond to decreasing of video playing speed or the amount of timeline distance the video is skipped or played backwards. The horizontal swipe pattern can correspond to an increase or decrease in video playing speed based upon if the finger is slid to the right or left. The horizontal swipe pattern can also correspond to a forward or reverse skipping or playing of the video based upon if the finger is slid to the right or left. If the swipe pattern has a slope the two options for the horizontal swipe pattern can be combined with the vertical swipe pattern. For the purpose of these next examples of swipe patterns with slopes, the horizontal swipe pattern will correspond to skipping or playing video forward when moved to the right, and reversing video when moved to the left. The vertical swipe pattern will correspond to increasing video speed when swiped up and decreasing video speed when swiping down. The swipe pattern with a positive slope will increase the video speed and skip forward when moved upward at its angle. When it is moved at its downward angle it will decrease video speed and reverse the video. The swipe pattern with a negative slope will decrease video speed and play video forwards as it is swiped to the right at its downward angle. When it is moved to the left at its angle the video will play at an increased speed in reverse.

Settings can be made for voice recognition services that give different responses. For example, a setting could be southern, and it would use “Y′ all” in its basic vocabulary. Another example could be happy/angry where it can complement/insulate, and the tone of the voice can be changed. This would be based upon what the user says to the

To easily edit the speed of a video on a touch screen device a program can be made so that when you hold one area of the screen it fast forwards and when you hold another area of the screen it reverses. Without a menu bar the users finger can be along the screen of the video and as the finger slides one direction the video can either speed up or slow down at a rate based about the speed and or acceleration of the finger slide. One the finger is released from the screen the video can play.

The host of a hot spot can have the control to view and disconnect devices from the convenience of their hot spot controls. A hot spot off and on control can be automatically be turned of when a device disconnects from it. A phone can automatically connect to a hotspot that they have previously connected to at least once before.

An unfamiliar word can be saved after its first use by the user. And this new word can be suggested before it is fully spelled by the user.

Flap on a phone or phone case can flip down and out of the way when the charger is inserted and flips back up to protect the port when not charging. This charger port protection can be put on any type of port such as one that is on a computer, camera.

To make a camera take a better picture of a view it can distort the image to make what is farther away look bigger. This can be done by having the camera be able to differentiate the fore ground from the back ground and then enlarge the background relative to the fore ground.

Wireless headphones where the user can control the volume of their music from the headphone by use of a dial, switch, surface tap or surface swipe motion. A tap on one ear bud could mean volume up and a tap on the other ear bud could mean volume down. A downward swipe could mean volume down and an upward swipe be volume up. A single tap could mean pause song and a double tap be skip song. A swipe up or down on one ear piece could mean volume change and, on the other ear piece, could be skip or rewind song.

To prevent the breaking of a phone charging cable the neck coating can be flush or close to flush with the body coating. To make headphones less inclined to fall off when wearing them they could have one or more gentle suction cups that attach to the ear. Wireless headphones can be set to be used by only specific phones. This can be done with the use of a phone app.

On a limited-time-post that wasn't recorded live there can be an option to like the post. An icon on screen when viewing the post can be selected by a user to “like” the post. This icon can be in the shape of a heart and when pressed the heart can be filled. Said limited-time post can be called a story and can appear for 24 hours. The stories can be located at the top of the app layout.

To improve television, smart phones, computers, chargers, phone cases, headphones, social media apps, or other sites several innovations can be made:
1. To convenience television users a television and a television remote could be made with:
   a. A symbol that shows up if the channel is on commercials.
   b. A button could also be added to the remote that takes you back to the channel once it is off commercial.
   c. A TV remote could have the alphabet as primary buttons. A touch screen TV remote that has the alphabet keyboard available on the touch screen.
2. An app or website that lets people vote in government elections.
3. A writing program that automatically keeps where you are writing at in the same spot on the screen, and this spot can be adjustable.

A social media app made to have:
a. A post where you could click, tap or double tap a portion of a post to like or comment on that portion.
b. A social media app or website can have two like buttons for the same post.
c. Social media app where users can individually like a posts caption, song or location.
d. A multi-finger tap and/or triple finger tap can be used as a command or to bring up options.
e. A tap on a certain area of a post can have a specific function that can be different than that same type of tap on a different area.
f. A triple tap on post or multi-finger tap can pause a post's video, or the pause icon could be located on or near the post.

On a limited-time-post that wasn't recorded live there can be an option to like the post.
h. To organize the feed of a social media app, people/pages can be grouped. The feed that these groups produce can be view separately from the rest of the people/pages you follow.
i. Extra information posted on a social media site can come at a financial expense.
j. On a limited time post of a shared video, the video could be played on limited time post automatically or when the play icon is selected.
k. On a social media live post, the screen can be double tapped to like the post and an option can be made that hides comments.
l. There could be a setting on a social media app or website where any language automatically translates to your set language.
m. To accurately control the where a video can be played from a bar can be dragged around a stationary, or slower moving point. By changing relation between the bar and point changes where the video will play from.

To have a music app work more conveniently with a phone:
a. A phone or app could allow music controls such as play, skip song, restart song, volume and go back to last song, available on the lock screen for as long as the music app is not cleared, or interrupted by another app that uses lock screen.
b. A phone or app/s can allow the lock screen of a phone to be shared by multiple apps.
c. To convenience phone users if a navigation and music app are both running at the same time, they can be showed on the same lock screen. This gives the user the ability to see the map and control music at the same time.

To better organize, a music app can:
a. A music playing app, could allow the user to save versions of original songs that the user can personally edit. By using controls such as trim, cut section, and conjoin two or more songs to each other.
b. A music playing app could arrange the songs of an artist's album by the amount of plays that song gets. The amount of plays each of the songs get and the total for the album could be viewed from the apps display of the album.
c. An album can be queued so that after the current song is finished the album can get played. When a song from an album gets queued the rest of the album can get shuffled to play next.
d. If you click the name of feature on a song or album it can take you to their music page.

### DESCRIPTION OF DRAWINGS

FIG. 1 shows the glasses with magnetic attachment of lens. The base lens 01, is secured to frame 03, that is then connected to the right arm 05 and the left arm 06. The auxiliary lens 02, has a lens thickness shown by 04. Magnets 09 and 11 connect with magnets 10 and 12 respectively. Magnets 07 and 08 match. Magnets 13 and 15 match with magnets 14 and 16 respectively.

FIG. 2 shows the rolling mount for a massage gun. The stem 17 is secured to the middle structure 18, which has the right protruding axil 19 and the left axle 20. At the ends of both axles are threading for bolts. The right bearing 24 is inserted into the inside of the right wheel 21, and then is slid over the right axle 19. This lets the wheel spin with low friction around the axle. Then the right bolt 26 is screwed onto the threading at the end of the axle 19 to secure the rolling wheel from falling off. The same can be done for the left bearing 25 and the left wheel 22, and the left bolt 27. On the wheels can be a tread pattern 23, that has a changing surface elevation to put more pressure on certain areas of the body that is being massaged.

FIG. 3 shows the rolling mount for a massage gun with one rolling wheel 30. It has a protruding axle 28 that is shaped so that the single wheel 30 is centered with the stem 17. A bump 29 on said axle 28 keeps the bearing 25 from sliding past it. Bolt 27 secures the wheel and bearing to the axle 28.

FIG. 4 shows the massage gun device. The body of the device 31 holds the motor and chips that make the device function. The lower dial 32 controls the vibration of the mount and the upper dial 33 controls the pulsation of the mount. The base 35 is where the stem 17 attaches to. Base 35 receives motion from the motor of the device. The gap 34 is a gap between the body 31 and the base 35 so that low friction movement can take place.

FIG. 5 shows a speargun apparatus with sheath for the knife inside the speargun handle. A knife 36 is comprised of a handle 37, a guard 38 and a blade 39. The speargun handle body 40, has a sheath 41 for the blade of the knife 39, a groove 44 for the knife handle 38 to snap into. A protrusion 45 at the end of the groove 44 prevents the guard 38 from falling out. Below the protrusion 45 the lower spear gun handle 46 still covers over the knife handle. The trigger 43 is surrounded by a trigger guard 42. The rest of the speargun apparatus 47 is above the handle body 40.

FIG. 6 shows a shoe. At the bottom perimeter of the shoe is a rubber strip 48. The back panel of the shoe 49 is the fabric that covers the heel. The inside of the back panel 50 is where the users heel contacts the shoe. A stretchy fabric panel 51 separates the back panel 49 from the front panel 54, and continues downward to meet the rubbers strip 48. The tab panel 52 is grabbed by the user when putting on the shoe. The stretchy tab panel 53 is a fabric panel of stretchy fabric that encompasses the tab panel 52 and divides it from the front panel 54.

FIG. 7 shows a shoe. Extended stretchy fabric panel 55 has a downward protrusion where many slip in shoes have a stretchy section, but this extended stretchy fabric panel 55 also extends and wraps around to the other side of the shoe.

FIG. 8 shows a shoe where it has many of the same parts as FIG. 6. The difference is with stretchy upper tab section 56 and non-stretchy fabric island 57.

FIG. 9 shows gummy candy. A sweet and/or sour coating 58 covers the gummy body 59 of the candy. At the center is a liquid core 60 of a sweet flavor burst. This figure shows a see-through diagram of its layers.

FIG. 10 shows a candy with a sweet and/or sour coating 58, a gummy body 59, and a liquid core 60. In this figure we see a cross-sectional view of FIG. 9. This figure can also be a 2-D view of a spherical candy with the same structure. This ordering of candy layers can be used for any shaped gummy candy.

FIG. 11 shows a hood of neoprene fabric. The back of the hood 61, has an opening 62. This opening allows the user to let their hair out of the hood. This opening 62 has a slit design with two stitching reinforcements 63 at either end. Said reinforcements 63 can be covered in rubber to prevent ripping of the neoprene fabric.

FIG. 12 shows how a wetsuit hood can let the user's hair out of an opening.

FIG. 13 shows a wetsuit 64. A shoulder panel 65 can have fabric thickness which is thinner than the arm below the shoulder or on the leg below the knee. Stitching 66 can show how the fabric panels inside the shoulder panel 65 are stitched together. The shoulder panel 65 can have a similar shape over the front of the shoulder and part of the chest compared to the back of the shoulder and part of the shoulder blade and latissimus dorsi. At the bottom of the wetsuit leg ending can be a section of fabric that is thinner than the neoprene fabric above it, this can be called a heel stretch section 67. A heel ridge 68 can be made of rubber and can cover the outside surface that goes up the back of the wetsuit from the leg ending.

FIG. 14 shows a bootie for water activities. The rubber outer sole 73 can run continuously from around the heel, under the foot, to the toes. Rubber heel spine 69 can travel from over the top of the heel, along the achilles tendon up to the top ending of the bootie. A rubber shin spine 72 can cover the front length of the bootie that covers the shin. Near the top of the heel spine 69 is a strap 70, and at the top of the shine spine 72 is a strap 71. Both of these straps help the user open and put on the booties.

FIG. 15 shows a bootie. On the upper rubber outer sole 73 can protrude a strap 74 to help the user put on the booties. A heel path section 75 can have a fabric that is thinner and/or more stretchy than the main fabric panel/s 76.

FIG. 16 shows a soft top construction. The foam core of the board 77 can have an external layer of square tread 79 or rolling bumpy tread 78.

FIG. 17 shows a scooter 80. On either side of the deck 81 of the scooter can be an external foam pad 82.

FIG. 18 shows a water filter for a smoking product 83. The front end 84 receives the smoking product, this can be something rolled like a joint, or bowl piece. This front end 84 can also be shaped with a right angle upwards so that this can be packed like a bowl or receive a bull piece. A chamber continues from the front end 84 to the mouthpiece 88. This design has three chambers. The underwater section 87 is under the wave horizon. The air chambers 85 are above the wave horizon. The body 86 can be made of glass. Above the chambers can be exit route 89, this can allow water to exit and enter for easy water change. A plug can cover this exit route 89, or a plug can be made to seal it.

FIG. 19 shows a pair of shorts. The body 90 of the shorts can have a fabric with thermochromic pigment. A fabric coating, a darker color, or lack of thermochromic pigment can make an ornamental design by color contrast to the changing colors of the body 90. The leg endings on shorts can have a split ending 92 where the front half is above the knee and the back half is at or below the knee. Especially for board short mobility. A knee to waist strip 95 connects the leg ending to the waist ending in a pair of shorts. Said strip has more stretch for comfort and mobility. The belt platform 94 has an outward facing bottle opener.

FIG. 20 shows the back end of a truck 95. On the rear-fender of the truck is a button 96. This button controls the lowering and other changing positions of the tail gate.

FIG. 21 shows a flipper. The body of the flipper 97 has an open heel for a strap 98. Said strap is made of stretchy material or sections of stretchy material. A part 99 that is connected to the flipper has slots for the strap 98 to loop through and secure it.

FIG. 22 shows a weighted juggling ball or work out sack. The core 102 is made of sand, gravel or any loose weighted material. The sealing layer 101 can be made of plastic or cloth and seals the loose weighted material. The outer layer 100 is made of a rubber and holds the sack together. The outer surface can have tread.

FIG. 23 shows a basketball rim. The receiving tube 103 has incremental holes 104. The holes allow for the specific change in rim size. A metal bead 105 is spring loaded to push out can lock into said holes 104. The metal bead 105 is located near the end of the rim that enters the receiving tub 103.

FIG. 24 shows a climbing shoe. The shoe can be divided into three main parts to the bottom of the shoe. At the back is the heel panel 106 which has a rubber exterior. In the middle is the stretchy arch 107 made of stretchy fabric. In the front is the tip section 109 which is also covered with rubber. Inside foot strap 108 can tighten the shoe for climbing, as well as the outer foot strap 112. The big toe tread 100 is a section of tread that is exposed on the outward surface of the shoe over the big toe. The upper tread 111 is a section of tread that is exposed on the upward surface over the toes, including the big toe. Stretchy top section 113 is a section of stretchy fabric that covers the top of the upper foot. It connects to the other side of the heel panel similar on both sides. Since this area is stretchy enough it allows the foot to enter.

FIG. 25 shows a bicycle with a wheelie assistance device. It has a wheel 114 that spins on the ground, an adjustable frame 115 that has a rotational attachment to the base frame 116 which attaches to the bike frame or seat stem.

FIG. 26 shows a yoga mat 117. In this yoga mat are ergonomic curves that are formed from changing thickness in the mat.

FIG. 27 shows an exercise mat that supports the lower back. The interior curve 118 of mat gradually meets the for at the thinning section 121. The mat body 119 is made from squishy foam. The side wall 120 keeps the user centered on the mat.

FIG. 28 shows a camera product. It is comprised of a floaty body 124 that has a layer of adhesive 123 that is sealed with a peelable layer 122. A base platform 125 is a rigid structure in the middle of the floaty body 124 and reaches the layer of adhesive 123. A stem 127 protrudes from the platform. At its center is an air channel. The top exit 129 lets are exit when surfing and can be plugged when diving. The side exit 126 lets out air and can allow for snorkel attachment. The arms 128 that protrude from stem 127 are for the a mouth guard to go over and attach to.

FIG. 29 shows a motorized bed 122 that has three moveable upper body frames that are each able to rotate on a joint between them.

FIG. 30 shows a hat. The hat can have a stretchy side panel 130 made from a fabric that is more stretchy than the fabrics of other panels on the hat.

FIG. 31 shows a candy that goes over the drinking edge of a soda can. The exterior coating 131 of the candy is a sweet/sour/fizz ingredient. A “V” shaped groove 132 in the candy is made to fit over the ridge of an aluminum can to secure the candy to it.

FIG. 32 shows a hat that has a curve around its perimeter that extends lower on the back of the head then the front.

FIG.33 shows a dinosaur mask. It is composed of an upper face mask 133 and jaw piece 134. The jaw piece 134 is able to swing relative to the upper face mask 133 because of a rotational piece 135. The user can see out of the eye hole 136, and be able to breathe through a nasal passage 137. Feathers 138 are attached to the mask. The attachment point 139, is where the feathers 138 are secured to the mask and allow the feathers to rotate into different positions.

FIG. 34 shows the dinosaur mask with feathers 138 extended into a more upright position. This is done by the rotational piece 135 being powered by a battery powered module to reposition itself. Many different positions can be set, and a remote, or buttons on the apparatus can be used to control them. When the jaw piece 134 is put into a specific position the feathers 138 can be set into a corresponding position. This can be done with wire connection between the rotational piece 135 and the attachment points 139.

FIG. 35 shows a structure for glasses. The upper frame bar 140 has magnets 142 set into it. Supporting arms 141 connected to the upper frame bar 140. The nose part 143 also has a magnet 144 set into it. At the end of the nose part 143 is the nose cushion 145. Above the nose cushion 145 is a flat or grooved surface for part of the lens to rest on, this is called the nose platform 146.

FIG. 36 shows the structure for a halloween mask. The rubber exterior 147 of the mask is separate from the rest of the face mask 149 but can be secured with glue, tape or a peelable sticky layer. The face mask 149 can have interior padding 151 and exterior padding 152. A strap 148 can secure the face mask 149 around the back of the user's head.

FIG. 37 shows the face mask 149 as well as the upper strap 148a and the lower strap 148b which loop through a hole 152. There are also eye holes 154 to see out of. The nose pad 153 can have a peelable and sticky layer to secure it to the rubber exterior 147.

FIG. 38 shows a trail camera. Its main components are a camera body 155, a lens 156 and exterior cover 161 and a platform 157. The platform 157 has spikes to dig into a tree with. The platform 157 also has holes 159 that allows nails 160 and screws to pass through, as another method to secure it to a tree. The exterior cove 161 is in the shape of a mushroom, and can be painted as such. A transparent section 162 can allow the camera to see through. An attachment snap 163 can secure the exterior cover 161 to the camera body 155.

FIG. 39 shows a driver's sun blocking device. In the upper section is a mirror 164. A tinted transparent layer 165 is what blocks the sun but still allows the user to see through it to view the road. A connection platform 169 attaches this device to the inside of a vehicle. A rotational joint 168 allows it to rotate. There can be several layers stem sections 166 that can extend out from one another at an overlap point 167. This overlap point 167 can also be rotatable. A clip 170 can attach to the inside of the vehicle when the user wants it to be put up and stored away. This clip 170 and the rotational joint 168 can be rotated to lay flush with the inside surface of the vehicle.

FIG. 40 shows an underwater flashlight for diving. It is composed of an upper body 171, a rotational ring 172 that when rotated can put the light into different settings, such as brightness levels and off. The lower body 173 is the flashlight body below the rotational belt 172. A screen 175 can show the diver information about the dive, such as depth, time, distance, location and more. Buttons 176 can be placed on the device to control features on the screen or light. Button 176a can start and stop a stopwatch. Button 176b can start and stop recording diving paths. Button 176c can change light brightness. The cap 174 can screw onto the lower body 173 and make a watertight seal enclosing the battery.

FIG. 41 shows a flotation device for an underwater sports camera. The main body 177 is composed of a buoyant material. The protrusion piece 178 can also be made of a buoyant material like foam and allows the user to bite it. This creates a simple mouth mount. The sticky layer 179 is what sticks to the camera, and can have a peelable layer to preserve the stickiness.

FIG. 42 shows a halloween mask. The mask exterior 180 makes the halloween mask its unique shape, and connects to the transparent lens 181. Said lens 181 can be tinted so the user's eyes are not visible. A nose bridge 182 connects the lens 181 of the right and left eye. A nose mask section 183 connects to both transparent lens 181, and to the rest of the mask exterior 180 from the top and bottom.

FIG. 43 shows a vehicle's mirror. The body 185 is connected to the stem 186 which connects it to the side of the vehicle. The flat part of the mirror 187 is closest to the vehicle. The curved part of the mirror 188 is farther outward from the vehicle.

FIG. 44 shows an electrical trimmer. The trimmer body 189 is where the user can hold it and inside it can be a rechargeable battery. A detachable charger port system 190 is used to recharge the trimmers rechargeable battery. A mechanical lever 191 changes the length of the base trimmer guard over the cutting system when the lever is rotated. This trimmer design has a rotatable trimmer guard 192 that is attached to said base trimmer guard that is moved by the mechanical lever 191. The rotational handle 193 can be rotated by the user's hand to rotate the rotatable trimmer guard 192. An angle chart 194 shows the angle the rotatable trimmer guard 192 is at so that it can be set precisely.

FIG. 45 shows an electrical trimmer. In this design the trimmer has a secondary guard 195 with an ascue rotational point 196.

FIG. 46 shows an electrical trimmer. On the bottom of the trimmer guard is a secondary guard pocket 197. This pocket lets a secondary guard of various shapes slide in and be secured to the bottom of the trimmer guard and be interchangeable.

FIG. 47 shows a swipe pattern for touchscreen devices when a video is being played. The touchscreen 198 can have the user hold their finger on it. Area where the finger is held 199 is depicted as a circle in this illustration. The incremental sections upward 200 correspond to the increasing video playing speed or the amount of timeline distance the video is skipped or played forwards. The incremental sections downward 201 correspond to decreasing of video playing speed or the amount of timeline distance the video is skipped or played backwards. The horizontal swipe pattern 202 can correspond to an increase or decrease in video playing speed based upon if the finger is slid to the right or left. The horizontal swipe pattern 202 can also correspond to a forward or reverse skipping or playing of the video based upon if the finger is slid to the right or left. If the swipe pattern has a slope the two options for the horizontal swipe pattern 202 can be combined with the vertical swipe pattern. For the purpose of these next examples of swipe patterns with slopes, the horizontal swipe pattern 202 will correspond to skipping or playing video forward when moved to the right, and reversing video when moved to the left. The vertical swipe pattern will correspond to increasing video speed when swiped up and decreasing video speed when swiping down. The swipe pattern with a positive slope 203 will increase the video speed and skip forward when moved upward at its angle. When it is moved at its downward angle it will decrease video speed and reverse the video. The swipe pattern with a negative slope 204 will decrease video speed and play video forwards as it is swiped to the right at its downward angle. When it is moved to the left at its angle the video will play at an increased speed in reverse.

FIG. 48 shows the bottom of a soft top surfboard. Main bottom body 205 can be made with a plastic or strong foam layer that is smooth for low friction. A rigid tail and fin box supporting structure 206 can be made of a plastic that is stronger than the plastic of the main bottom body 205. The purpose of the rigid tail and fin box supporting structure 206 is to give the fins boxes a sturdy attachment to the board so the fin boxes don't tilt and give poor fin performance. The rigid tail and fin box supporting structure 206 can have fin boxes built into it so that they are very well supported. One, two, three, four or five fin boxes can be built into the rigid tail and fin box supporting structure 206. A center fin box 207a, a left fin box 207b and a right fin box 207c can be the main fin box design set up.

FIG. 49 shows a vehicle's bumper lip 208. Attached to the bottom edge of the bumper lip 208 is a center roller 209a, a right roller 209b and a left roller 209c. Said rollers rotate when they contact the ground to not damage the car.

FIG. 50 shows a truck. The front frame 210 is the frame of the front half of the vehicle. The upper point 211 is a protrusion for looks and aerodynamics. The case 218 covers the truck bed and is ergonomically fitted around the upper point 211 and has a spike 219 that eronomically fits around a downward sloping back end. The asymmetrical wheel well 214 has a more gradual curve in the front half and a more squared curve in the back half. The truck floor 215 is the bottom surface of the truck's bed. The tail gate 216 is able to fold inward and lay flat on the truck floor 215. The hinge structure 217 contains the hinge that allows the tail gate 216 to rotate like this. A rotational track 213 is attached to the front bumper of the truck. This allows the front end of the truck to roll out of steep off-road positions. The retractable roof lights 212 are able to rotate upward from a flush or near flush position from the exterior of the car.

FIG. 51 shows an in depth view of the inward folding tailgate 216. Inside the hinge structure 217 is a track 220 that allows the pin 221 which is attached to the inward folding tailgate 216 to be lifted up and rotated inward.

FIG. 52 shows an in depth view of the retractable roof lights 212 which can rotate upwards. In this illustration they are in the retracted position. The roof frame 222 is the area which the retractable roof lights are built into. A wire 223 connects to an electric module 224 that powers the rotation of the retractable roof lights.

FIG. 53 shows the retractable roof lights 212 in the upright position. A rear rubber seal 225 covers a gap to prevent water seepage. A front rubber seal 226 is used to prevent water seepage when the retractable light is retracted.

FIG. 54 shows a double sided retractable light 227 that has lights facing forwards and backwards. These lights can be sieren lights, such as the ones police officers have. This retractable feature allows the vehicle to become undercover and indistinguishable from normal vehicles. Said double sided retractable light 227 can slide up and down with motorized front track 228a and motorized rear track 228b.

FIG. 55 shows a truck design. A front fender curve 230 is for looks and maybe aerodynamics. A window perimeter 229 has an increased window section towards the rear half of the window.

FIG. 56 shows a method of finding the text you are looking for within a document or website. The document or website 233 has to have text. The search bar 231 lets the user type in words that they want to find. If the user thinks that the words do not directly follow one another then they can put a semicolon or another symbol used to separate the words in the search bar. If all of the words in the search bar are within the same sentence, then the searched words will be highlighted or in a box 232 or signified in some other way like bolded or italics possibly. The search system will take the document or website 233 to the page that has words that are highlighted or in a box 232. If some but not all of the searched words are in the same sentence then the searched word/s can be underlined 234 or signified in some other way.

FIG. 57 shows a screen of an electronic device and can be the lockscreen of such a device. It shows to sections an upper section which has map navigation 235, and a lower half that has music playing information and controls 236. Box 242 is where the name of the song and artist can be placed. Time bar 243 is the timeline of song/audio and dot is where the current playing position is located. Icon 245 identifies if the song is playing or paused and the double arrows on either side can skip forward or backward in the playlist or audio sequence. Volume bar 244 identifies volume range and the dot shows the current level. Circle 241 overlaps the dividing line between the map navigation 235 and the music playing information and controls 236. This circle 241 represents the area where a finger makes contact with the touchscreen device and when the finger is held and slid upward or downward the dividing line follows, resulting in a changing ratio of the two sections. Line 239 signifies the white line on a road and can be shown on the map navigation 235 as a white line. Dotted line 238 separates the lanes on the road to give an accurate representation of the road. Double solid lines 237 shows the separation of direction of traffic, and can be yellow for accuracy. Location dot 240 shows the location of the user of the map navigation 235. The line continuing from the location dot 240 is that of future travel which the map navigation 235 suggests. There is no trailing line of where the user was behind the location dot 240.

FIG. 58 shows a navigation software that gives directions on a road, and within a building. The one dotted and one solid line combination 246 shows the separation of direction of traffic where one side can cross through. This can be shown yellow for accuracy. The line of direction 248 is where the navigation directs the user, and can seamlessly transition from vehicle to walking navigation. Walking path 247 can be shown as the user walks with navigation. The building system 250 includes the entire building, departments 255 and rooms 253. Building navigation path 249 navigates the user through a building, such as a mall, university, airport and more. Elevator 251 is shown in navigation and the navigation software can detect how light you are in the elevator and once you reach your new floor the building navigation can change to be accurate to this new floor. Floor box 252 informs the user what level to take the elevator to. Destination dot 254 shows the end destination and in this case is within a room 253.

FIG. 59 depicts a design for a pair of glasses. The frame 256 has a high corner magnet 258, a side magnet 257 and a low corner magnet 260 that are secured to and protrude from the frame 256. A lower groove 261 runs along the bottom inside edge of the frame 256 so that a lens can be slid inside. A nose groove 263 can be made also to receive the edge of a lens and secure it. A clamp 262 can be built flush into the frame 256 so that it can secure a lens.

FIG. 60 shows a structural design for a frame of a pair of glasses. The exposed edge of frame 264 is also connected to the hidden edge 265, built into the surface of the hidden edge 256 is a magnet 266.

FIG. 61 shows the same structural design for a frame of a pair of glasses as FIG. 60 but from a different perspective. In this illustration we see the magnet 266 placed on the hidden platform 265a. The hidden edge 256 reaches the same level as the magnet 266 but the magnet is placed on a lower surface called the hidden platform 265a so that the magnet 266 and the hidden edge 256 are flush.

FIG. 62 shows how the clamp 262 works. A lens 268 can have a lens hook 269 attached to it. The clamp hook 262a secures the lens hook 269. A rotational pin 267 allows the clamp 262 to rotate and can be spring loaded to recoil to the depicted position. The rotational pin 267 can attach to the frame 256 as shown in FIG. 59 and allow rotation between them.

FIG. 63 shows a rod 270 that is accessible for the driver of a vehicle. On the rod 270 is a rotational dial 271 that when spun increases or decreases the amount of head beam light based upon which way it is spun. This rotational dial 271 can be spun very slightly and allow for the fine tuning of the light that comes out. Icon 272 can depict to the user which way to spin the rotational dial 271 to increase the light output.

FIG. 64 shows a double layered dial system that can be used for compacting controls within a vehicle. The outer dial 273 can be spun either way and controls something like fan speed. The inner dial 274 can be spun either way and can control something like the temperature of fan air.

FIG. 65 shows a zipper body 274 with a zipper handle 275 and a part snap 276. The part snap 276 can be on either side of the zipper handle 275. The benefit of this part snap 276 is that if there is a compatible part snap on the surface of something it can secure the zipper body 274 near that area.

FIG. 66 shows a lounge chair that consists of a body platform 277, a back rest platform 278, and a head rest platform 279. Legs 280 hold up the lounge chair. Lower bar 281 allows for positioning of lower adjustment bar 283. Higher bar 282 allows for positioning of higher adjustment bar 284. Both adjustment bars have incremental teeth. The lower adjustment bar 283 changes the angle of the back rest platform 278 based upon which row of teeth is catching the lower bar 281. The higher adjustment bar 284 changes the angle of the head rest platform 279 based upon which row of teeth is catching the higher bar 282.

FIG. 67 shows a design structure for a zip line that can go in a curving path. It consists of two cables 287 that have a coating 288 which can be of rubber/plastic and still allows the cables to be flexible. Incrementally along the line are attachment structures 286 which have a hollow section 286 that allows it to be supported by line. The attachment structures 286 attach to the cable by encompassing it like the coating 288 and is flush with the coating 288. A double pulley system rides along the coated cable lines and is attached or held by the rider.

FIG. 68 shows a shirt 289 with a curved neck collar. The front section 290 and the back section 292 are divided by a middle section 291 on either side. The middle section is shaped like a trapezoid with the shorter base at the top, this is what will give the neck collar its curved shape.

FIG. 69 shows a hat with a front fabric section 293 and a brim that has a flat section 294 and a curved section 295 on either end. This curved section 295 allows for the blocking of sun rays, but the flat section 294 allows for a comfortable fit. The front fabric section 293 which is all fabric panels that cover the front half of the hat, can have fabric pannel/s that align with the flat then curve of the brim.

FIG. 70 shows a martial arts and work out device that has rigid platforms 296 covered in squishy exterior padding 297 and spring hinges 298 that the user works against.

FIG. 71 shows a chest workout device that comprises two platforms 299 and strong spring hinge 300 and a hinge protector surface 301. The user will push the platforms together with their elbows, forearms, hands, legs, lats and more.

FIG. 72 shows a kiteboarding bar 303 that has holes or grooves 304 that go into the surface of the bar or all the way through. The center lines 305 go through the center of the bar 303. The holes or grooves 304 are for the rider's thumbs to press against to help steer.

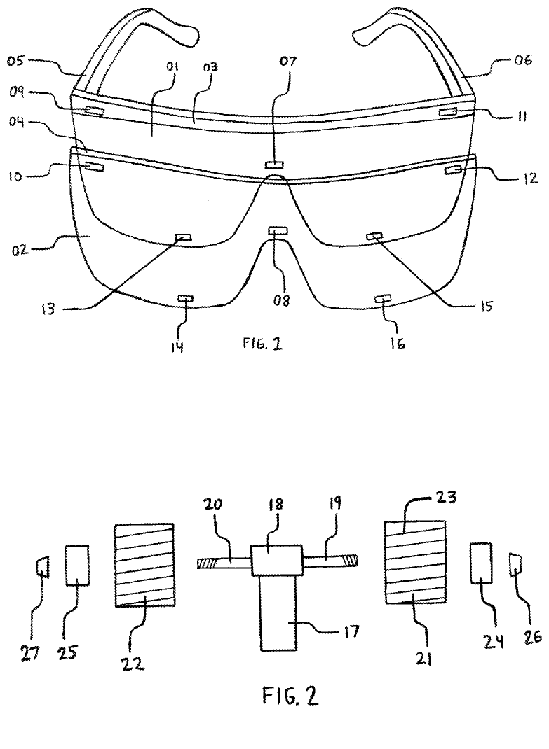

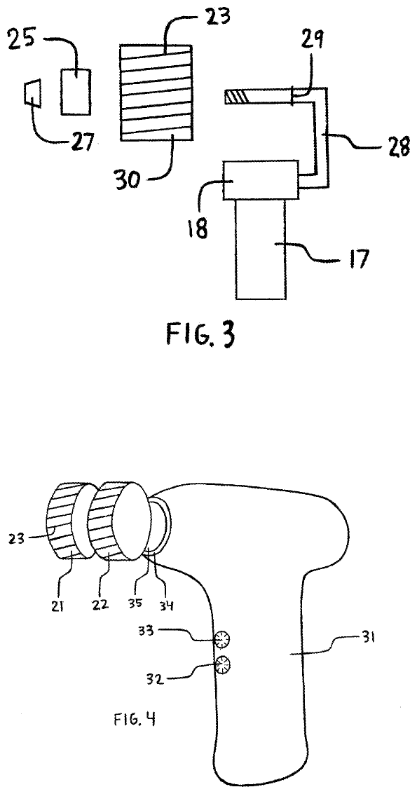

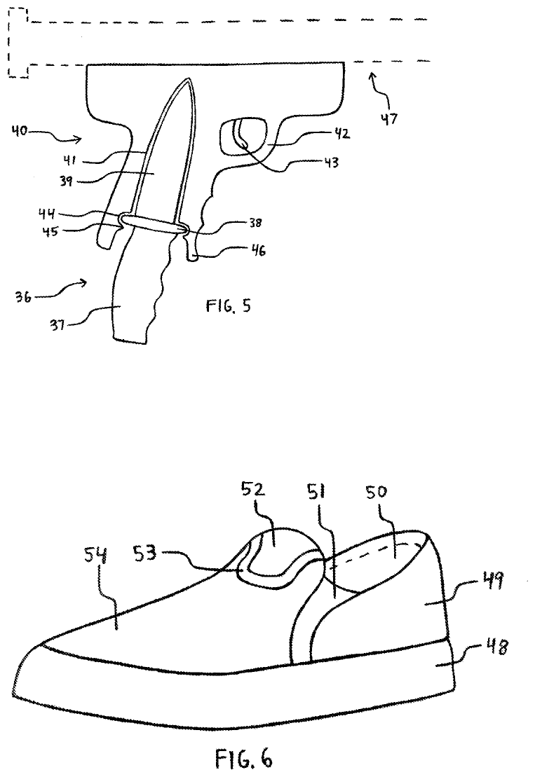

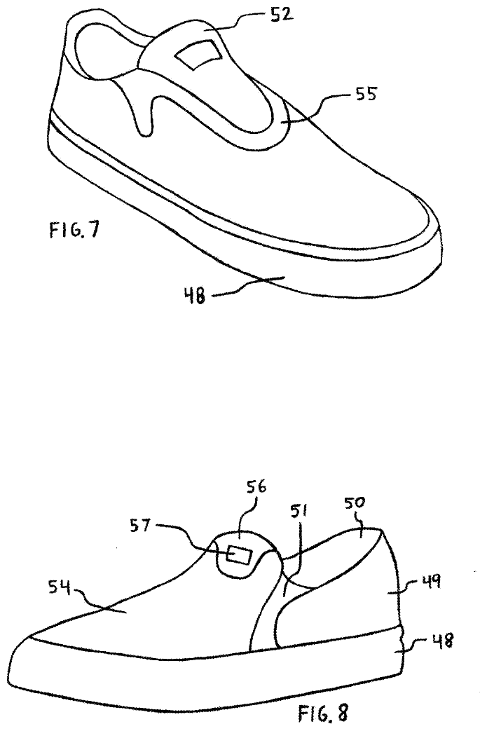

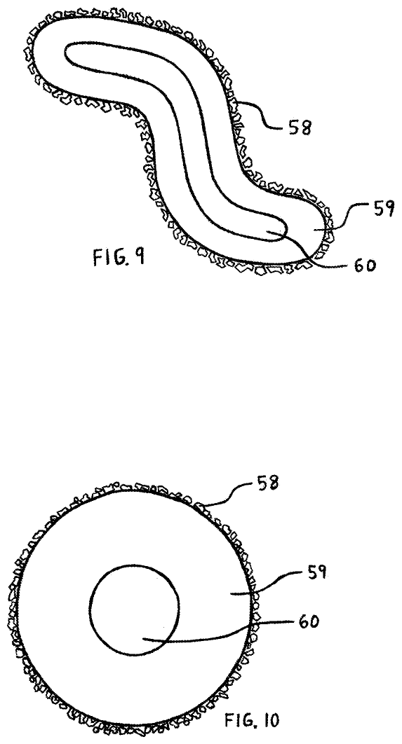

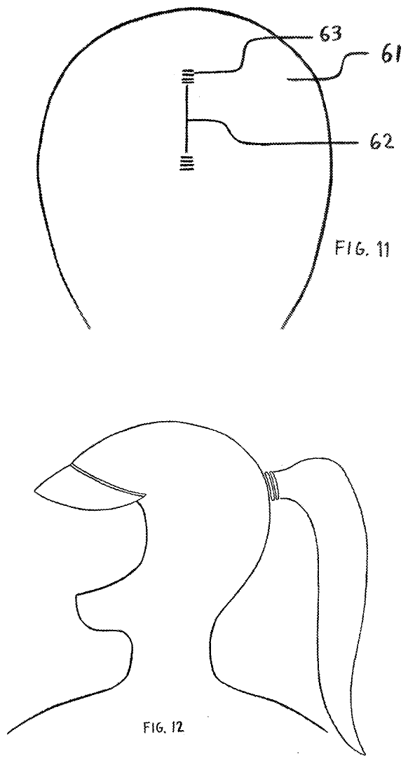

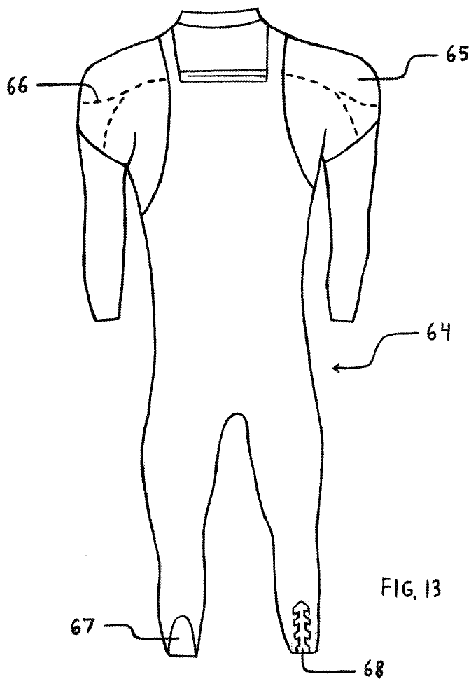

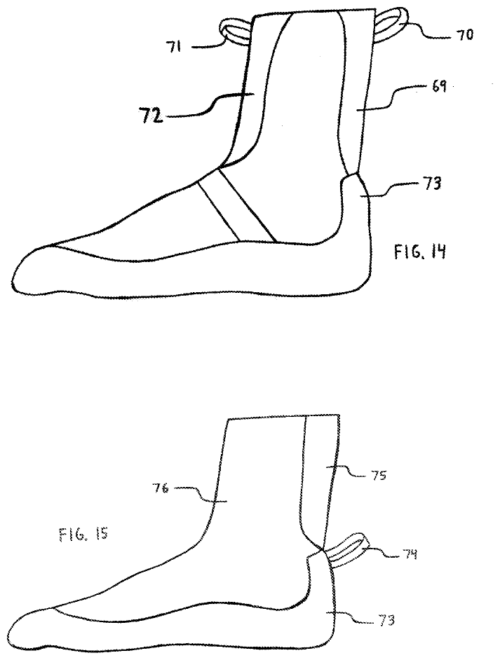

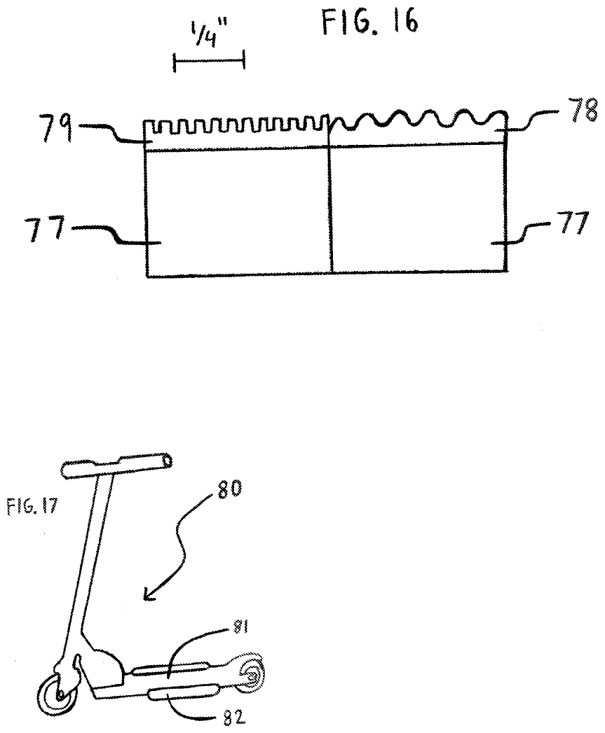

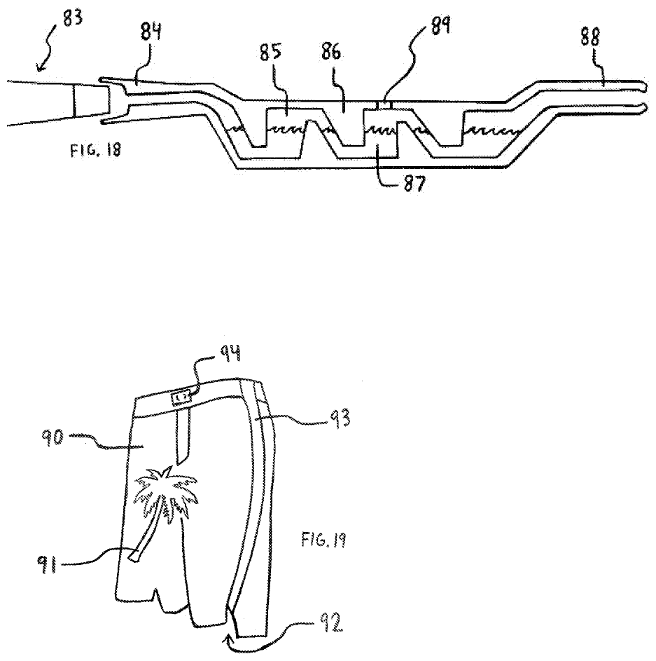

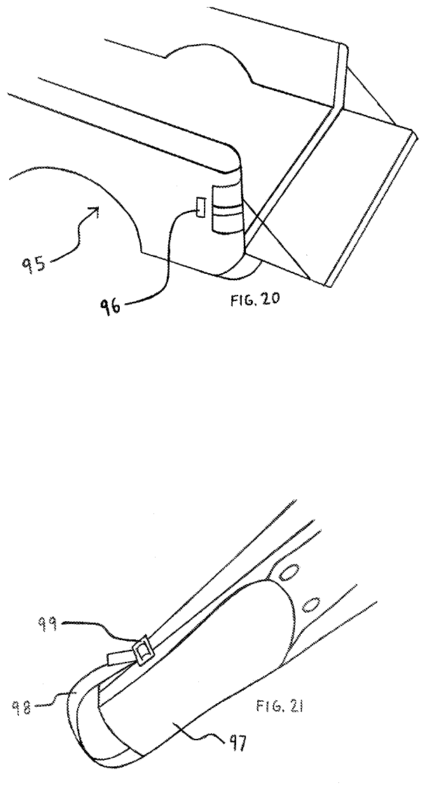

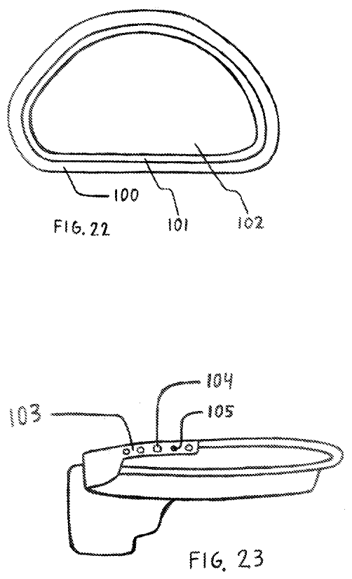

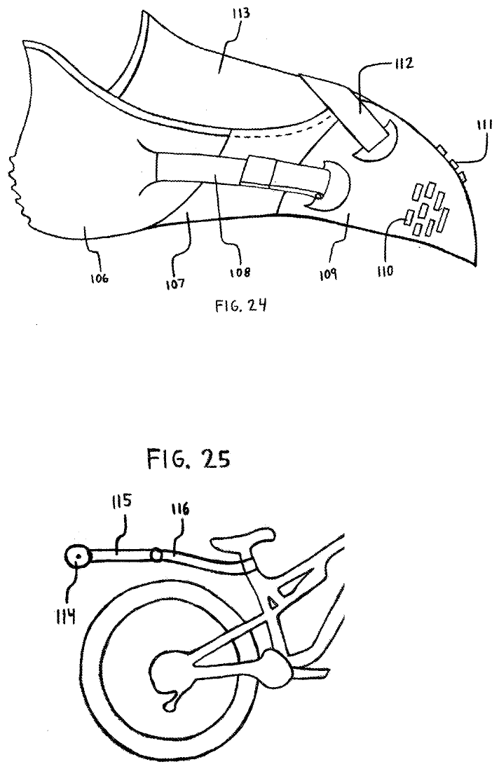

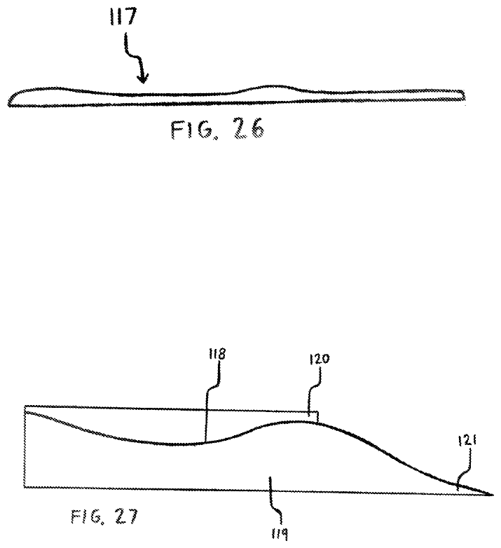

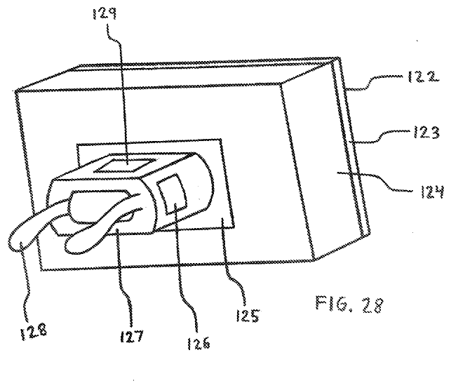

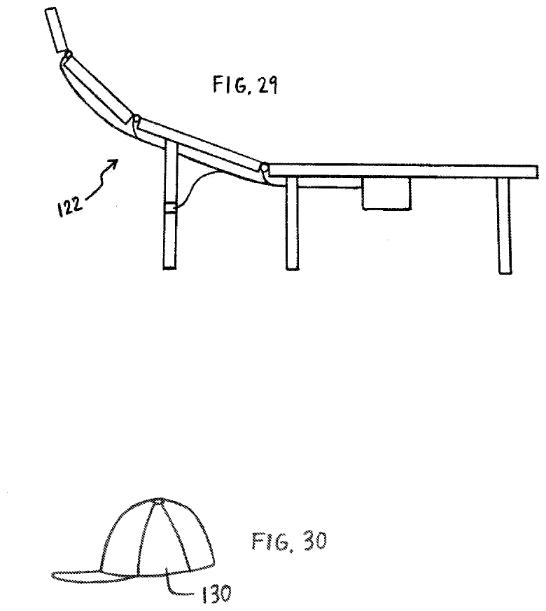

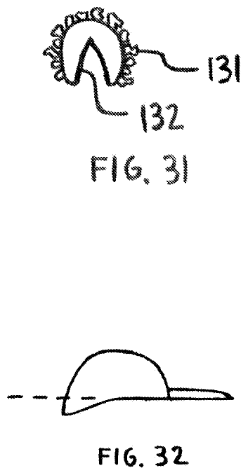

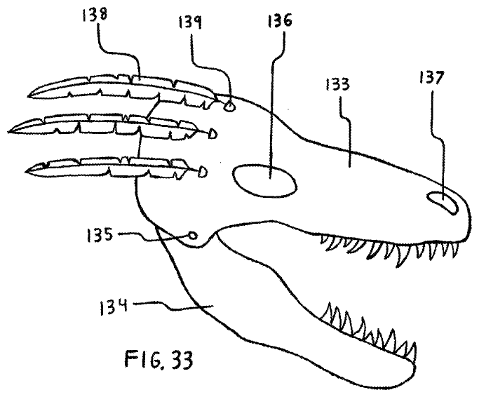

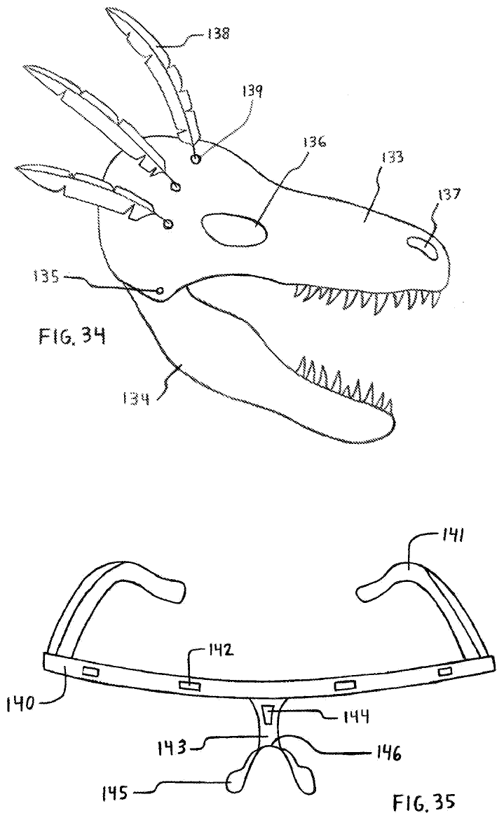

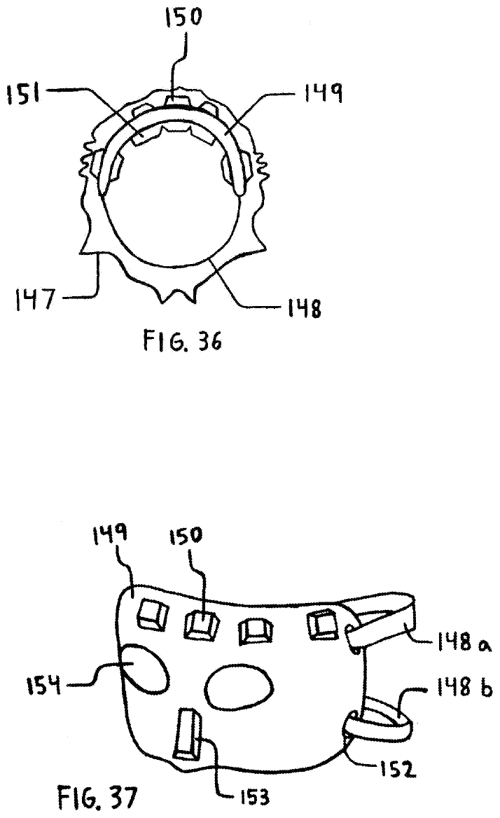

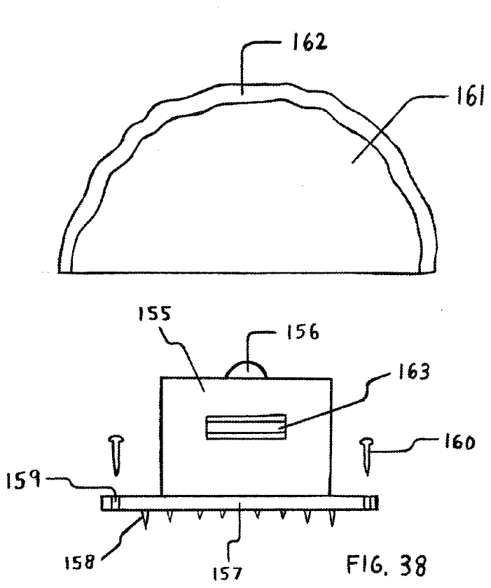

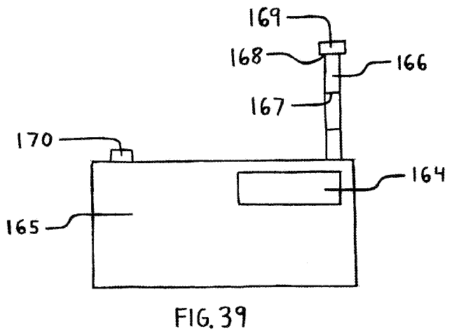

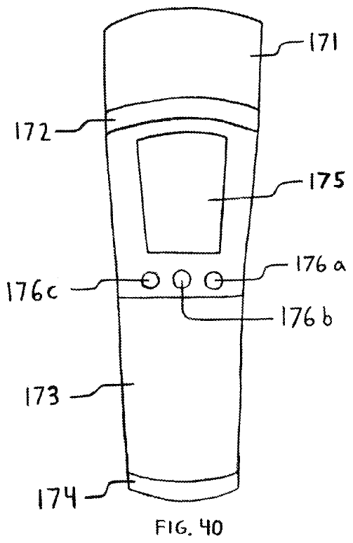

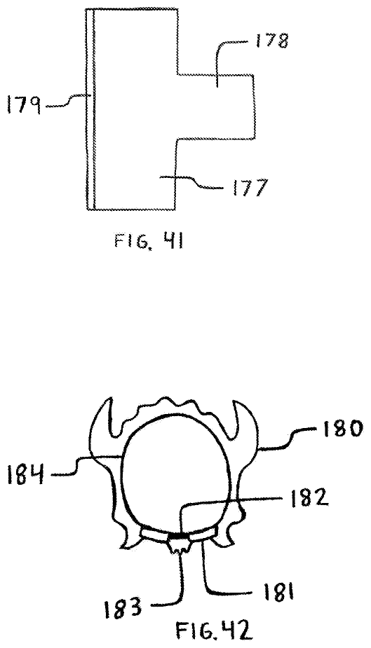

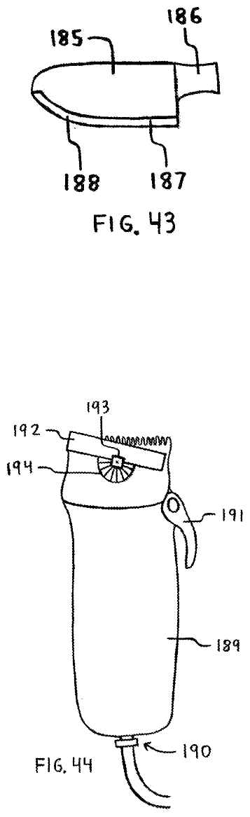

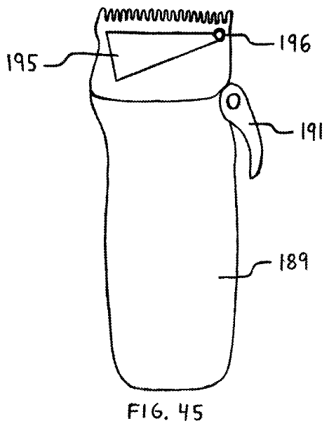

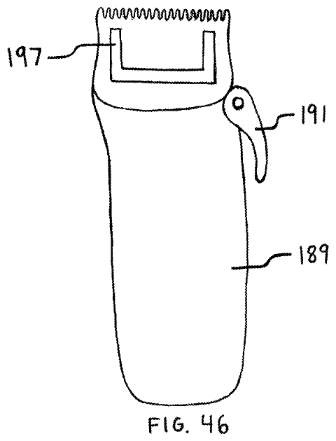

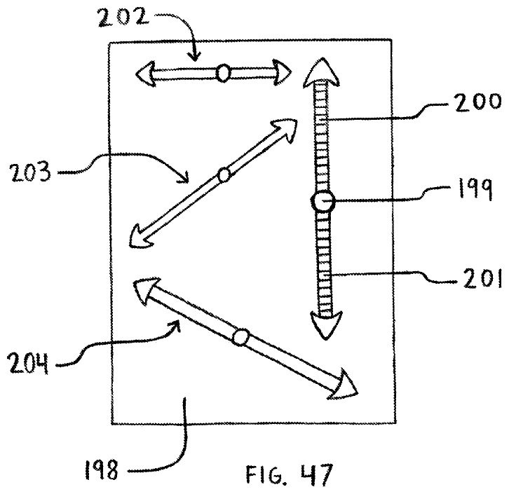

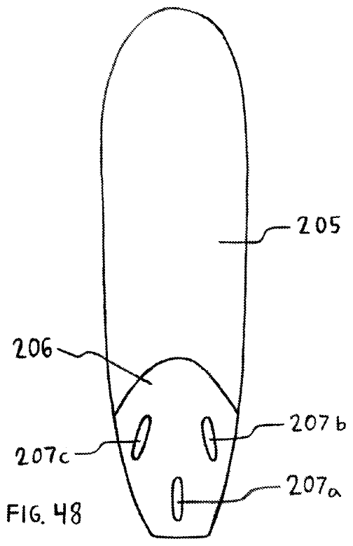

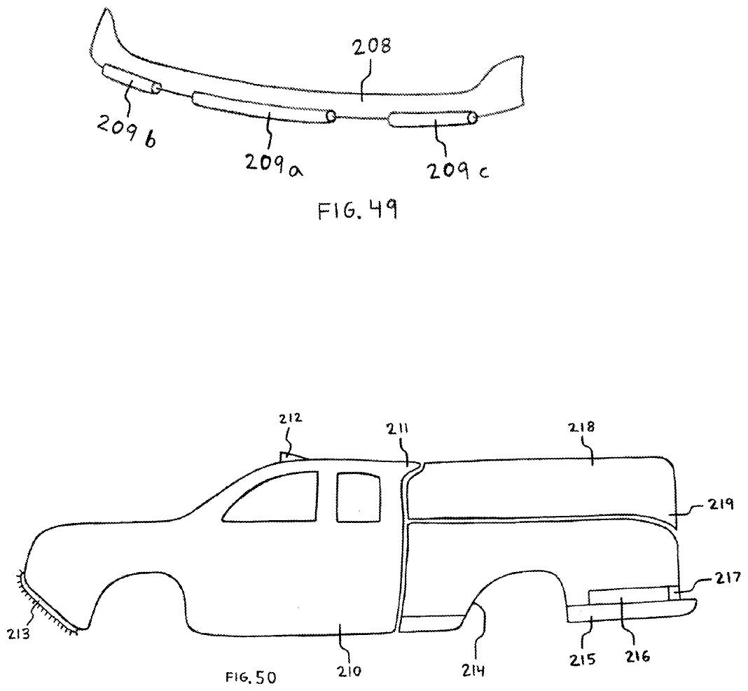

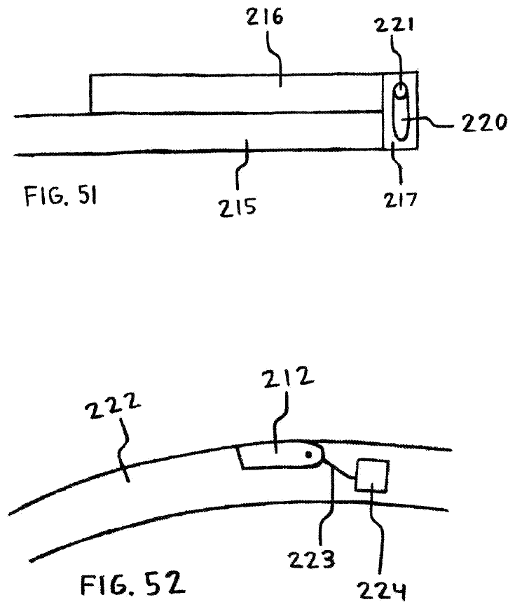

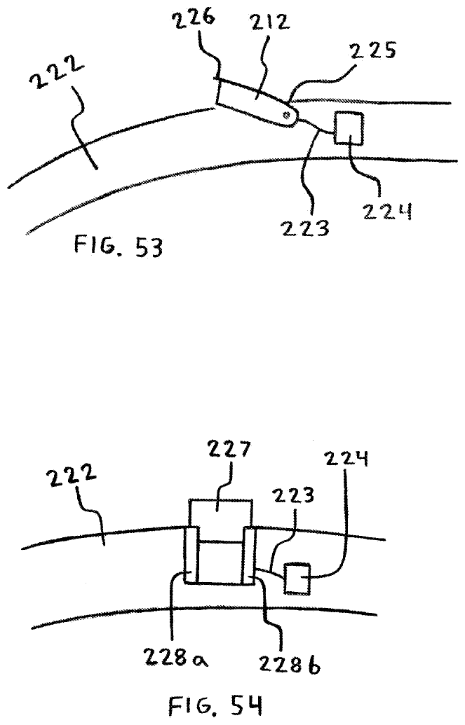

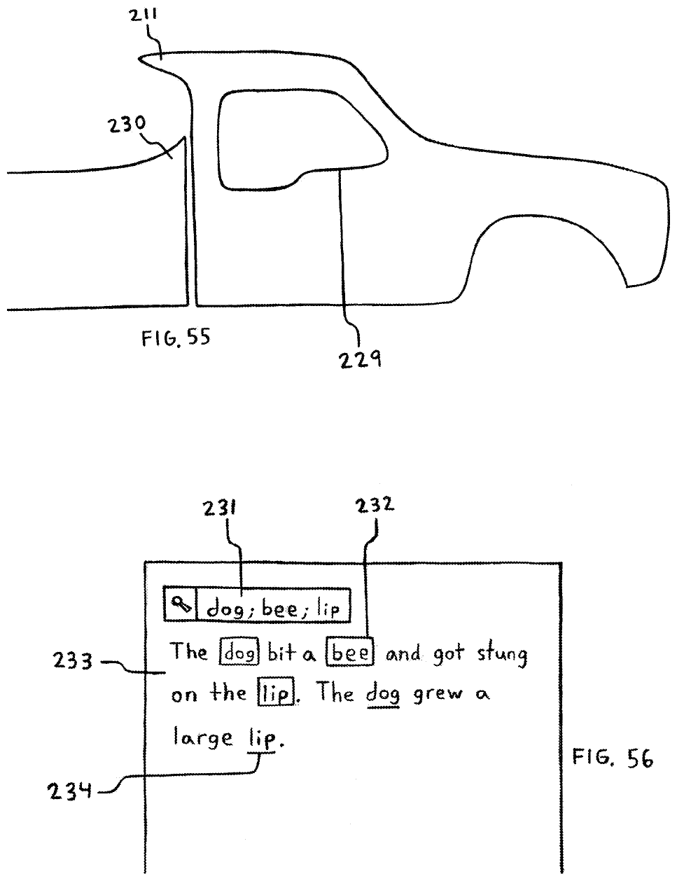

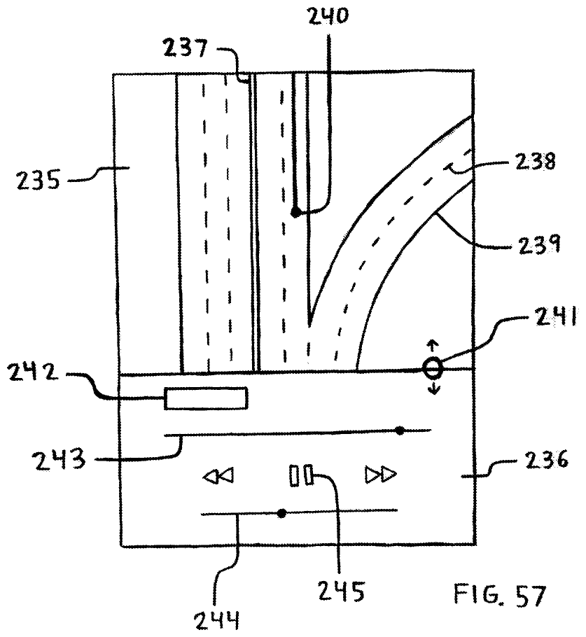

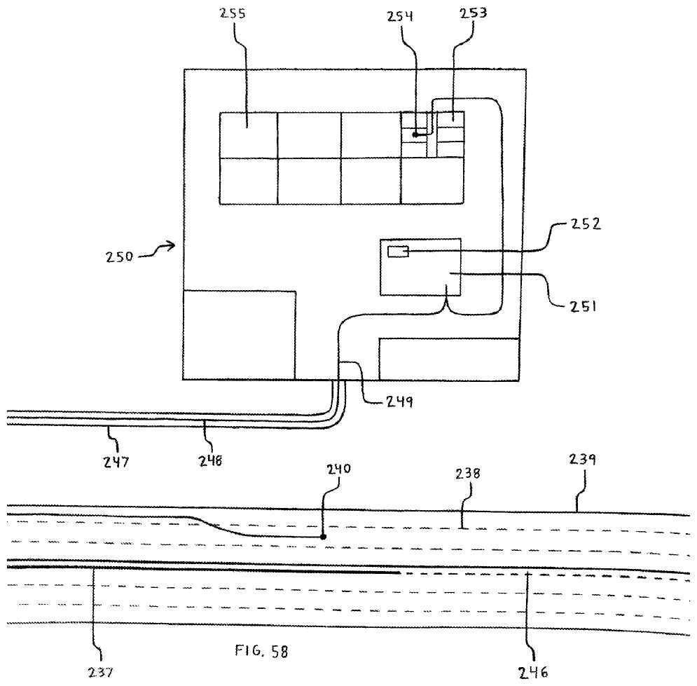

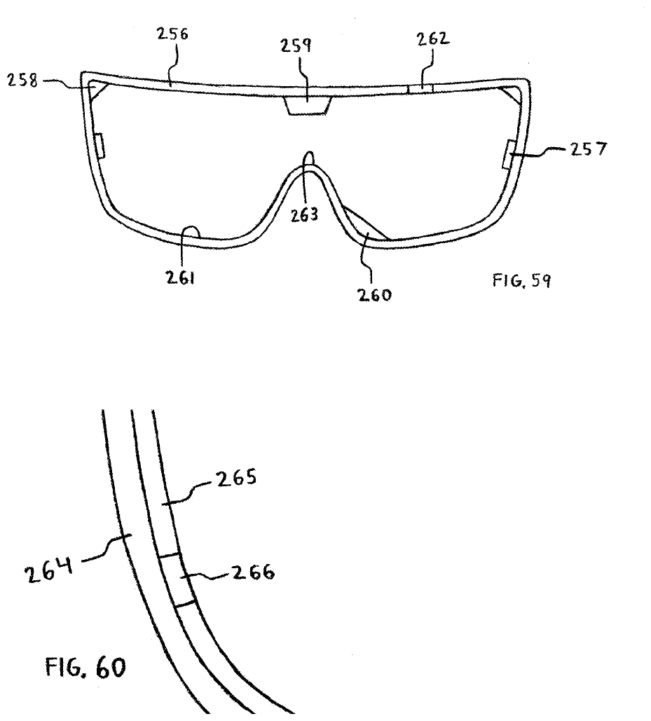

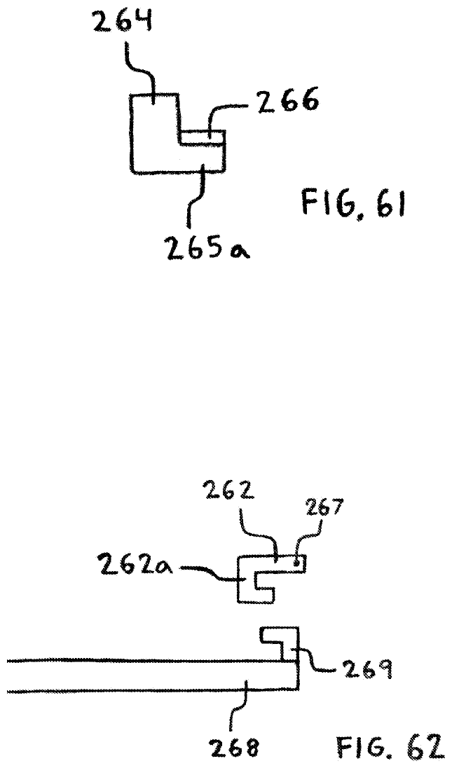

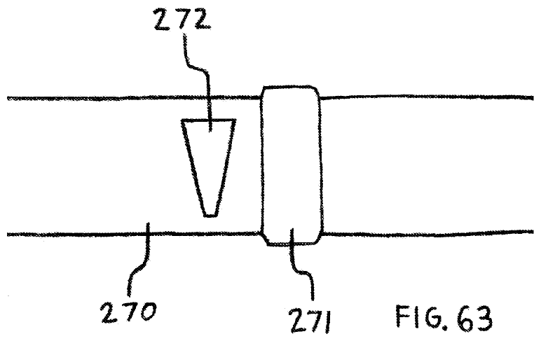

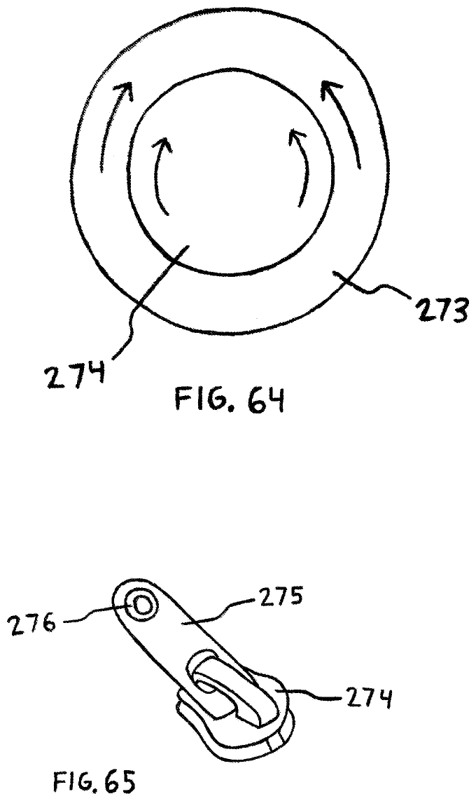

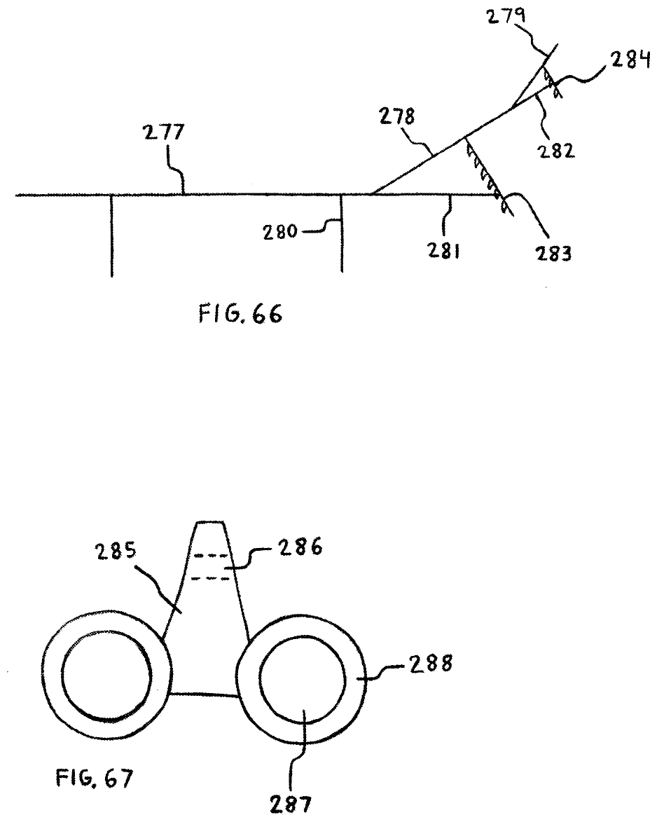

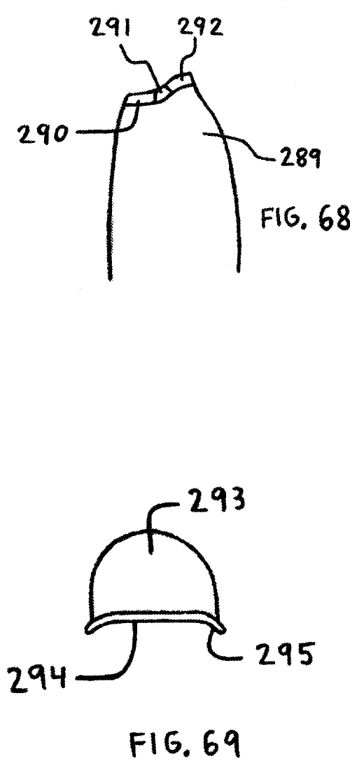

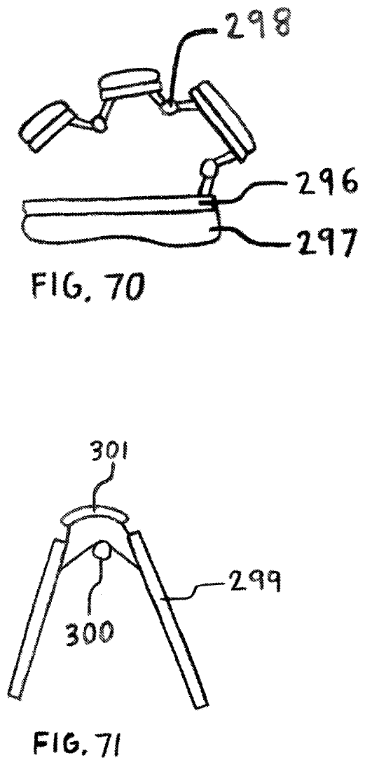

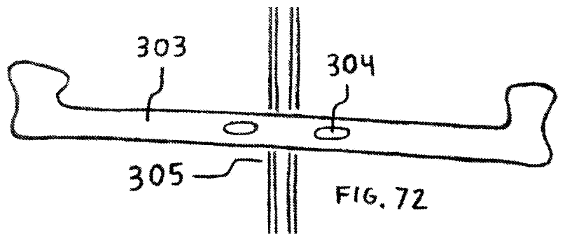

1. A vehicle can have an automatic tailgate that can reposition itself from the press of a button or buttons on the fender of the vehicle.

2. A gummy candy that has a surface covered in sour and/or sugar coating, can have a liquid filling inside the gummy.

3. A social media app comprising a home section for posts from accounts that you primarily follow which can be scrolled through vertically, a search section that shows posts that are in the interests of the user in columns of two or three, can have a row of limited time posts of accounts the user follows. Said limited time posts can stay up for 24 hours since posted. When a user views these posts on the screen they can select an icon that can notify the account that made the post of their selection. This section can be called a “like”.
a. The social media app of claim 3, can have wherein a permanent post can be made with multiple images and videos, where the account that makes such a post is able to edit the post later and be able to delete one or more of the photos or videos.
b. The social media app of claim 3, can have a filter that lets the user draw with their nose. As the user's nose is moved a line is drawn on the screen over where the nose was.
c. The social media app of claim 3, can have a filter where it replicates half of the users face onto the otherside to show symmetry. This other symmetry is done without the user's face remaining in the middle of the screen.
